(19) United States
(12) Patent Application Publication
(10) Pub. No.: US 2013/0238964 A1
(43) Pub. Date: Sep. 12, 2013

(54) APPLICATION FOR DESIGNING JOURNALS

(71) Applicant: APPLE INC., Cupertino, CA (US)

(72) Inventors: Laurent C. Perrodin, Los Altos, CA (US); Randy Ubillos, Los Altos, CA (US); Christopher R. Cunningham, Sunnyvale, CA (US); Samuel M. Roberts, Santa Cruz, CA (US)

(73) Assignee: APPLE INC., Cupertino, CA (US)

(21) Appl. No.: 13/629,318

(22) Filed: Sep. 27, 2012

Related U.S. Application Data
(60) Provisional application No. 61/607,571, filed on Mar. 6, 2012.

(51) Int. Cl. G06F 17/00

(52) U.S. Cl. 715/209; 715/255; 715/227

(57) ABSTRACT

Some embodiments provide an image organizing and editing application for designing a journal. In some embodiments, the application allows a user to select media content and creates the journal by populating it with the selected content. The application allows the user to build a story around the journal's content by adding different info items, such as a map, calendar, and weather info. When an info item is added, the application may analyze one or more pieces of content in the journal to dynamically present information.

### CLAIM OF BENEFIT TO PRIOR APPLICATION

This application claims the benefit of U.S. Provisional Application 61/607,571, entitled “Application for Creating Journals”, filed Mar. 6, 2012. U.S. Provisional Application 61/607,571 is incorporated herein by reference.

### BACKGROUND

To date, many applications exist for organizing images. Several of these applications allow users to organize images into different photo albums. Typically, an application's user can select one or more images, and drag and drop them on a name of a photo album to add them to the album. The user can also select the photo album's name to display the images in the album. Upon selection of the name, the application displays thumbnail representations of the images on one or more rows.

There are a number of shortcomings associated with the applications described above. For instance, the presentation of the album's images lacks aesthetic appeal. While the photos may be captivating to a person, the presentation of these images as thumbnail images across different rows may very well be quite boring to the person. The person could use the application to concurrently increase or decrease the size of the thumbnail images. This usually results in additional or fewer thumbnails images being shown on each row but does not add much to the presentation.

To provide a designed layout, some applications provide album templates. An album template can have several image frames that are sized differently. The user can drop images onto these frames to create a designed album. In most cases, the user can also remove an image from a frame and replace it with another image.

The templates provide predesigned photo album layouts. However, the user of a template is not confined by rows of thumbnail images but by the template's static design. That is, aside from some minor differences, different albums created with the same template will look substantially the same. Moreover, there are very few tools to personalize an album, much less to add a story to the presentation.

### BRIEF SUMMARY

Embodiments of an image organizing and editing application for creating a journal are described herein. In some embodiments, the application allows a user to select media content (e.g., images, video clips, etc.) and creates the journal by populating it with the selected content. To create a designed layout, the application of some embodiments chooses certain images to be larger than other images in the journal. That is, the application may identify an image that is captioned or marked as a favorite, and present that image as a larger image (e.g., at a higher resolution) than some of the other images.

In some embodiments, the journal is defined by a two-dimensional grid that contains a fixed number of cells along one dimension and a varying number of cells along the other dimension. In order to layout items (e.g., images, video clips, etc.) across the grid, the application of some embodiments creates an ordered list. The ordered list defines the layout by specifying the position and size of each item in the journal. Several of the items in the list are specified to be different sizes. The application then uses the specified size and position information to place some items on one grid cell and some other items on multiple grid cells.

To emphasize certain tagged images, the application of some embodiments performs multiple passes on the ordered list. The application may perform a first pass to list each item with a particular size. The application may then perform at least a second pass to identify any images that are tagged with a marking (e.g., a caption, a favorite tag). In some embodiments, the position and/or the size of the tagged images are swapped with that of other images. One reason for identifying these marked images is that the user has taken his or her time to mark them (e.g., input captions, tag them with a special rating tag). Therefore, the marking provides an indication that the marked images are more special or important to the user than other images. In this manner, the application of some embodiments identifies such a marking to intelligently make some images larger than other images.

Once the layout is created, the application allows the user to modify it in a number of different ways. The user can edit the journal by removing images from the journal, resizing the images, rearranging the images, and adding additional pages to the journal, etc. When the layout is modified, the application of some embodiments reflows items (e.g., images, video clip) across the grid. When an image is removed, the application may fill the gap left by the image with one or more items. As such, the application of some embodiments presents the user with a different design when a change is made to the journal layout.

In some embodiments, the application provides a variety of different editing tools that can be used to build a story around the images in the journal. The user can use a header tool to input a heading (e.g., that describes a trip to a particular location), or a text tool to input text (e.g., that describes something that someone said on that trip). The text may also be designed text items with associated images (e.g., that create the look of a travel journal).

In some embodiments, the application provides tools to add dynamic info items to a journal. These dynamic info items can include date, map, weather, etc. The user can use a map tool to add a map that shows a location (e.g., of a past vacation destination), or use a weather tool to add information about what the weather was like at the location. When such dynamic info items are added, the application of some embodiments analyzes nearby images (e.g., by identifying the images' metadata) in the journal to present information (e.g., the location, the weather). That is, the application may identify the location information associated with an image to retrieve map tiles from an external map service, or the date and location to retrieve weather report from an external weather service.

In some embodiments, the application allows the user to share the journal in a number of different ways. The application of some embodiments allows a user to share a journal by publishing it to a website, presenting a slide show of the images in the journal, etc. In some embodiments, the application provides a control that can be toggled to specify whether a journal is published to the website that is hosted by a cloud service provider. The journal can also be saved on a computing device as one or more web documents or can be published to a personal homepage.

As mentioned above, the journal in some embodiments is defined by an ordered list that indicates the position and size of each item (e.g., image, text item) in the journal. To publish the journal to a website, the application of some embodiments traverses the ordered list to generate different images at different sizes (e.g., resolutions) using source images. The application then sends the generated images over a network to an external web publishing service in order to publish the journal as a set of web pages. In conjunction with generating images or instead of it, the application of some embodiments generates a serialized version of the journal based on the ordered list. The serialized version is sent to the external web publishing service. In some embodiments, the web publishing service receives the serialized version and converts it to a set of one or more web pages.

Several more detailed embodiments of the invention are provided below. Many of these examples refer to controls (e.g., selectable items) that are part of an image editing application. This application in some embodiments is a standalone application that executes on top of the operating system of a device, while in other embodiments it is part of the operating system. Also, in many of the examples below (such as those illustrated in 1-4, 11, 13, 14, 16, 18, 21-33, 35-38, 40-47, 49, 52-54, and 57), the device on which the application executes has a touch screen through which a user can interact with the image editing application. However, one of ordinary skill in the art will realize that cursor controllers or other input devices can be used to interact with the controls and applications shown in these examples for other embodiments that execute on devices with cursors and cursor controllers or other input mechanisms (e.g., voice control).

The preceding Summary is intended to serve as a brief introduction to some embodiments as described herein. It is not meant to be an introduction or overview of all subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description and the Drawings is needed. Moreover, the claimed subject matters are not to be limited by the illustrative details in the Summary, Detailed Description and the Drawings, but rather are to be defined by the appended claims, because the claimed subject matters can be embodied in other specific forms without departing from the spirit of the subject matters.

### BRIEF DESCRIPTION OF THE DRAWINGS

The novel features as described here are set forth in the appended claims. However, for purposes of explanation, several embodiments are set forth in the following figures.

FIG. 1 illustrates a graphical user interface (“GUI”) of an application for creating journals.

FIG. 2 provides an illustrative example of selecting a range of images to create a journal.

FIG. 3 provides an illustrative example of specifying a name (e.g., title) and theme for the journal.

FIG. 4 illustrates creating a journal with the specified settings.

FIG. 5 provides an illustrative example of populating a grid with several images.

FIG. 6 conceptually illustrates a process that some embodiments use to create the list.

FIG. 7 illustrates placing additional images on the grid.

FIG. 8 provides an illustrative example of swapping images in the list.

FIG. 9 conceptually illustrates a process that some embodiments use to swap images in the list.

FIG. 10 illustrates a process that some embodiments use to traverse a grid to populate it with images.

FIG. 11 provides an illustrative example of removing an image from a journal.

FIG. 12 provides an illustrative example of reflowing images upon removing an image from the journal.

FIG. 13 provides an illustrative example of locking the image.

FIG. 14 provides an illustrative example of reducing the size of the image.

FIG. 15 provides an illustrative example of reflowing images upon resizing the image from the journal.

FIG. 16 provides an illustrative example of increasing the size of the image.

FIG. 17 provides an illustrative example of reflowing images upon resizing the image from the journal.

FIG. 18 provides an illustrative example of moving the image from one location on the journal to another location.

FIG. 19 provides an illustrative example of reflowing images upon moving the image in the journal.

FIG. 20 illustrates framing a landscape image and a horizontal image.

FIG. 21 provides an illustrative example of framing the landscape image on the cell.

FIG. 22 provides an illustrative example of framing the portrait image on the cell.

FIG. 23 provides an illustrative example of sliding the portrait image that is framed on multiple grill cells.

FIG. 24 provides an illustrative example of resizing and framing the image within the boundary of the cell.

FIG. 25 provides an illustrative example of creating a multi-page journal.

FIG. 26 provides an illustrative example of displaying and modifying the new page.

FIG. 27 provides an illustrative example of using a spacer to add blank spaces to the journal.

FIG. 28 provides an illustrative example of adding a header to a journal.

FIG. 29 provides an illustrative example of adding text to a journal.

FIG. 30 provides an illustrative example of specifying the text inputted in the text field to be an in line item of the journal.

FIG. 31 provides an illustrative example of adding a note to the journal.

FIG. 32 provides an illustrative example of adding another info item.

FIG. 33 provides an illustrative example of adding a date to a journal.

FIG. 34 provides an illustrative example of how some embodiments populate an info item with data.

FIG. 35 provides an illustrative example of adding a map to a journal.

FIG. 36 provides an illustrative example of adding weather information to a journal.

FIG. 37 provides an illustrative example of adding images or icons showing money to a journal.

FIG. 38 provides an illustrative example of adding travel information to a journal.

FIG. 39 conceptually illustrates a process that some embodiments use to populate such info items with data.

FIG. 40 provides an illustrative example of editing an image on the journal.

FIG. 41 provides an illustrative example of adding images.

FIG. 42 provides an illustrative example of modifying the layout of a journal.

FIG. 43 provides an illustrative example of sharing a journal by publishing the journal to a website.

FIG. 44 provides an illustrative example of how some embodiments present the published journal on a web browser.

FIG. 45 provides an illustrative example of adding a published journal to a journal home page.

FIG. 46 provides an illustrative example generating and sending a message relating the published journal.

FIG. 47 provides an illustrative example of synchronizing edits to a local journal with a corresponding remote journal.

FIG. 48 conceptually illustrates a data flow diagram that provides an example of how a journal is synchronized across multiple associated devices.

FIG. 49 provides an illustrative example of how the application of some embodiments presents the local and remote journal differently.

FIG. 50 conceptually illustrates a process that some embodiments use to generate different items to publish a journal to a web site.

FIG. 51 conceptually illustrates a process that some embodiments use to publish a journal to a web site.

FIG. 52 illustrates saving a journal as web documents.

FIG. 53 provides an illustrative example of a journal settings tool to modify a journal.

FIG. 54 provides an illustrative example of modifying a designed text item.

FIG. 55 conceptually illustrates the software architecture of an image organizing and editing application of some embodiments.

FIG. 56 conceptually illustrates several example data structures associated with the image organizing and editing application of some embodiments.

FIG. 57 illustrates a detailed view of a GUI of some embodiments for viewing, editing, and organizing images.

FIG. 58 is an example of an example architecture a mobile computing device with which some embodiments described herein are implemented.

FIG. 59 illustrates a computer system with which some embodiments described herein are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments described herein provide an image organizing and editing application for creating a journal. In some embodiments, the application allows a user to select media content (e.g., images, video clips, etc.) and creates the journal by populating it with the selected content. To create a designed layout, the application of some embodiments chooses certain images to be larger than other images on the journal. For example, the application may identify an image that is captioned or marked as a favorite, and present that image as a larger image (e.g., at a higher resolution) than some of the other images.

Once the layout is created, the application allows the user to modify it in a number of different ways to build a story around the images in the journal. For example, the user can layout the story by removing images from the journal, making some images bigger or smaller than others, rearranging the images, and adding additional pages to the journal, etc. The user can also use a map tool to add a map that shows a location (e.g., of a past vacation destination), or use a weather tool to add information about what the weather was like at the location. In addition, the application provides a text tool to input text (e.g., that describes of his or her experience at the vacation destination).

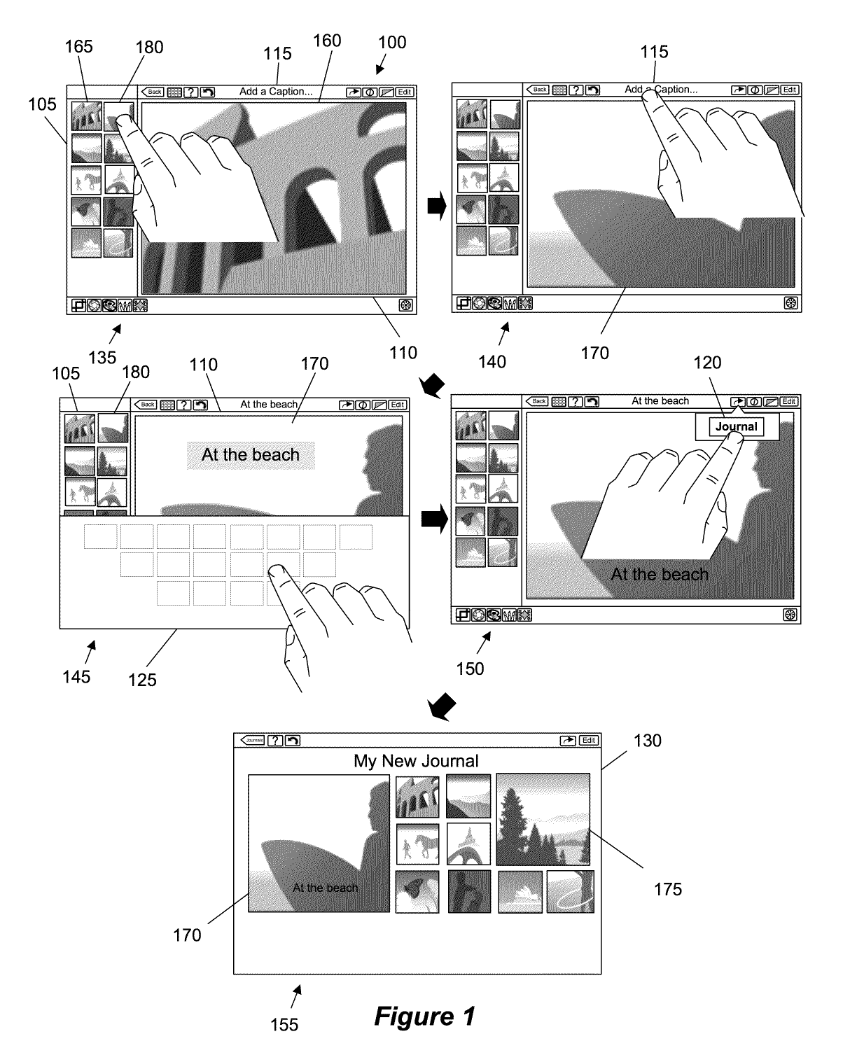

In some embodiments, the application allows the user to share the journal in a number of different ways. For example, the user can publish the journal to a website, display a slide show of the images in the journal, etc. Many more examples will be described below in the following sections. However, before describing these examples, an image organizing and editing application with such journal authoring features will now be described by reference to FIG. 1.

For some embodiments, FIG. 1 illustrates a graphical user interface (“GUI”) 100 of an application with such journal authoring features. Specifically, this figure illustrates in five operational stages 135-155 how the GUI 100 can be used to easily generate a journal using several images. As shown in FIG. 1, the GUI 100 includes a thumbnail display area 105, an image display area 110, a caption tool 115, and a journal tool 120.

The thumbnail display area 105 is an area within the GUI 100 through which the application's user can view thumbnail representations of images. The thumbnails may be from a selected collection such as an album or a library. Thumbnails are small representations of a full-size image, and represent only a portion of an image in some embodiments. For example, the thumbnails in the thumbnail display area 105 are all squares, irrespective of the aspect ratio of the full-size images. In order to determine the portion of a rectangular image to use for a thumbnail, the application identifies the smaller dimension of the image and uses the center portion of the image in the longer dimension.

As shown in FIG. 1, the thumbnails are presented in a grid format having several rows and columns. In some embodiments, the application allows the user to change the number of thumbnail images that are shown on each row. For example, the application of some embodiments allows the user to change the number of thumbnails overlaid on each row by increasing or decreasing the width of the thumbnail display area 105. Alternatively, the application may allow the user to change the size of the thumbnail images. The user may select one or more images in the thumbnail display area 105. In some embodiments, the selected thumbnails are displayed with a highlight or some other indicator of the selection.

The image display area 110 displays the one or more selected images at a larger resolution. This typically is not the full size of the image (which is often of a higher resolution than the display device). As such, the application of some embodiments stores a cached version of the image designed to fit into the image display area 110. Images in the image display area 110 are displayed in the aspect ratio of the full-size images. When one image is selected, the application displays the image as large as possible within the image display area 110 without cutting off any portion of the image. When multiple images are selected, the application of some embodiments displays the images in such a way as to maintain their visual weighting by using approximately the same number of pixels for each image, even when the images have different aspect ratios.

In some embodiments, the image display area 110 is a selection tool that can be used to perform a variety of different editing operations. For instance, the user can select one or more portions of the displayed image in order to the crop the image, remove a blemish, remove red eye, etc. In conjunction with these editing operations, or instead of it, the image display area 110 may be used to mark or tag an image with a marking. One example of such a marking is a caption that provides a description, comment, or title for the image.

To facilitate the captioning, the image organizing and editing application provides a caption tool 115. The user can select this tool 115 and input text to caption an image. Once captioned, the application of some embodiments displays an indication to show that the image is captioned. For example, the application may display the image in the thumbnail display area 105 and/or the image display area 110 with the caption. In some embodiments, the application displays the caption at least partially over the image.

The journal control 120 is a tool within the GUI 100 that can be used to generate a journal. The journal can be created using all images from a collection (e.g., those images represented in the thumbnail display area 105). Alternatively, the user can select a set of one or more images and then select the journal control 120. The application then creates the journal using the set of images. In some embodiments, the application allows the user to select a range of images from the thumbnail display area 105. For example, the user can select (e.g., by performing a multi-touch gesture such as tapping and holding the user's fingers on) the first and last thumbnails that correspond to the images in the range.

Having described the elements of the GUI 100, the operations of creating a journal 130 will now be described by reference to the state of the GUI during the five stages 135-155 that are illustrated in FIG. 1. In the first stage 135, the thumbnail display area 105 displays thumbnail representations of several images. As mentioned above, these images may be from a collection such as an album or a library.

As shown in the first stage 135, the image display area 110 displays an image 160. The image 160 corresponds to the first thumbnail 165 that is displayed in the thumbnail display area 105. When the user selects a second thumbnail image 180, the selection causes the image display area 110 to display a corresponding image 170, as illustrated in the second stage 140.

In the second stage 140, the user selects the caption tool 115 to caption the image 170. The third stage 145 illustrates inputting a caption for the image. Specifically, the selection of the caption tool 115 causes a virtual or on-screen overlay keyboard 125 to be displayed. The user then types in a brief text description of the image using the keyboard. The text input causes a caption to appear over the image 170 in the image display area 110. Alternatively, or conjunctively, the caption may appear over or near the thumbnail image 180 in the thumbnail display area 105.

As shown in the fourth stage 150, the user selects the journal control 120. The fifth stage 155 illustrates the GUI 100 after the selection of the journal control 120. As shown, the application has created a journal 130. Specifically, the application has populated the journal using images in a collection (i.e., the images represented in the thumbnail display area 105). By default, the application has also specified a journal layout in which some images are larger than other images. For example, the image 170 is larger than all other images in the journal, while the image 175 is smaller than image 170 but larger than the remaining images. That is, the application has specified a default journal layout that is different from a grid with images that are of the same size.

In creating the journal layout, the application of some embodiments determines which images to feature more prominently than other images. As mentioned above, the application of some embodies chooses certain images to be larger than other images on the journal. The application of some embodiments makes this determination based on one or more markings associated with the images. For example, the application may identify one or more images in a collection that are captioned, marked with a favorite tag, or some other markings. The application may then present the identified images at a higher resolution than several other images in the collection. This is shown in the fifth stage 155 as the captioned image 170 is scaled such that it is the largest image on the journal 130.

One reason for identifying a caption is that the user has taken his or her time to input the caption. Hence, the caption provides the application with an indication that the captioned image is more important to the user than other non-captioned images. In this manner, the application of some embodiments identifies such a marking to intelligently emphasize one or more images in the journal. As will be described in detail below, the application identifies other types of tags. For example, the application of some embodiments identifies images that are tagged with a favorite tag.

As mentioned above, the application of some embodiments allows the user to edit the journal in a number of different ways. These modifications include removing images from the journal, resizing the images, rearranging the images, and adding additional pages to the journal. By providing the flexibility to perform these operations, the user can create a personal journal that is different from any other journals. In other words, the user is not confined to the design of an album template, and can freely resize images, rearrange, images, etc.

In conjunction with the layout operations, or instead of it, the application of some embodiments provides several tools for adding different info items to the journal 130. Examples of such items include a map, a date, weather information, and a note. In some embodiments, the info items are pre-designed items that can be used to design the journal (e.g., to create a look of a physical or bound journal). The info items can also be used to display information associated with one or more images on the journal. For example, when a map is added to the journal, the application of some embodiments analyzes the location information (e.g., GPS data) associated with an image and displays the mapped location.

Many more examples of creating, editing, and publishing journals are described below. Section I describes an example of creating a journal based on several settings (e.g., journal theme, name, etc.). Section II then describes how some embodiments creates a journal layout.

Section III describes different examples of modifying the journal layout. Section IV then describes how the application of some embodiments frames each image on one or more grid cell of the journal layout. This section is followed by Section V that describes different editing tools for adding info items. Section VI then describes editing images. Section VII describes adding images to a journal. Section VIII then describes resetting and automatically laying out journal images. This section is followed by section IX that describes several tools for sharing a journal. Section X then describes several different alternate embodiments of the image of an image organizing and editing application. Section XI then describes software architecture of an image organizing and editing application of some embodiments. Finally, Section XII describes several example electronic systems that implement some embodiments described herein.

### I. Example Operations for Creating a Journal

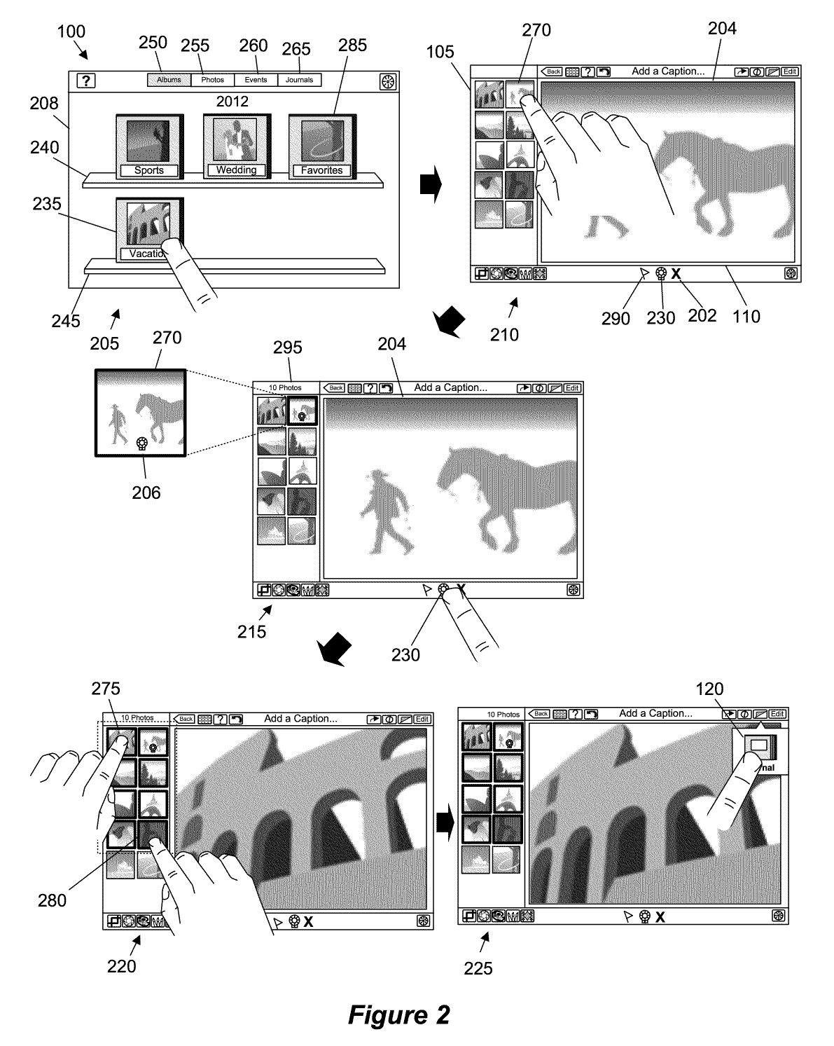

In the previous example, the image organizing and editing application creates a journal using images in a collection. FIG. 2 provides an illustrative example of selecting a range of images to create a journal. Five operational stages 205-225 of the application are shown in this figure. As shown, the GUI 100 includes an album display area 208 for displaying different photo albums and a marking tool 230 for marking images with a favorite tag. The GUI 100 also includes the thumbnail display area 105, the image display area 110, and the journal control 120 that are described above by reference to FIG. 1.

The album display area 208 is an area of the GUI 100 that displays different photo albums. Specifically, the album display area presents the photo albums in an aesthetically pleasing manner by displaying them on several shelves 240 and 245 (e.g., glass shelves). Similar to a physical or bound photo album, each photo album is displayed with an image (e.g., a key image or photo) and a title. The application of some embodiments provides a set of tools to modify the title and/or the image. In some embodiments, the application allows the user to rearrange the albums on the shelves. For example, the application's user can select (e.g., through a touch and hold operation) an album 235 on the second shelf 245 and move it to the first shelf 240. The user can also select any one of the displayed albums in order to display images of the selected album.

The marking tool 230 can be used to tag one or more images with a favorite tag. To tag an image, the user can select one or more images (e.g., from the thumbnail display area 105) and select the marking tool 230. The marking tool can be re-selected to remove the favorite tag from the tagged images. The user can also select an image flag tool 290 to flag a selected image or select an image hide tool 202 to hide the selected image.

When an image is associated with the favorite tag, the application of some embodiments displays a visual indication of the association. For example, a marking (e.g., favorite icon) may be displayed at least partially over each thumbnail representation of the image. This allows the application's user to quickly identify each tagged image in a collection. To further assist in locating the tagged images, the application may automatically associate the tagged images with a favorite album 285 that is displayed in the album display area 208. In some embodiments, the favorite album 285 is a special type of collection or ordered list that contains only images that are associated with the favorite tag.

The first stage 205 illustrates the application displaying an album view. This is indicated by an album tab 250 that is highlighted. At any time, the user can select the photos tab 255 to display all images available to the application (e.g., library of images including those taken or shot with a camera of a device on which the application executes), the events tab 260 to display images grouped by events, and the journal tab 265 to display different journals. In some embodiments, the application presents the other views similar to the album view. For example, each journal may be displayed on a shelf as a physical or bound journal with a cover having a key image and a title.

The second stage 210 illustrates the application after the selection of the album 235. As shown, the selection causes the thumbnail display area 105 to be populated with images from the selected album. The thumbnail display area includes a heading 295 that display the number of images in the album. In some embodiments, the heading also indicates the number of marked images (e.g., flagged images) that are in the album. The application of some embodiments includes, in the heading, a selectable item that when selected provides a list of filtering option. These filtering options can be used to filter the thumbnail display area 105 to only display certain images, such as marked images (e.g., flagged images, favorite images), edited images, hidden images, all images, etc.

In second stage 210, the user selects a second thumbnail 270 from the thumbnail display area 105. To provide an indication of the selection, the second thumbnail 270 is highlighted in the thumbnail display area. The selection also causes the corresponding image to be displayed in the image display area 110.

The third stage 215 illustrates tagging the selected image 204 with the favorite tag. Specifically, the user selects the marking tool 230 after selecting the second thumbnail image 270. The selection causes the image 204 to be tagged with the favorite tag. As shown in the expanded view, the selection also causes the second thumbnail image 270 to be displayed with a marking 206 (e.g., an icon) which indicates that the image 204 is tagged with the favorite tag.

The fourth stage 220 illustrates selecting a range of images from the album 235. Here, the selection is made via a multi-touch gesture. Specifically, the user taps and holds the first and last thumbnails 275 and 280. The multi-touch gesture causes the application to highlight the selected thumbnails in the thumbnail display area 105. As shown in the fifth stage 225, the user then selects the journal control 120 to create a journal using the selected range of images.

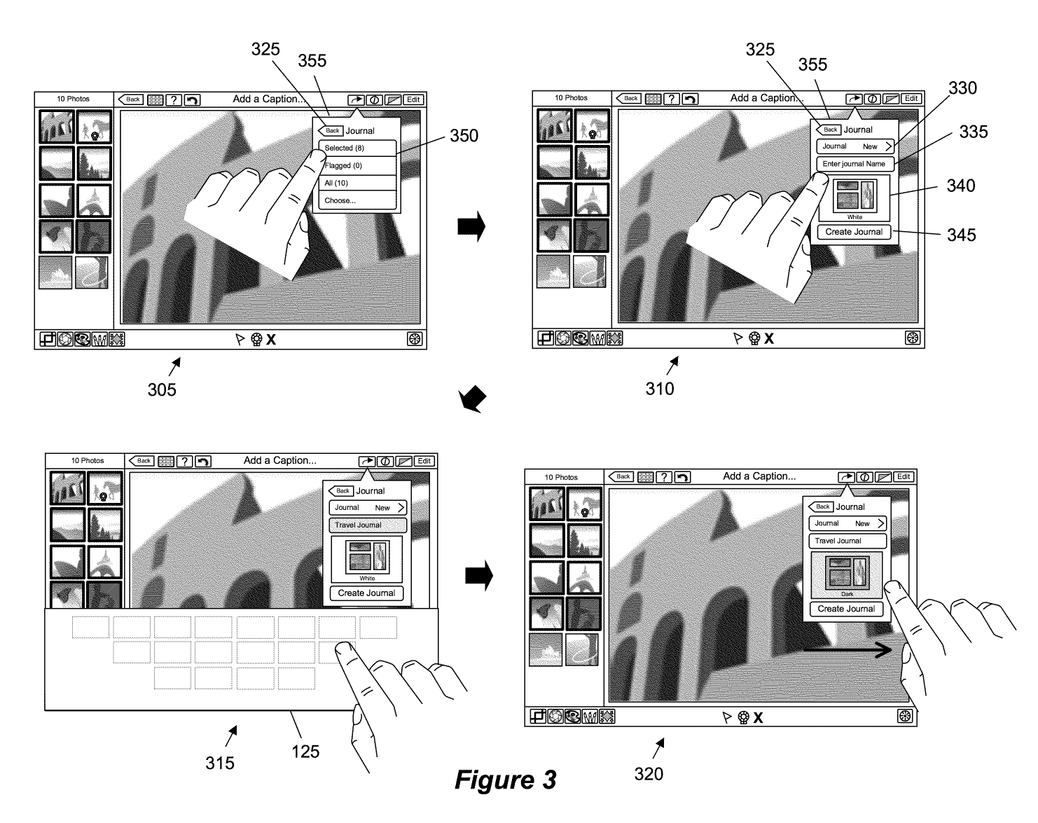

The previous example illustrated selecting a range of images for a journal. FIG. 3 provides an illustrative example of specifying different options (e.g., a name or title, journal theme) in creating the journal. Four operational stages 305-320 of the application are shown in this figure. These operations are continuations of those shown in FIG. 2.

As shown in the first stage 305, the selection of the journal tool 120 resulted in the display of the journal options window 355. The journal options window 355 includes a back button 325 to return to the journal tool 120 and a list of image options 350 to specify which images should be included in the journal. Here, the list includes options to include only selected images in the journal, only flagged images, and all images. The list also includes an option for choosing one or more images. In some embodiments, the selection of this “choose” option hides the journal options window 350 to allow the user to select one or more images (e.g., range of images) from the thumbnail display area 105. In this “choose” mode, the selection of an image may also cause the application to display a marking (e.g., a check mark) at least partially over the selected image in the thumbnail display area 105.

In the first stage 305, the user selects the option to create the journal using selected images. The selection causes the journal options window 350 to display another set of options for creating the journal, as illustrated in the second stage 310. Specifically, the set of options includes (1) a journal selector 330 to specify whether to create a new journal or add the selected images to an existing journal, (2) a name field 335 to specify a name (e.g., title) for the journal, (3) a theme selector 340 to select a theme for the journal, and (4) a create journal button 345 to create the journal. The user can also select the back button 325 to return to the list of image options 350.

In the second stage 310, the user selects the name field 335 to specify a title for the journal. As shown in the third stage 315, the selection of the name field 335 causes an on-screen overlay keyboard 125 to be displayed. The user then uses this keyboard to type a name for the journal. As the user types, the input characters are shown on the name field 335.

The fourth stage 320 illustrates the selection of a theme for the journal. As shown, the theme selector 340 displays a preview of a current theme (e.g., the default theme, user-selected theme). Here, the user interacts with (e.g., by swiping across) the theme selector 340 to switch to another theme. Specifically, the journal theme is switched from a “White” theme to a “Dark” theme. In some embodiments, a journal theme defines the background (e.g., color, pattern) of the journal. The theme may also define the size of the image boundary or edge (i.e., seam). For example, the theme may specify that two images have a particular spacing between them. In some embodiments, the application provides a “seamless” or “mosaic” theme that specifies that there are no seams or borders between images. The application of some embodiments includes one or more themes that define whether the images in the journal have frames around them.

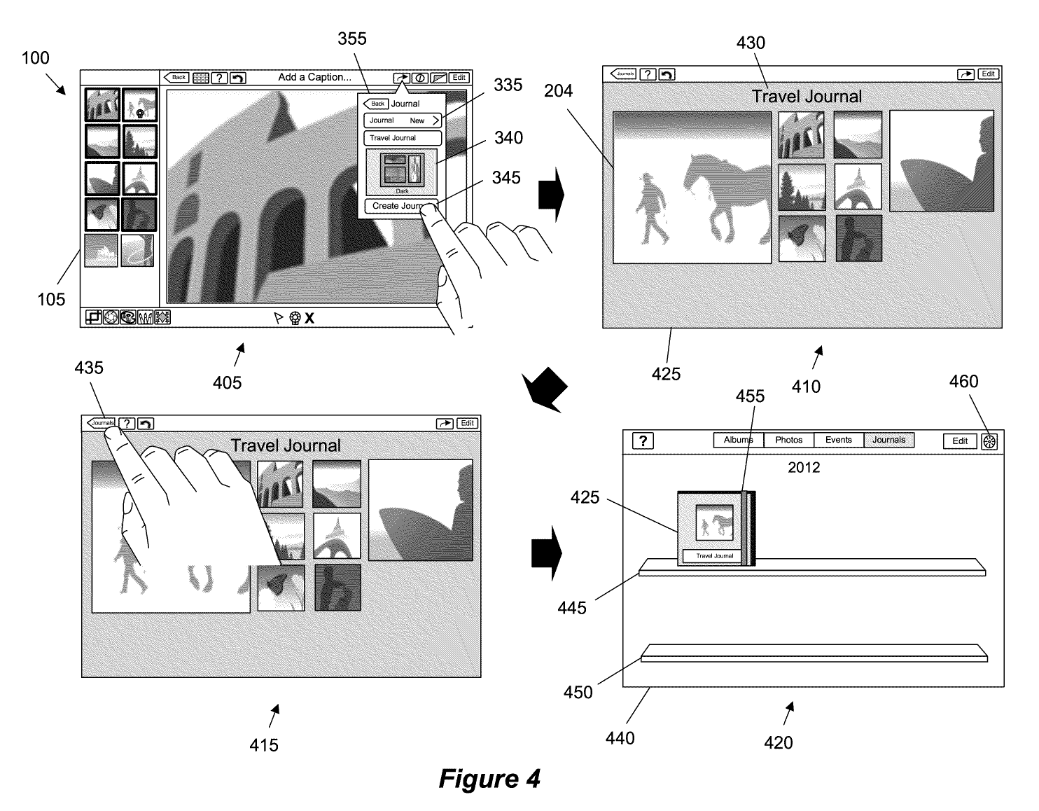

The previous example illustrated specifying several journal settings. FIG. 4 illustrates creating a journal with the specified settings. Four operational stages 405-420 of the application are shown in this figure. These operations are continuations of those shown in FIG. 3.

In the first stage 405, the user has selected a range of images for a journal. The user has also used the marking tool (not shown) to tag the image 204 with the favorite tag. As shown by the journal options window 355, the user has specified a name and selected a theme for the journal. To create the journal, the user then selects the create journal button 345.

The second stage 410 illustrates the GUI 100 after the selection of the create journal button 345. As shown, the application has created a journal 425 using the selected range of images. The application has also specified a header 430 for the journal. Specifically, the application has used the name of the journal (specified with the name field 335) as a default header. The header 430 is shown at the top of the journal 425. The header is also centered along the span of the journal.

The journal 425 has been created using the selected theme (i.e., the “Dark” theme that was specified with the theme selector 340). This is shown in the second stage 410 with the dark background (e.g., color, pattern). The application of some embodiments allows the user to select another theme to change the look of the journal. In addition, the application has performed a layout operation that made some of the images appear larger than other images. As mentioned above, the application of some embodiments determines which images to feature more prominently than other images. In some embodiments, the application makes this determination based on a content rating tag (e.g., the favorite tag). For example, the application may identify several images that are tagged with the favorite tag. The application then increases the resolution (i.e., scale) of one or more of those images. This is illustrated in the second stage 410 because the image 270 tagged with the favorite tag is the largest image on the journal 425.

The third stage 415 of FIG. 4 illustrates the selection of a button 435 to display available journals. As shown in the fourth stage 420, the selection causes the application to display a journal display area 440. Similar to the album display area, the journal display area 440 presents each journal in an aesthetically pleasing manner by displaying it (i.e., the journal's book representation) on a particular shelf (e.g., several shelves 445 or 450). In the example illustrated in the third stage 415, the shelves 445 and 450 are designed to appear as glass shelves. The journal 425 is displayed on the shelf 445. That is, the journal 425 is displayed on one of its own journal shelf and not an album shelf, in some embodiments. At any time, the user can select the journal 425 on the shelf 445 to return to the previous view.

As shown in the fourth stage 420, the journal 425 is presented with a particular design that is different from that of a photo album. In the example illustrated in FIG. 4, the journal 425 is presented similar to a small travel journal with an elastic band 455 around it. Similar to an album, the journal is displayed with an image (e.g., a key image or key photo) and a title. The application has used the name of the journal (specified with the journal options window 355) as a default title. The user can modify the title using the same journal options window. In some embodiment, the image organizing and editing application selects the first image in the journal as its cover image. Alternatively, the application selects an image that is marked with a particular marking. This is illustrated in the fourth stage 420, as the cover image is the image 270 that has been tagged with the favorite tag. The application may allow the user to tag an image as a key photo and then use the tagged image as the cover image.

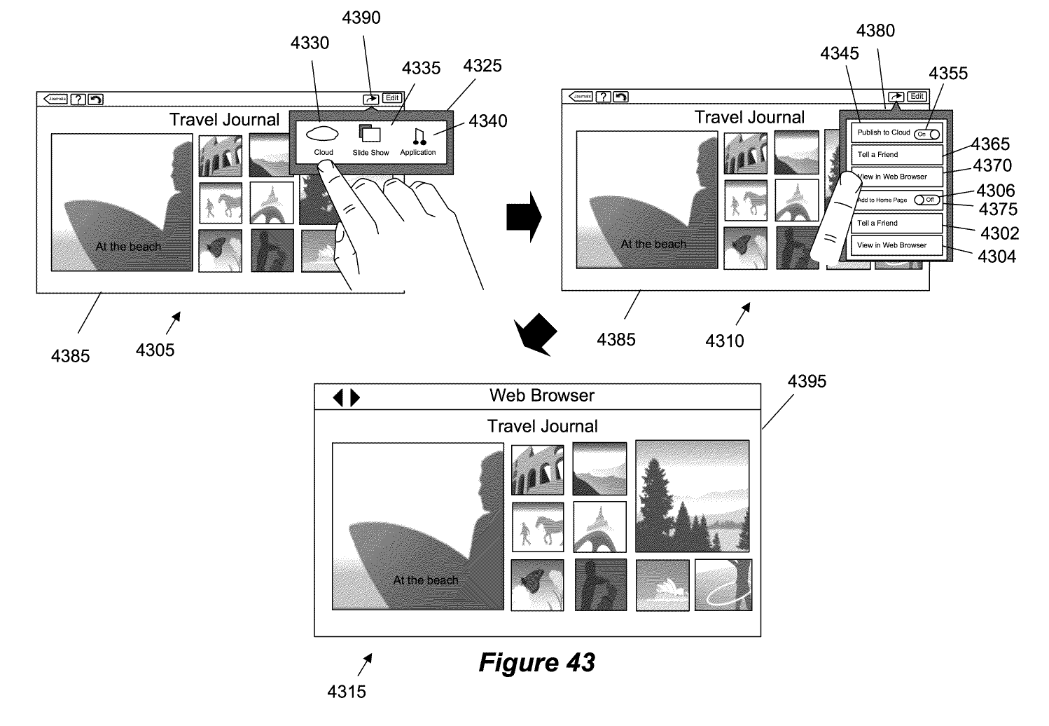

In the fourth stage 420, the application provides a settings control 460. The selection of this control 460 causes the application to display an option to edit the journal 425. When the edit option is selected, the application displays a delete button at least partially over the journal representation 425 on the shelf 445. The user can select this delete button to delete the representation 425 as well as its associated journal. When the delete option is selected, the application may display a prompt, which indicates that the delete operation cannot be undone. The prompt may also indicate that the published web page version of the journal will be deleted if the journal is deleted. Examples of publishing journals to a website will be described in detail below by reference to FIGS. 43-45.

In some embodiments, the selection of the edit option causes a tagging button to be displayed at least partially over the journal representation 425 on the shelf 445. The user can select this tagging button to mark the journal as a favorite. When a journal is marked as a favorite, the application of some embodiments displays the journal's representation in the upper shelf (e.g., shelf 425) and moves other journal representations to a lower shelf (e.g., shelf 450). The application may also remove the shelf label (e.g., “2012”) and place it on the lower shelf. At the same time, a “Favorites” label may be displayed over the top shelf.

### II. Creating a Journal Layout

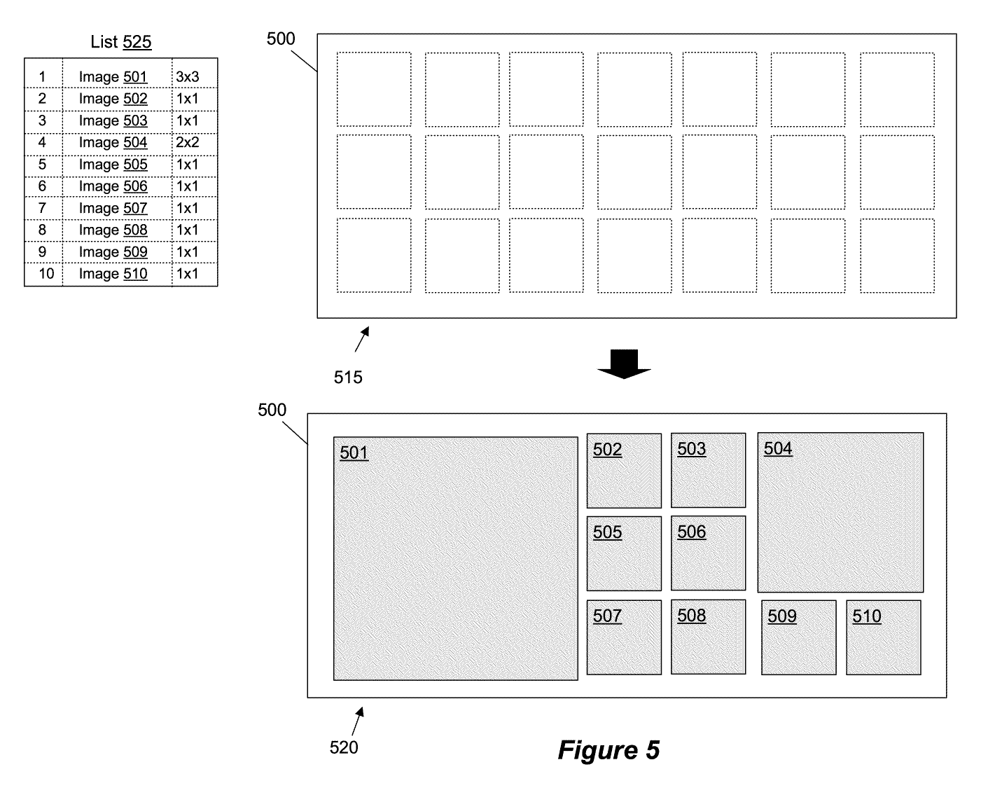

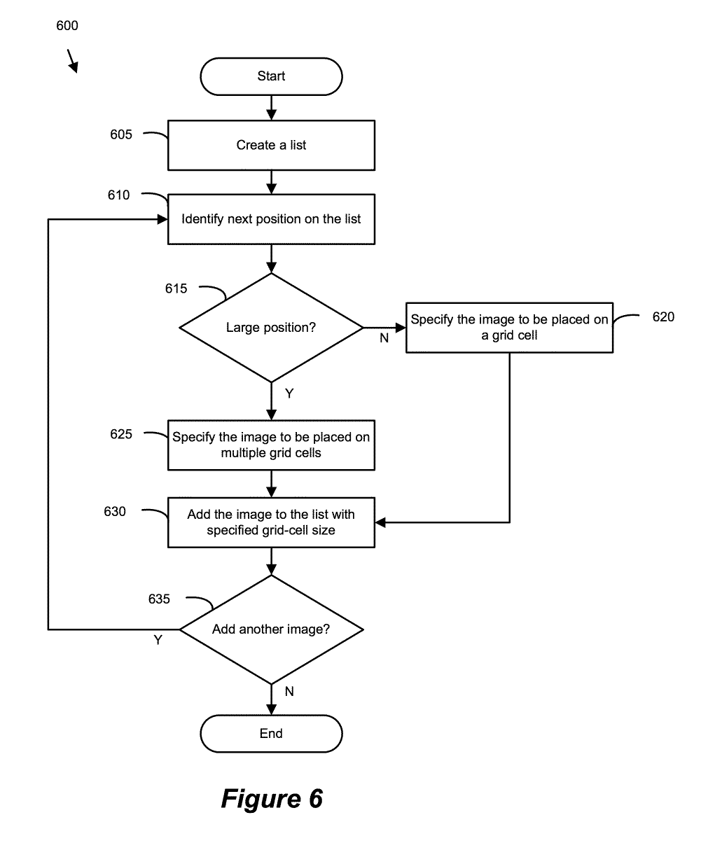

The image organizing and editing application of some embodiments uses a grid to create a journal. FIG. 5 provides an illustrative example of populating a grid 500 with several images 501-510. Specifically, this figure illustrates in a first stage 515 how the application creates a list, and in a second stage 520 how the application uses the list to populate images across the grid 500. This figure will be described by reference to FIG. 6.

The first stage 515 illustrates the grid 500 prior to populating it with images. The grid is seven cells wide. For illustrative purposes, the grid 500 includes three rows. However, the grid may include as many rows as necessary to populate it with the images. As such, the grid can have fewer rows or even more rows. In some embodiments, a maximum of one image can be placed on one grid cell. An image can also be placed on multiple grid cells. Accordingly, each row can include a maximum of seven images and one image can take up all available cells on the row. In some embodiments, the maximum number of cells that an image can take up in the vertical direction is seven cells. One of ordinary skill in the art would understand that this grid configuration is just one of many different configurations. For example, instead of the seven-wide cell configuration, the grid 500 can include additional cells or fewer cells. Also, instead of only one image per cell, the application may place several image on one cell, in some embodiments.

To populate the grid 500, the application of some embodiments creates the list 525 (e.g., a list of images). In some embodiments, the list defines the layout of the journal by specifying the position and size of each image on the grid 500. FIG. 6 conceptually illustrates a process 600 that some embodiments use to create the list 525. In some embodiments, the process 600 is performed by the image organizing and editing application. As shown, the process begins when it creates (at 605) a list. In some embodiments, the process 600 creates the list upon the user selecting a set of images and a control to create the journal. Several examples of such selections are described above by reference to FIG. 2-4.

The process then identifies (at 610) a next position on the list. At 615, the process 600 determines whether the position is a large position. If so, the process 600 specifies (at 625) a multi-cell placement for the image. Otherwise, the process 600 specifies a single cell placement (at 620) for the image. The process 600 then adds (at 625) the image to list with the specified grid-cell size.

The process 600 then determines (at 635) whether to add another image to the list. For example, the collection or the range of images may include additional images. If so, the process 600 returns to 610, which is described above. Otherwise, the process 600 ends.

Referring to FIG. 5, the list 525 includes a first image 501. In some embodiments, the image 501 represents a first image from a selected collection or a selected range of images. As shown, the image is associated with a sequence number and a size. The sequence number indicates the position of the image in the list. The size indicates the size of the image 501 in the journal. Here, the image 501 is specified to be a three by three image. That is, the image is specified to be placed on three grid cells in width and height.

In some embodiments, the application uses a set of rules to determine the size of the images on the journal. For example, a first rule might state that the first image (e.g., in the collection or the first selected image) should be the largest one and the fourth image should be the second largest one. This is shown in FIG. 5 as the first image is defined to be a three by three image, the fourth image 504 is defined to be a two by two image, and the remaining images 502, 503, 505-510 are defined to be one by one images. The application of some embodiments may repeat this pattern (e.g., rotation of sizes) for another set of images (e.g., in the collection or the range of selected images).

As shown in the second stage 512 of FIG. 5, the grid 500 is populated with the images 501-510. To place the images, the application of some embodiments traverses the grid starting at the upper left cell of the grid. The application then uses the size information from the list and places each image in one or more available cells. For example, as the first image is a three by three image, the application places the first image across three cells in both directions (i.e., width and height). The application then marks those cells as being used or allocated. The application then places the second image 502 on the fourth cell of the first row. This is followed by the third image 503 on the fifth cell of the first row. The application then places a fourth image (which is a two by two image) on the last two cells of the first and second rows. The remaining images 505-510 are then distributed across each available cell in the grid 500.

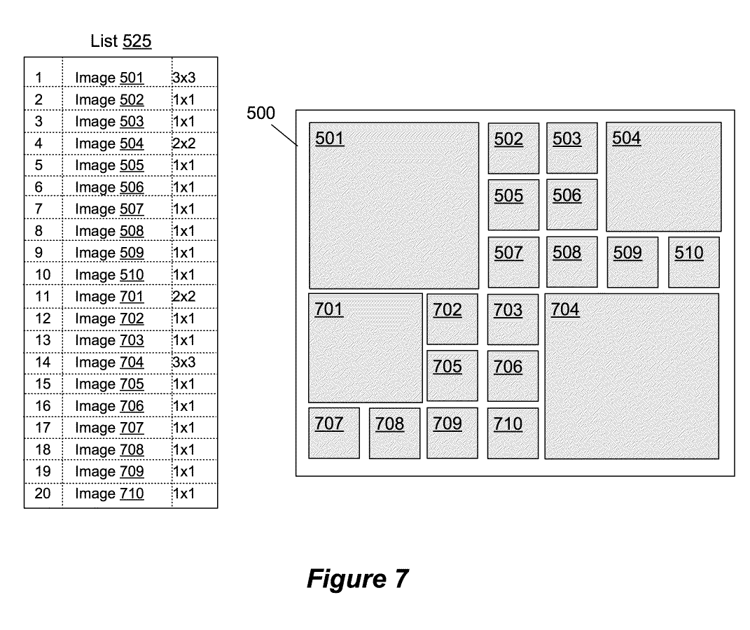

FIG. 7 illustrates placing additional images 701-710 on the grid 500. As shown, the list includes the images 701-710. Based on the set of rules, the image 701 is defined to be a two by two image, and the image 704 is defined to be a three by three image. In some embodiments, the application may use the set of rules to repeat the size pattern shown in the list. For example, the twenty-first image on the list 525 may be a three by three image similar to the first image 501, the twenty-fourth image may be a two by two image, and so forth.

As shown in the list 525, the image 701 is defined to be a two by two image. As such, the image 701 takes up two cells on the fourth and fifth rows. As the first two cells are allocated on the fourth row, the images 702 and 703 are then sequentially placed on the next available cells. This is followed by the 704, which is defined to be a three by three image. The remaining images 705-710 are then placed by traversing the rows and filling each available cell.

One of ordinary skill in the art would understand that the set of rules used to specify the size of the images may be modified. For example, the set of rules can specify a different set of images to be larger than other images. Also, the set of rules can specify that the images are larger than a three by three image (e.g., four by four, five by five, etc.). The set of rules can also specify that some images take up more space in one direction than another direction. For instance, an image may span more cells across a horizontal direction than the vertical direction.

In the previous example, the application uses a set of rules to determine which images to feature more prominently than other images. In some embodiments, the application identifies images that are tagged with one or more types of markings (e.g., a caption, keyword, favorite tag) and scales these images to occupy multiple grid cells. To scale the tagged images, the application of some embodiments performs a first pass of selected images (e.g., a collection of images, a range of images) to create a list (e.g., a list of images). The application then performs a second pass to swap positions of one image that is tagged with a particular marking with another image that is not tagged with the marking.

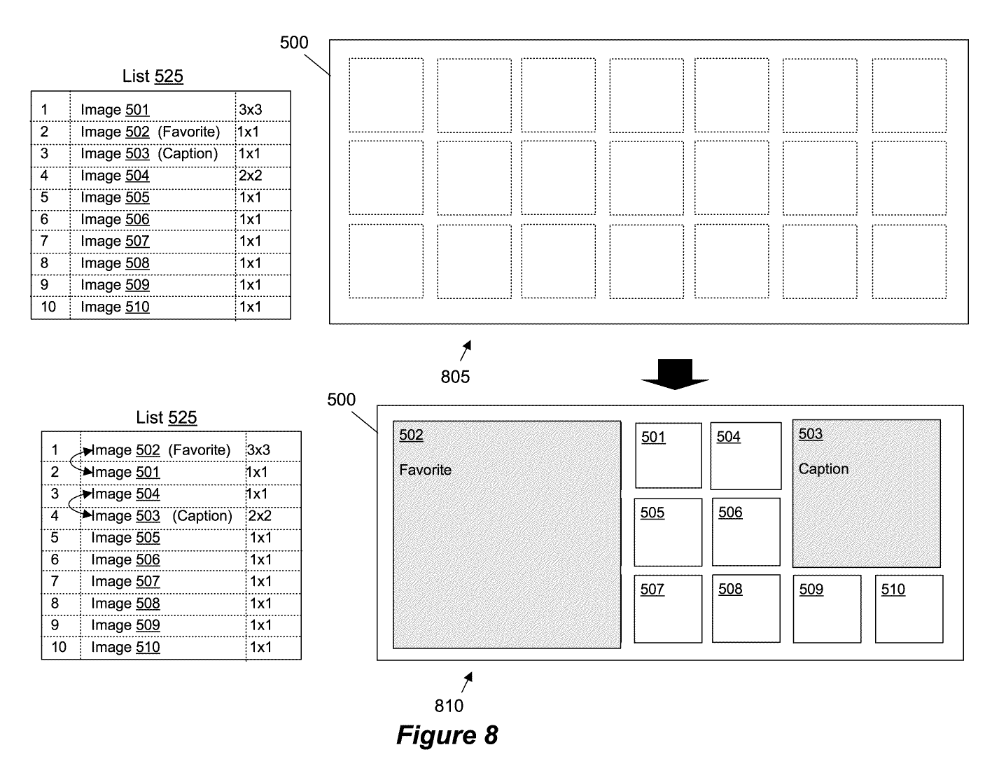

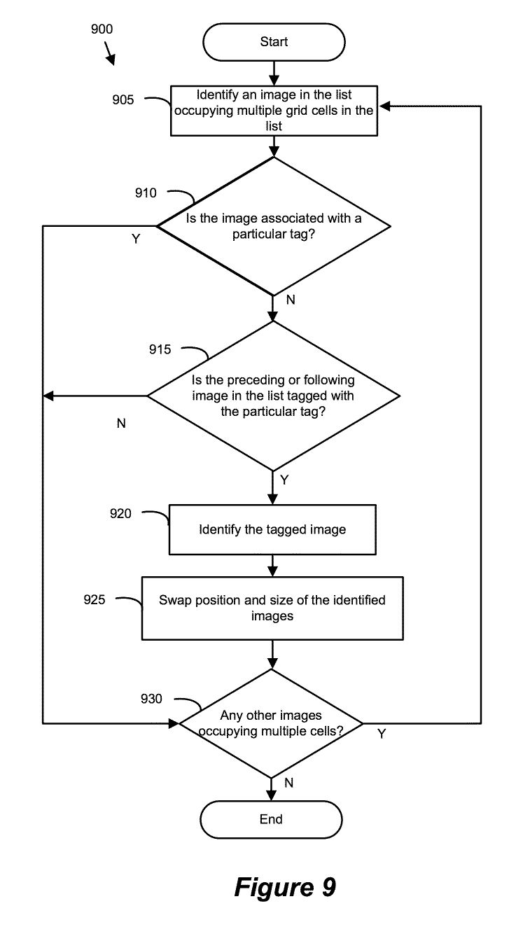

FIG. 8 provides an illustrative example of swapping images in the list 525. Two operational stages 805 and 815 of the application are shown in this figure. This figure will be described by reference to FIG. 9 that conceptually illustrates a process 900 that some embodiments use to swap images in the list. In some embodiments, the process 900 is performed by the image organizing and editing application. The process 900 begins when it identifies (at 905) an image in the list occupying multiple grid cells. In some embodiments, the process 900 identifies a position that is specified as a large image position and then identifies the image at that position.

Referring to FIG. 8, the first stage 805 shows the list 525. The list includes several positions that occupy multiple grid cells. Specifically, the first image 501 has been defined to be a three by three image, and the fourth image 504 to be a two by two image. In some embodiments, the process 900 performs the second pass by sequentially identifying each of these two images starting with the first image 501.

As shown in FIG. 9, the process 900 then determines (at 910) whether the identified image is associated with a particular tag. If so, the process 900 proceeds to 930, which is described below. Otherwise, the process 900 determines (at 915) whether another nearby image (e.g., an adjacent image) in the list is tagged with the particular tag. In some embodiments, the process might analyze only a previous image or a next image. Alternatively, the process 900 might first analyze the previous image and then analyze the next image when the previous image is not tagged with the particular tag, or vice versa. When the adjacent image is tagged, the process 900 identifies (at 920) the tagged image.

In the example illustrated in FIG. 8, the first image 501 is not associated with a caption or the favorite tag. Here, the application identifies that the second image 502 on the list is tagged with the favorite tag. In some embodiments, the application first analyzes the second image and not a previous image because the image 501 is the first image on the list and has no previous image. When an adjacent image is not tagged, the application might analyze other nearby images such as the third image 503.

Referring to FIG. 9, the process 900 swaps (at 925) the position of the identified images. The process 900 then determines (930) whether any other images are occupying multiple cells. When there is another image, the process 900 returns to 905, which is described above. Otherwise, the process 900 ends.

The second stage 810 of FIG. 8 illustrates that several images have been swapped in the list 525. Specifically, the application has identified that the second image 502 is tagged with the favorite tag, and swapped the position of the second image with the first image 501. Similarly, the application has identified that the third image 503 is associated with a caption, and swapped the position of the third image with the fourth image 504.

As shown in the second stage 810, the grid 500 is populated using the modified list with the swapped images. For example, as the second image 502 is now a three by three image, the application places the second image across three cells in both directions (i.e., width and height). The application then places the first image 501 on the fourth cell of the first row. As the third image has been swapped with the fourth image, the application then places the fourth image on the fifth cell. The application then places the third image (which is a two by two image) on the last two cells of the first and second rows. The remaining images 505-510 are then distributed across each available cell in the grid.

In the example described above, the application uses different markings (e.g., tags, captions) to swap positions and/or sizes of the images. The application of some embodiments performs other types of images analysis. For example, the application of some embodiments might analyze images to identify faces or people in order to modify the positions and/or the sizes of the images.

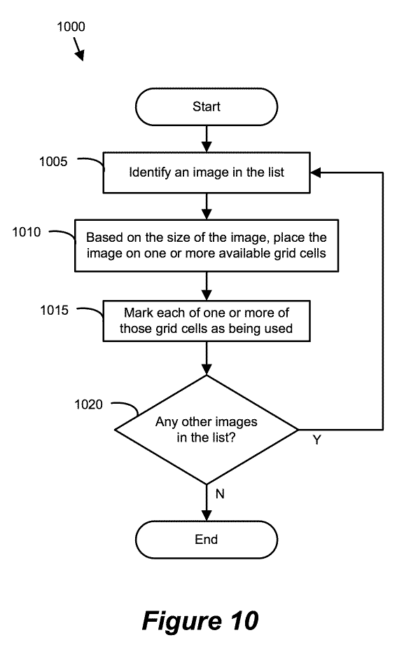

In several of the examples described above, the application traverses the grid using the list (e.g., the list of images). FIG. 10 illustrates a process 1000 that some embodiments use to traverse a grid to populate it with images. In some embodiments, the process is performed by the application. The process 1000 begins when it identifies (at 1005) an image in the list. The process 1000 then places (at 1015) the identified image on one more grid cell. Specifically, the process 1000 uses the size information in the list to place the identified image.

At 1015, the process 1000 marks each of the cells used to place the cell as being allocated or used. The process 1000 then determines (at 1020) whether there are any other images in the list. If so, the process 1020 returns to 1005, which is described above. Otherwise, the process 1000 ends.

### III. Modifying a Journal Layout

The previous section described several examples of how the image organizing and editing application creates a journal layout. Once the journal layout is created, the application of some embodiments allows the user to modify the layout in several different ways. These modifications include removing images from the journal, resizing the images, and rearranging the images. To assist the user in designing the journal, the application reflows one or more images when the journal is modified. That is, the application tries to present another (e.g., interesting) layout to account for the modification.

A. Removing Images

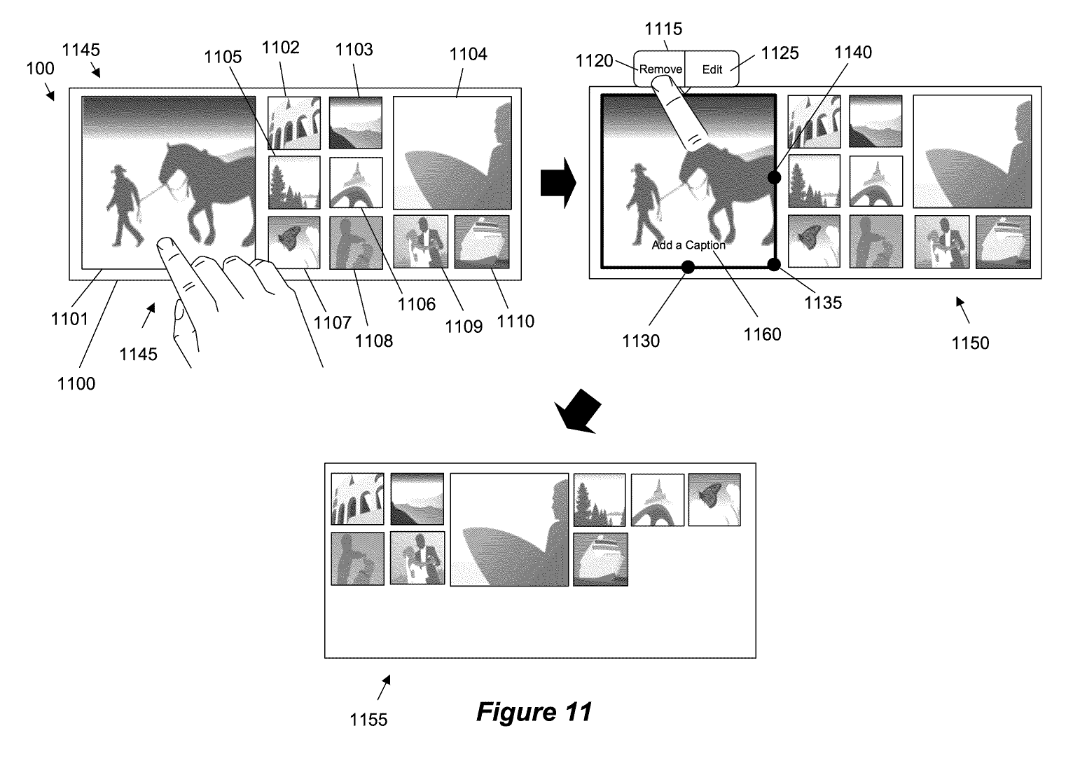

FIG. 11 provides an illustrative example of removing an image from a journal 1100. Three operational stages 1145-1155 of the application are shown in this figure. The first stage illustrates the GUI 100 after the application has created the journal 1100. The journal is populated with several images 1101-1110. These images may be from a collection such as an album or a library. Alternatively, the images may be several images (e.g., a range of images) selected with the thumbnail display area (not shown).

In the first stage 1145, the user selects the image 1101. Specifically, the user selects the image by tapping on the image 1101 on the journal 1100. The user might have also selected an edit button (not shown) to enter a journal editing mode prior to selecting the image. In some embodiments, the application displays an enlarged representation (e.g., a full screen representation) of a selected image when the editing mode is not activated.

As shown in the second stage 1150, the selection of the image 1101 causes a context menu 1115 to appear. The context menu 1115 includes a first menu item 1120 for removing the selected image and a second menu item 1125 for editing the selected image. The selection also causes a caption tool 1160 to appear. The user can select this caption tool to input a caption for the selected image. When inputted, the caption may be displayed at least partially over the image 1101 in the journal.

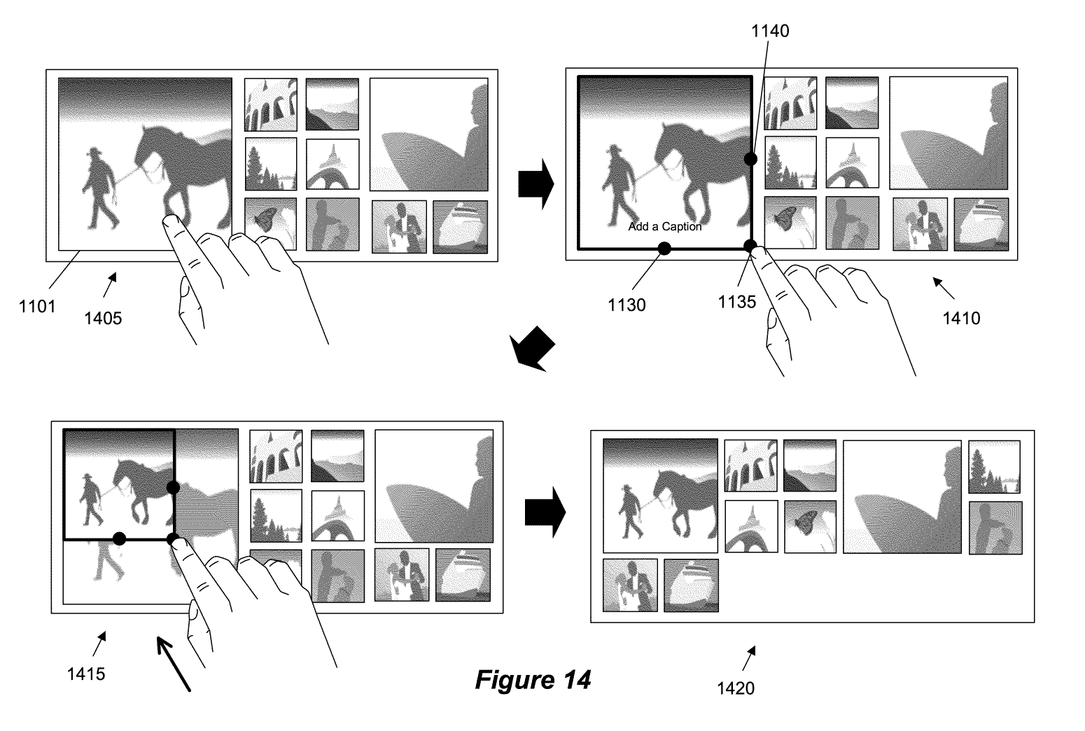

In the example illustrated in FIG. 11, the selection of the image 1101 causes several selectable items 1130-1140 to appear. These items can be used to resize the selected image in several different directions. For example, the selectable item 1130 can be used to vertically increase or decrease the size of the selected image. Several examples of resizing image will be described below by reference to FIGS. 14-17.

In the second stage 1150, the user selects the menu item 1120. As shown in the third stage 1155, the selection causes the application to remove the image 1101 from the journal 1100. However, there is no gap or blank space at a location on the journal in which the image 1101 was placed. Instead, the application has filled the gap by reflowing the remaining images 1102-1110 across a grid. By reflowing the images, the application's user does not have to manually design the journal. For example, the user does not have to move or resize one or more of the remaining images or resize to fill the gap. Accordingly, the application of some embodiments provides an interesting journal layout by moving images along the grid (e.g., a perfect grid).

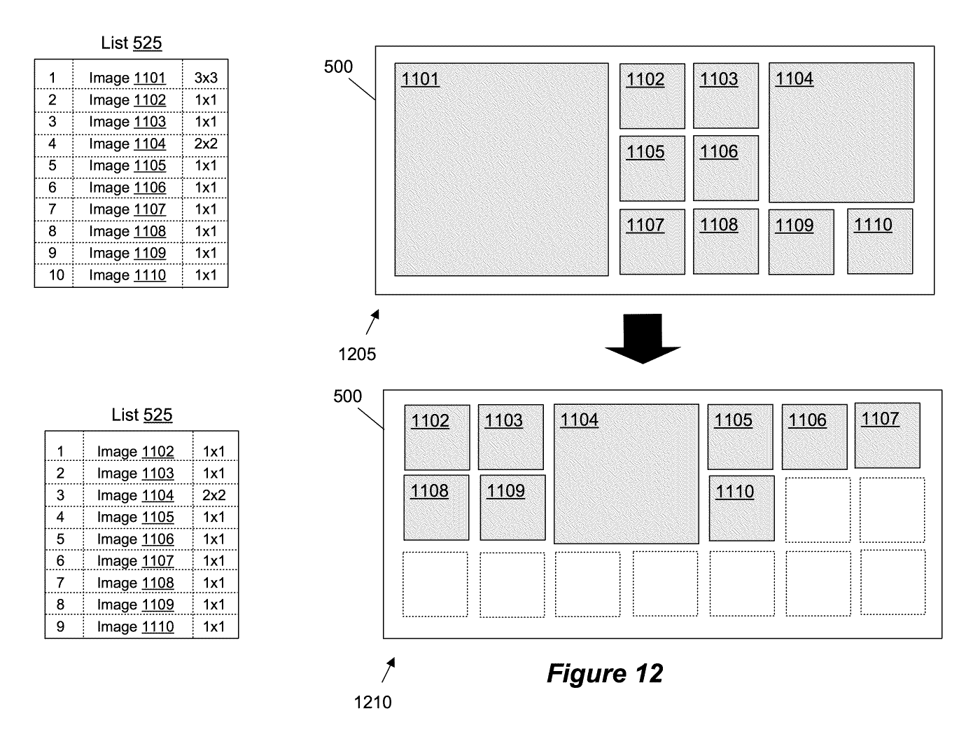

FIG. 12 provides an illustrative example of reflowing images upon removing the image 1101 from the journal. Two operational stages 1205 and 1210 of the application are shown in this figure. As shown in the first stage 1205, the list 525 includes the images 1101-1110. The first image 1101 is defined to be a three by three image, the fourth image 1104 is defined to be a two by two image, and the remaining images 1102, 1103, 1105-1110 are defined to be one by one images. Using this list, the application has flowed images across the grid 500. For example, the application placed the first image 1101 across three cells in both directions (i.e., width and height). The application then places the second and third image 1102 and 1103 on the fourth and fifth cells respectively. The application then places the fourth image 1104 (which is a two by two image) on the last two cells of the first and second rows. The remaining images 1105-1110 are then flows across each available cell in the grid.

The second stage 1210 illustrates the list 525 and the grid 500 after removing the image 1101. As shown, the image 1101 has been removed from the list 525, and each of the remaining images has been moved up in the list. For example, the image 1102 is the first image in the list, the image 1103 is the second image, and so forth. The size of the remaining images has not been modified. The grid 500 is also populated according to the list. Specifically, the image 1102 is placed on the upper left cell of the grid and each remaining images are sequentially placed on one or more available slots. For example, the image 1105 is placed on the fifth cell of the first row because the image 1104 is a two by two image that takes up third and fourth cells of the first and second rows.

B. Locking Images

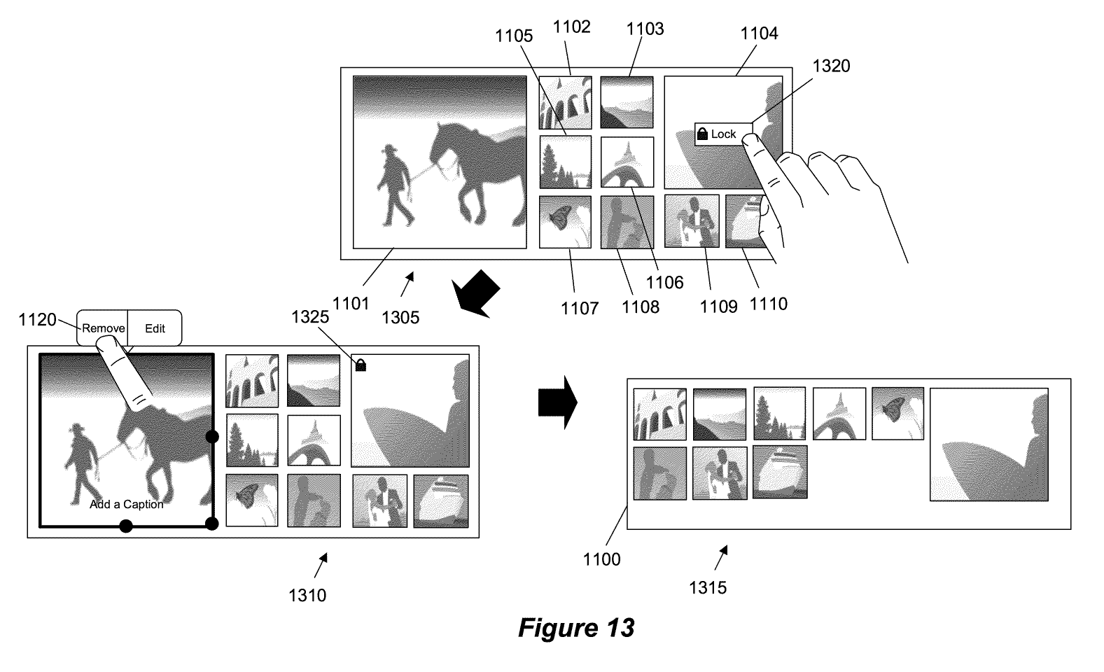

In the previous example, the image organizing and editing application reflows several images upon removing an image. In some embodiments, the application provides a locking tool that can be used to lock images to prevent the application from reflowing the locked images. FIG. 13 provides an illustrative example of locking the image 1104. Three operational stages 1305-1315 of the application are shown in this figure.

The first stage 1305 illustrates locking the image 1104. As shown, the user selects the image 1104. The selection causes a locking tool 1320 to appear. The user then selects the locking tool 1320 to lock the image. As shown in the second stage 1310, the locked image 1104 is displayed with a marking 1325 (e.g., a lock icon). This marking provides a visual indication to the user that the image 1104 is locked. Here, the user selects the image 1101 and the menu item 1120 to remove the selected image.

The third stage 1315 illustrates the journal 1100 after removing the image 1101. As shown, the application has reflowed several of the remaining image 1102, 1103, and 1105-1110 across the first two rows of the journal. However, the locked image 1104 is not affected by the reflow operation and remains at the same location on the journal.

C. Resizing Images

FIG. 14 provides an illustrative example of reducing the size of the image 1101. Four operational stages 1405-1420 of the application are shown in this figure. The first stage 1405 illustrates the selection of the image 1101. As shown, the selection causes several selectable items 1130-1140 to appear. The user can select and move any one of these items to resize the image. Specifically, the user can select and move (1) the item 1140 to modify the width of the image, (2) the item 1130 to modify the height, or (3) the item 1135 to modify both the width and height.

In the second stage 1410, the user selects the selectable item 1135 to resize both the height and width of the image 1101. The third stage 1415 illustrates reducing the size of the image 1101. Here, the user drags the selectable item 1135 on one corner of the image towards the opposite corner.

The fourth stage 1420 illustrates the journal after reducing the size of the image 1101. As shown, the image 1101 has been resized from a three by three image to a two by two image. To account for the size modification, the application has reflowed several of the remaining images across the journal.

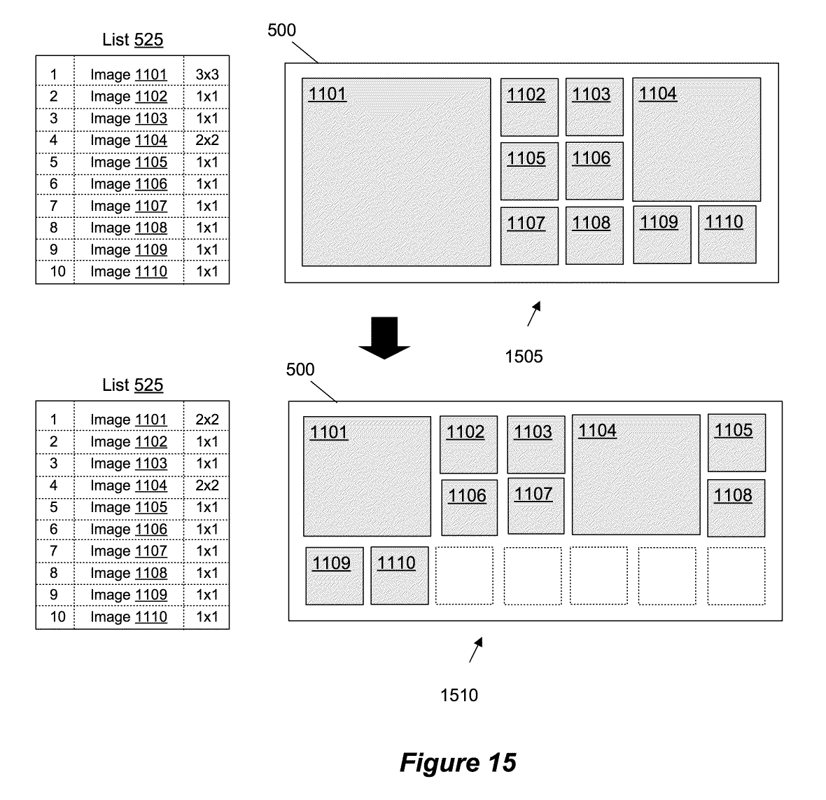

FIG. 15 provides an illustrative example reflowing images upon resizing the image 1101 from the journal. Two operational stages 1505 and 1510 of the application are shown in this figure. As shown in the first stage 1505, the list 525 includes the images 1101-1110. The first image 1101 is defined to be a three by three image, the fourth image 1104 is defined to be a two by two image, and the remaining images 1102, 1103, 1105-1110 are defined to be one by one images. Using this list, the application has flowed images across the grid 500.

The second stage 1510 illustrates the list 525 and the grid 500 after resizing the image 1101. As shown in the list 525, the image has been scaled from a three by three image to a two by two image. The grid 500 is also populated according to the list. Specifically, the image 1101 is placed on the first two cells of the first and second rows, and each remaining images is sequentially placed on one or more available cell.

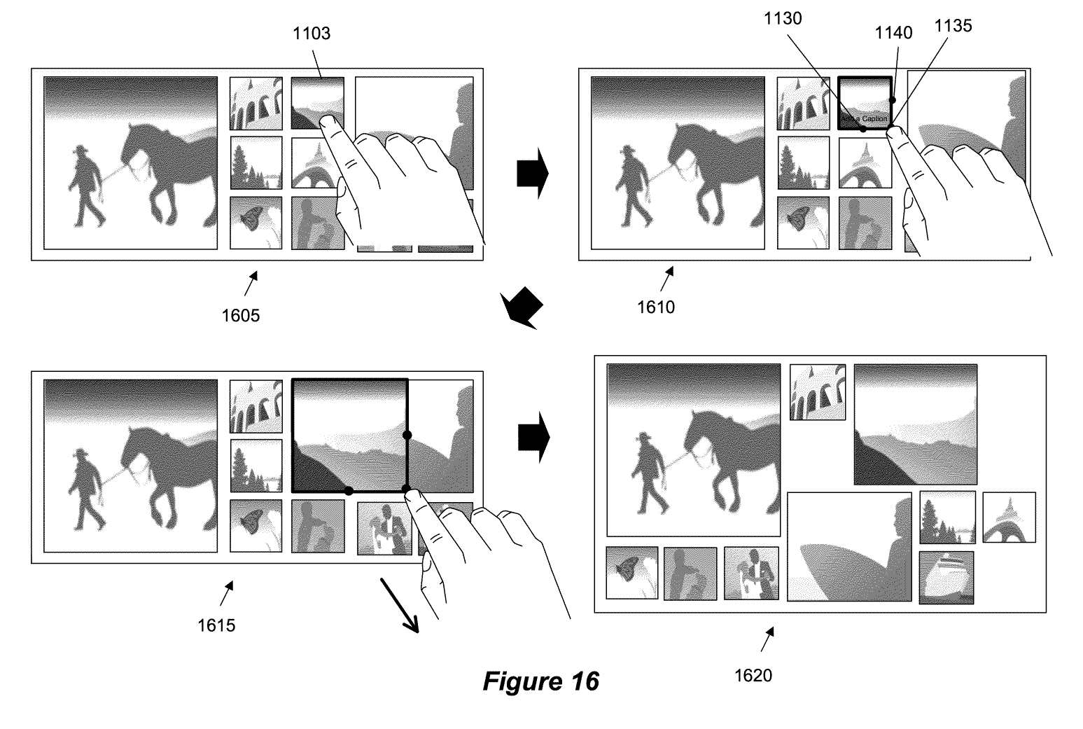

FIG. 16 provides an illustrative example of increasing the size of the image 1103. Four operational stages 1605-1620 of the application are shown in this figure. The first stage 1605 illustrates the selection of the image 1103. As shown in the second stage 1610, the selection causes several selectable items 1130-1140 to appear.

In the second stage 1610, the user selects the selectable item 1135 to resize both the height and width of the image 1103. The third stage 1615 illustrates enlarging the size of the image 1103. Here, the user drags the selectable item 1135 on one corner of the image away from the opposite corner.

The fourth stage 1620 illustrates the journal after increasing the size of the image 1103. As shown, the image 1103 has been resized from a one by one image to a two by two image. To account for the size modification, the application has reflowed several of the remaining images across the journal.

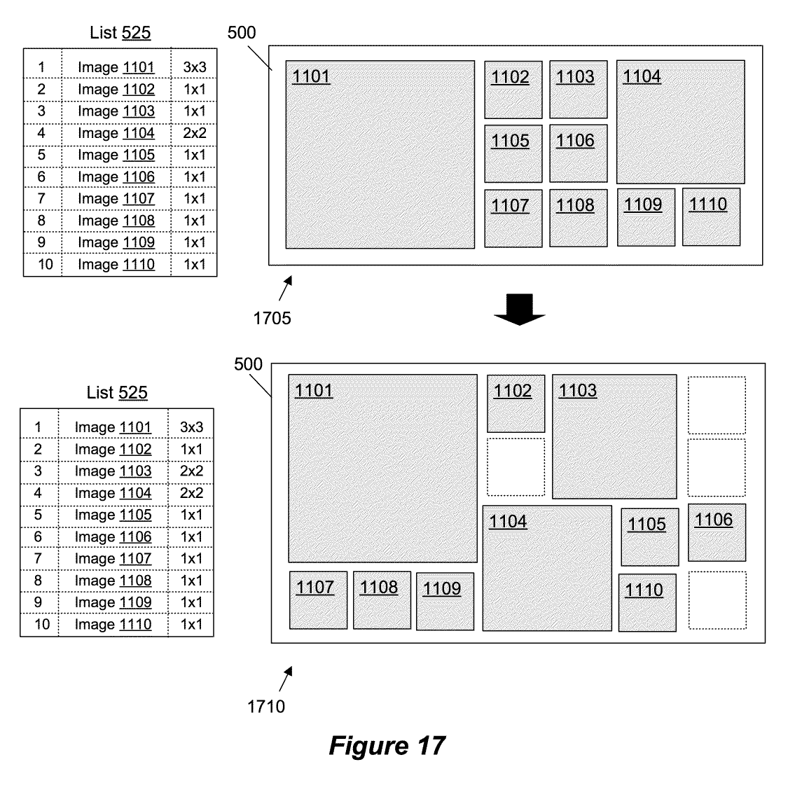

FIG. 17 provides an illustrative example of reflowing images upon resizing the image 1103 from the journal. Two operational stages 1705 and 1710 of the application are shown in this figure. As shown in the first stage 1705, the list 525 includes the images 1101-1110. The first image 1101 is defined to be a three by three image, the fourth image 1104 is defined to be a two by two image, and the remaining images 112, 113, 115-1110 are defined to be one by one images. Using this list, the application has flowed images across the grid 500.

The second stage 1710 illustrates the list 525 and the grid 500 after resizing the image 1103. The list 525 indicates that the image has been scaled from a one by one image to a two by two image. The grid 500 is also populated according to the list. As shown in the second stage 1710, the resizing of the image 1103 caused the grid 500 to have several empty cells.

Specifically, as the fourth image 1104 is a two by two image, it cannot be placed on the seventh and eighth cells of the first and second rows. In addition, the image 1104 cannot be placed on the remaining fourth cell of the second row. Accordingly, the application places the image 1104 on fourth and fifth cells of the third and fourth rows.

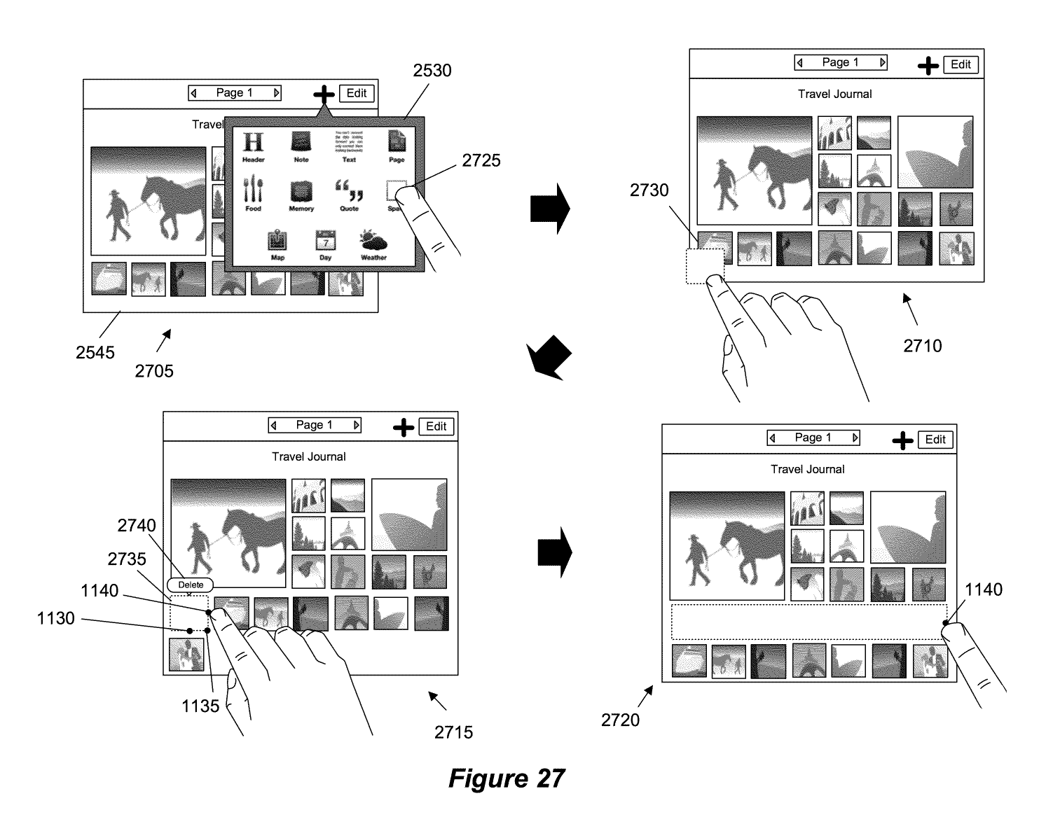

In some embodiments, the application provides several tools to design around such empty cells. One example of such tool is the locking tool described above by reference to FIG. 13. As will be described below by reference to FIG. 27, the application of some embodiments provides an editing tool for adding a spacer. The spacer can be added to one or more grid cells; however, it does not appear in the journal. As such, the user can push items (e.g., images) down the list 525 using this spacer.

D. Rearranging Images

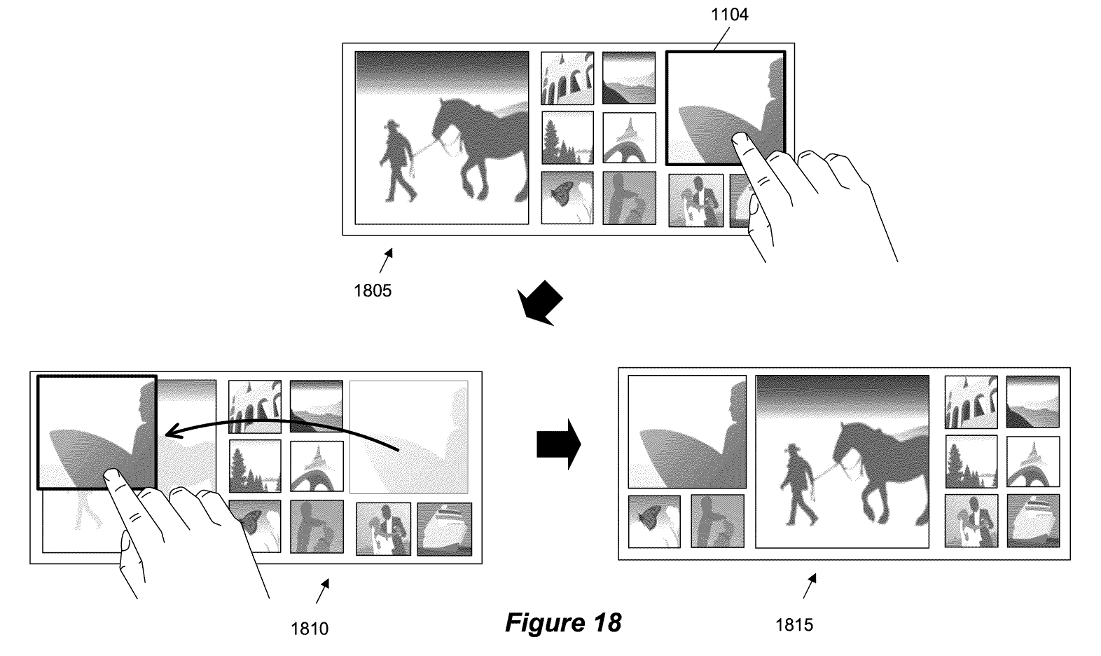

FIG. 18 provides an illustrative example of moving the image 1104 from one location on the journal to another location. Three operational stages 1805-1815 of the application are shown in this figure. The first stage 1805 illustrates the selection of the image 1104. Here, the user selects the image by tap and hold operation. As shown in the second stage 1810, the user then drags and drops the image from one side of the journal to the other side.

The third stage 1815 illustrates the journal after moving the image 1104. Specifically, the image is placed at the upper left corner of the journal. The application has also reflowed several of the remaining images across the journal.

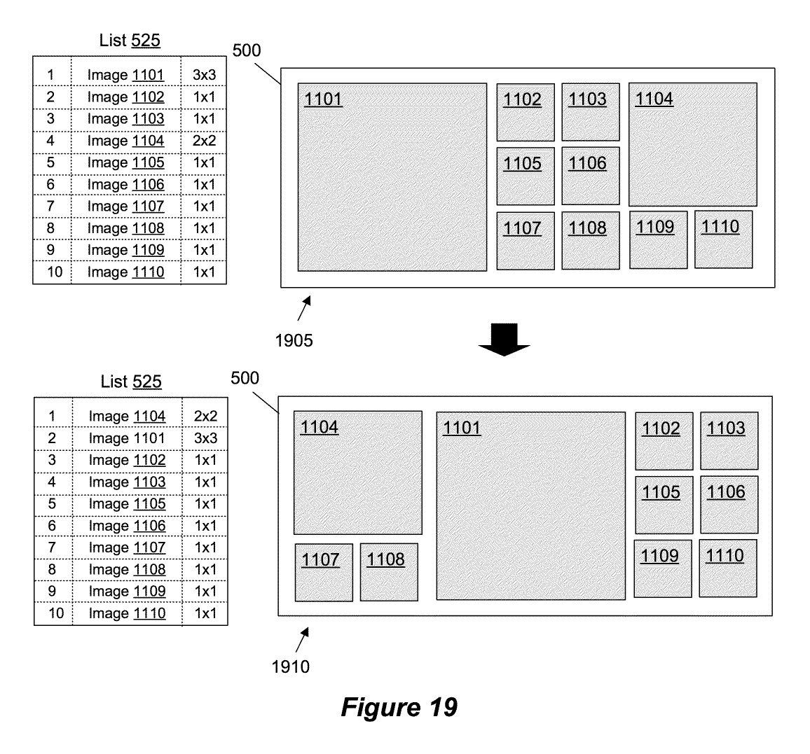

FIG. 19 provides an illustrative example of reflowing images upon moving the image 1104 in the journal. Two operational stages 1905 and 1910 of the application are shown in this figure. As shown in the first stage 1905, the list 525 includes the images 1101-1110. The first image 1101 is defined to be a three by three image, the fourth image 1104 is defined to be a two by two image, and the remaining images 1102, 1103, 1105-1110 are defined to be one by one images. Using this list, the application has populated images across the grid 500.

The second stage 1910 illustrates the list 525 and the grid 500 after moving the image 1104. The list 525 indicates that the image 1104 has been moved from the fourth position to the first position. The grid 500 is also populated according to the list. Specifically, the image 1104 is placed on the first two cells of the first and second rows, and the image 1101 is placed on the third, fourth, and fifth cells of the first three rows. The remaining images are then sequentially placed on the next available grid cell.

### IV. Framing Images

In several of the examples described above, the images are placed on one or more grid cells. In some embodiments, the grid cells are square cells. Accordingly, there can be a mismatch between the aspect ratio of the image and the set of one or more cells. To account for this mismatch, the image organizing and editing application of some embodiments frames images within the set of grid cells.

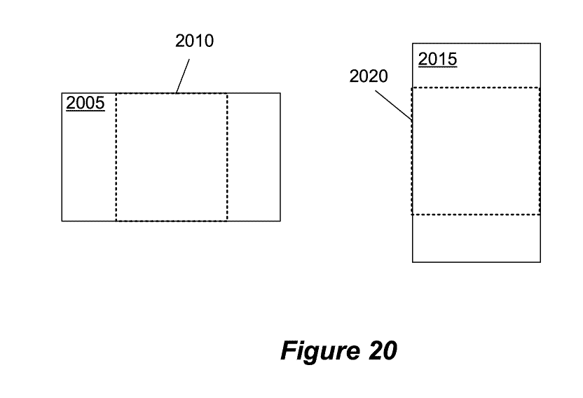

FIG. 20 illustrates framing a landscape image 2005 and a horizontal image 2015. As shown, the figure includes two square cells 2010 and 2020. The landscape image 2005 is placed on the cell 2010, and the horizontal image 2015 is placed on the cell 2020.

To account for the mismatch in the aspect ratio, the application of some embodiments performs a fit-to-fill operation. This operation fits a landscape or horizontal image in one or more grid cells along the smaller of the two dimensions (i.e., width and height). The application then allows the user move (e.g., slide, pan) the image along the larger of the two dimensions.

As shown in FIG. 20, the height of the landscape image 2005 is matched with the height of the cell 2010. In matching the height, the application also maintains the image's aspect ratio. The application then centers the landscape image 2005 on the cell 2010. Accordingly, the left and right sections of the images are outside the boundary of the cell. These outer sections represent the portions of the landscape image that is not displayed on a journal.

Conversely, the width of the portrait image 2015 is matched with the width of the cell 2020. In matching the width, the application also maintains the image's aspect ratio. The application then centers the portrait image 2015 on the cell 2020. Accordingly, the upper and lower sections of the portrait image are outside the boundary of the cell. These outer sections represent the portions of the portrait image that is not displayed on a journal.

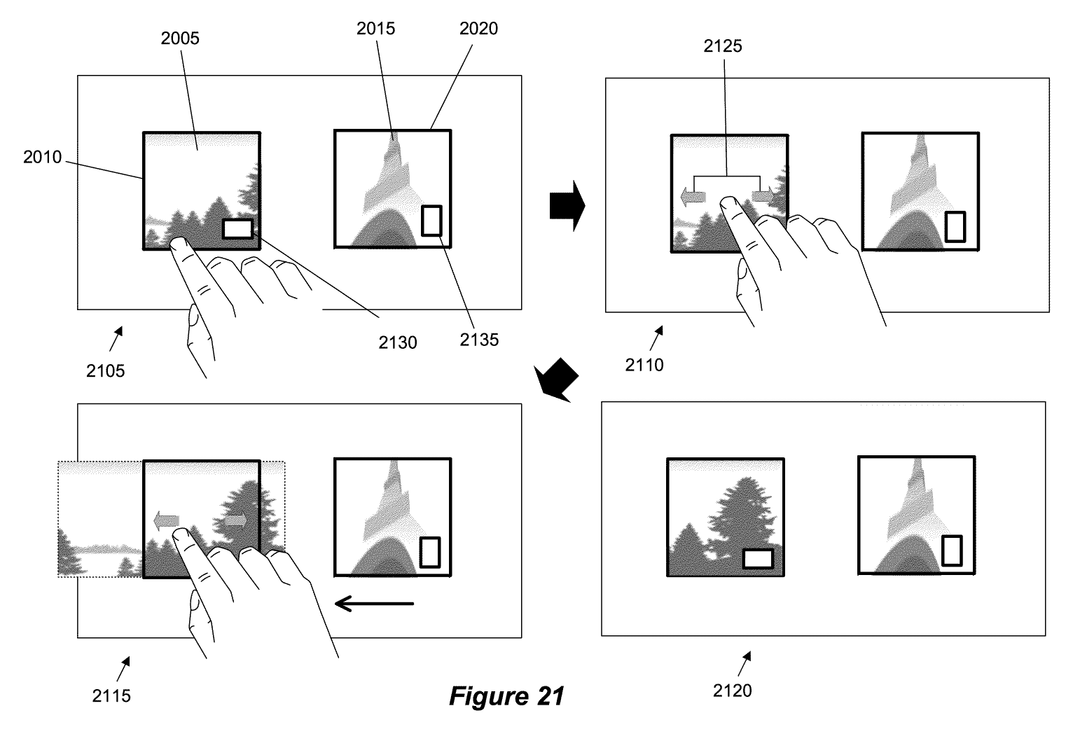

To account for the mismatch, the application of some embodiments allows the user to move (e.g., slide, pan) the image along the mismatched direction. FIG. 21 provides an illustrative example of framing the landscape image 2005 on the cell 2010. Four operational stages 2105-2120 of the application are shown in his figure.

The first stage 2105 illustrates the landscape image 2005 and the portrait image 2015 on a page of a journal. The images 2005 is displayed on the grid cell 2010, and the image 2015 is displayed on the grid cell 2020. These images are displayed with several markings 2130 and 2135 (e.g., rectangles). The shape or orientation of the marking 2130 indicates the image 2005 is a landscape image, and the shape or orientation of the marking 2135 indicates that the image 2015 is a portrait image. In some embodiments, the markings 2130 and 2135 (e.g., rectangles) are only shown when the image application is in a journal editing mode. For instance, the user might first open the journal using the image application and then select an edit button (not shown) to enter the journal editing mode.

In the first stage 2105, the user selects the landscape image 2005. As shown in the second stage 2110, the selection (e.g., double tap) causes several directional arrows 2125 to appear over the image. The user might have double tapped on the image to display the directional arrows 2125. These arrows provide an indication that the user can move (e.g., slide, pan) the image along the horizontal direction.

The third stage 2115 illustrates framing the landscape image 2005. The user moves the landscape image 2005 along the horizontal direction. As shown in the fourth stage 2120, the movement caused a right section of the image to be within the boundary of the cell 2010 and the left section to be outside the boundary.

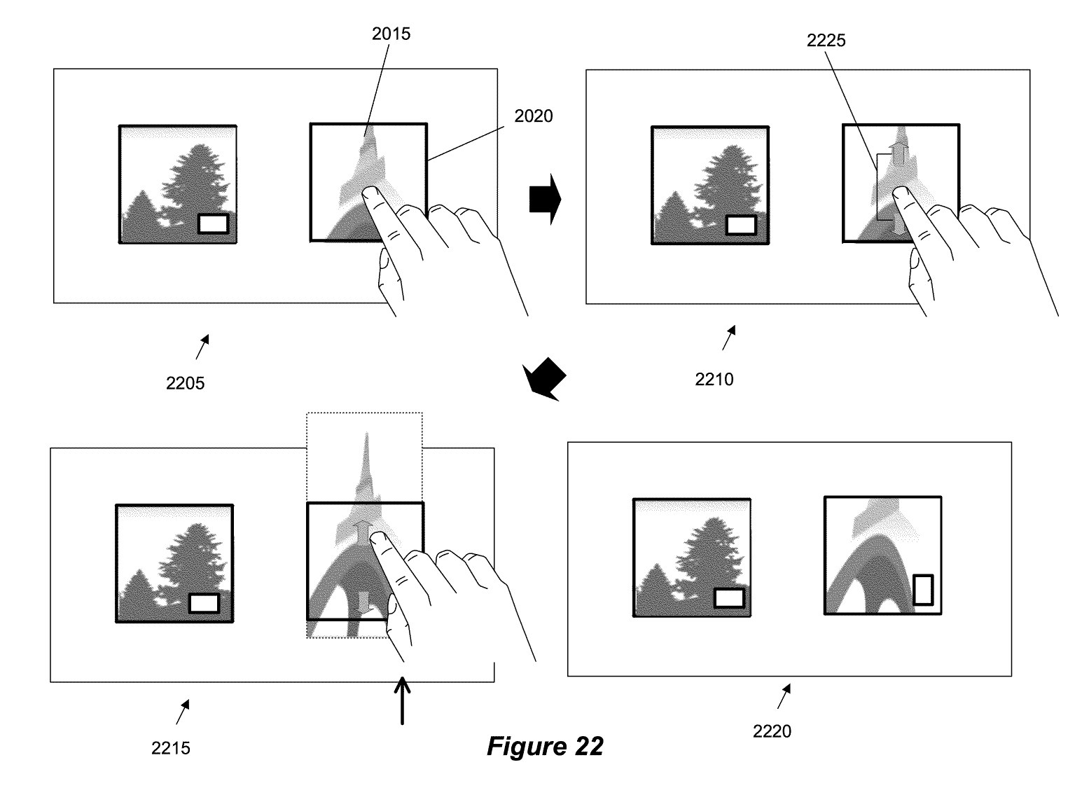

FIG. 22 provides an illustrative example of framing the portrait image 2015 on the cell 2020. Four operational stages 2205-2220 of the application are shown in his figure. The first stage 2205 illustrates the selection of the portrait image 2015. As shown in the second stage 2210, the selection (e.g., double tap) causes several directional arrows 2225 to appear over the image. The user might have double tapped on the image to display the directional arrows 2225. These arrows provide an indication that the user can move (e.g., slide, pan) the image along the vertical direction.

The third stage 2215 illustrates framing the portrait image 2015. The user moves the portrait image 2015 along the vertical direction. As shown in the fourth stage 2220, the movement causes a lower section of the image to be within the boundary of the cell 2020 and an upper section to be outside of the boundary.

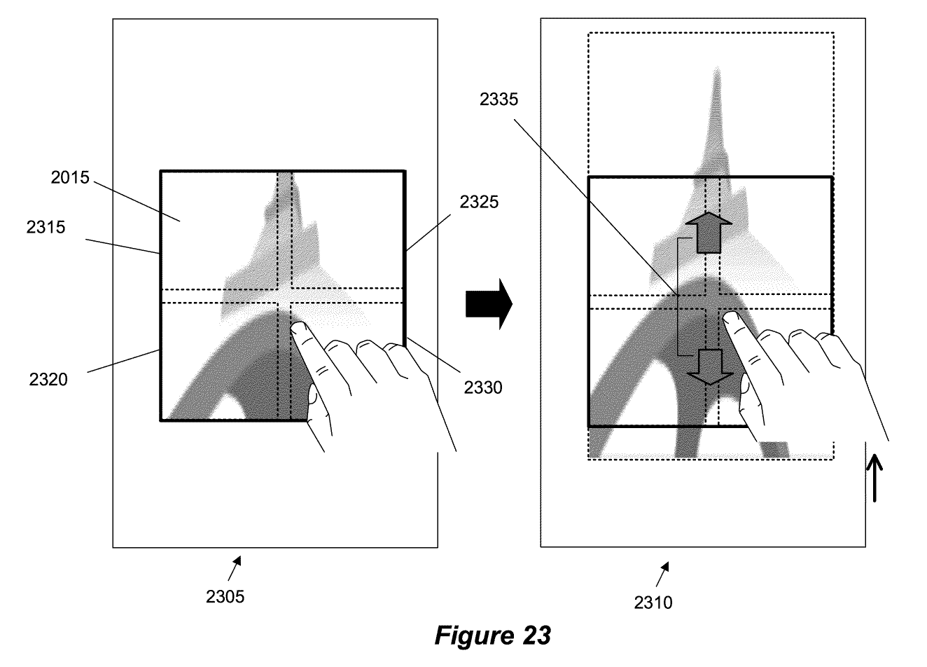

As mentioned above, the application of some embodiments places an image on multiple grid cells. FIG. 23 provides an illustrative example of sliding the portrait image that is framed on multiple grill cells. Two operational stages 2305 and 2310 of the application are shown in this figure. As shown, the portrait image 2015 is placed on multiple cells 2315-2330. The width of the portrait image 2015 is also aligned with these cells.

In the first stage 2305, the user selects the image 2015. As shown in the second stage 2310, the selection causes the directional arrows 2335 to appear. The user then moves the image 2015 along the vertical direction to frame the image.

In the example described above, the image organizing and editing application performs a fit-to-fill operation that fits a landscape or horizontal image in one or more grid cells along the smaller of the two dimensions (i.e., width and height). The fit-to-fill operation may also center the image in one or more grid cells. The user can then select the image and slide it along the larger of the two dimensions.

In some embodiments, the application performs a fit-to-fill operation that fits an image along the larger of the two dimensions and allows the user to slide the image along the smaller dimension. This can occur when an image is resized such that it is not square on a journal page.

For instance, when a landscape image is resized horizontally and not vertically, the application may fit the width of the image on several grid cells and allow the user to slide the image along the vertical direction. Conversely, when a portrait image is resized vertically and not horizontally, the application may fit the height of the image on several grid cells and allow the user to slide the image along the horizontal direction. Several examples of resizing images are described above by reference to FIGS. 13-17.

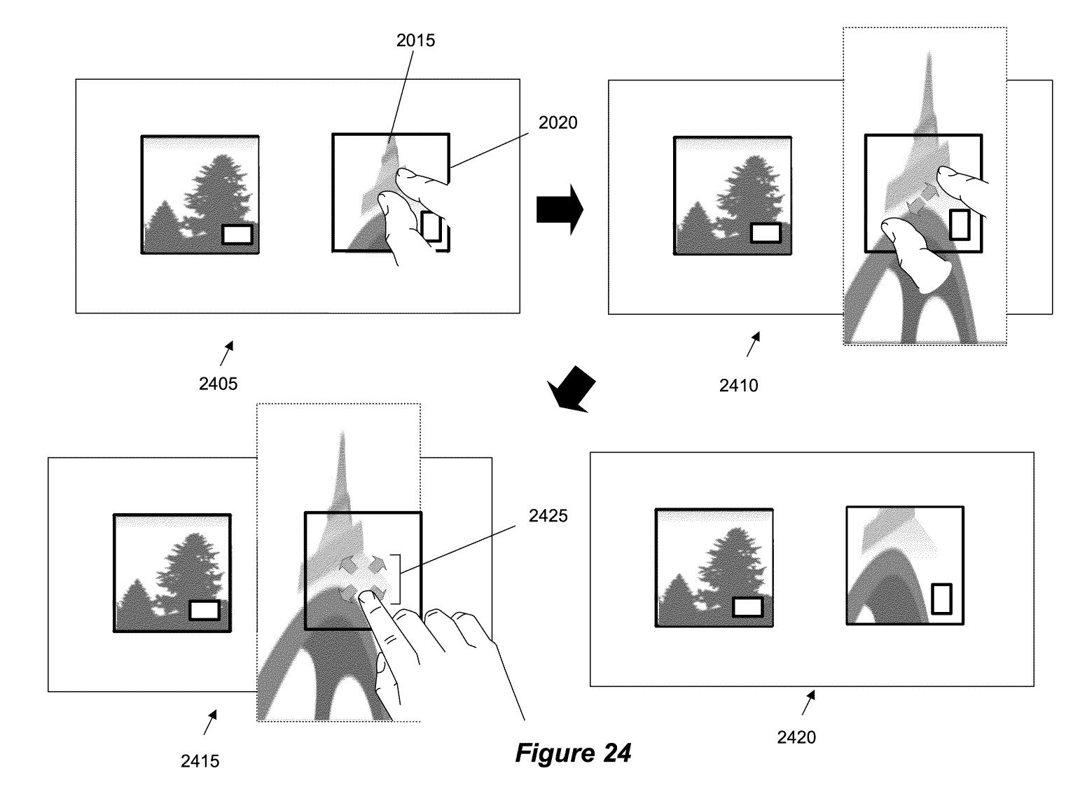

In some embodiments, the image organizing and editing application allows the user to resize and frame an image. FIG. 24 provides an illustrative example of resizing and framing the image 2015 within the boundary of the cell 2020. Four operational stages 2405-2420 of the application are shown in this figure. The first stage 2405 illustrates the selection of the portrait image 2015. In the second stage 2410, the user inputs a command to resize the selected image. Here, the user inputs the command through a multi-touch operation (e.g., pinch gesture).

The third stage 2415 illustrates framing the image 2015. As shown, the image is displayed with several directional arrows 2425. The user might have double tapped on the image to display the directional arrows. These arrows provide an indication that the user can move (e.g., slide) the image along any direction. The user then frames the image 2015 by moving the image. Lastly, the fourth stage 2420 shows the image that is resized and framed within the boundary of the cell 2020.

In several of the example described above, the application fits an image in one direction and centers it on one or more grid cell. In some embodiments, the application analyzes images to frame an image. For example, the application might analyze an image to detect one or more objects or faces to frame the image.

### V. Editing Operations

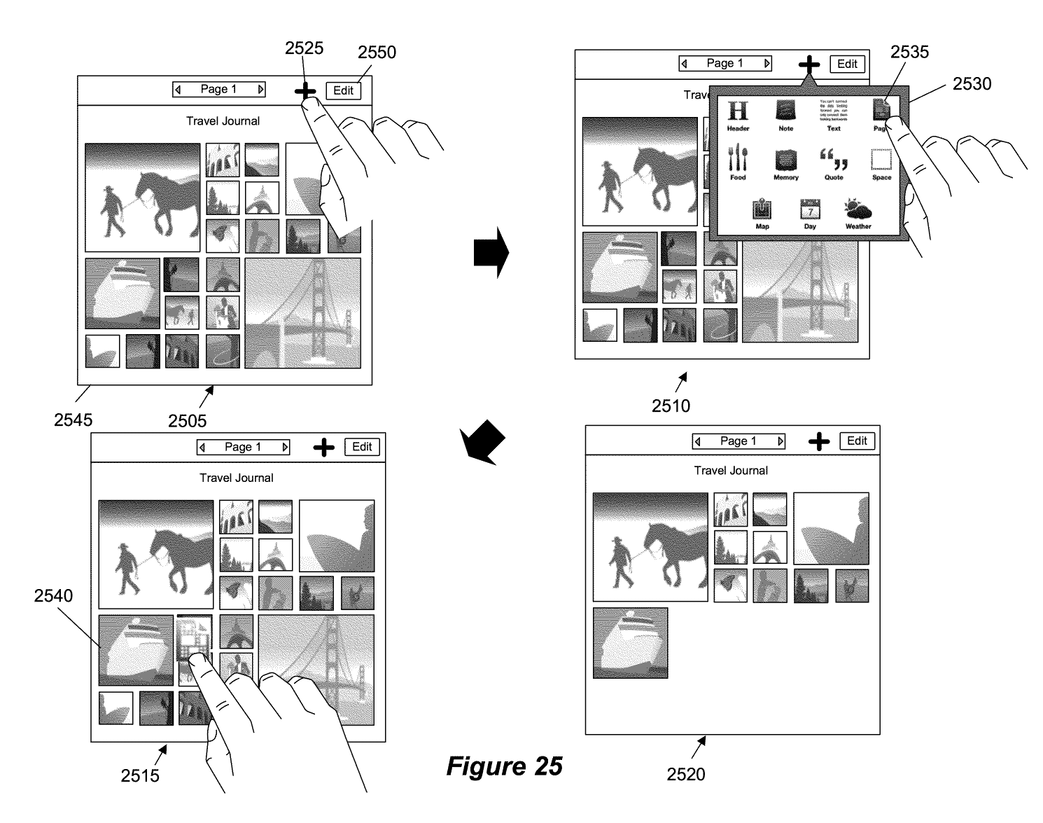

The previous sections described creating and editing a journal layout. In some embodiments, the image organizing and editing application provides a variety of different editing tools or widgets that can be used to build a story around the images in the journal. Several of these tools will now be described by reference to FIGS. 25-38.

A. Creating a New Page

FIG. 25 provides an illustrative example of creating a multi-page journal. Specifically, this figure illustrates in four operational stages 2505-2520 how a single page journal can be converted to a multi-page journal using a page tool 2535. The first stage 2505 illustrates the application displaying a journal 2545. The journal 2545 is a single page journal that includes a heading and a number of different images. To select the page tool 2535, the user selects a tool button 2525. In some embodiments, the application displays the tool button after the user's selection of the edit button 2550. When the application' user interface is displayed in a portrait view (e.g., on a smart phone), the selection of the edit button 2550 may rotate the user interface to a landscape view.

As shown the second stage 2510, the selection of the tool button 2525 causes a pop-up window 2530 to appear. The pop-up window 2530 includes a number of different tools or items that the user can use to customize the journal 2545. Examples of these tools include a header tool for adding a heading, a note tool for adding a note, and a map tool for adding a map. All of these tools will be described in detail below. Instead of a pop-up window 2530, the application of some embodiments displays a sheet that includes the different tools. For example, when the application is displayed in a smart phone, the sheet may cover the entire screen in order to allow the user to select one of the different tools.

In the second stage 2510, the user selects the page tool 2535 for creating a new journal page. The third stage 2515 illustrates selecting a location on the journal 2545 to split the journal page. Specifically, the user selects (e.g., taps and holds) the page tool 2535 from the pop-up window 2530, and drags and drops it at the location. Here, the user drags and drops the page tool on a grid cell after the image 2540. In some embodiments, a user can select the location by tapping or placing a finger at a location on the journal. However, other gestures may be performed to select the location.

The fourth stage 2520 illustrates the journal 2545 after dropping the page tool 2535 on the journal. As shown, several images of the journal have been moved to a new journal page (not shown). Specifically, all the images that were overlaid on the journal's grid after the image 2540 have been moved to the new journal page (not shown).

Instead of dragging and dropping items, the application of some embodiments allows the user select (e.g., tap) any one of the items in the pop-up window 2530. The application then adds the item as a last item on the page. For instance, when the user taps the page tool 2535, the application creates a new page after the current page without splitting images between two pages. As no image has been flowed from the current page, this new page will not have any image.

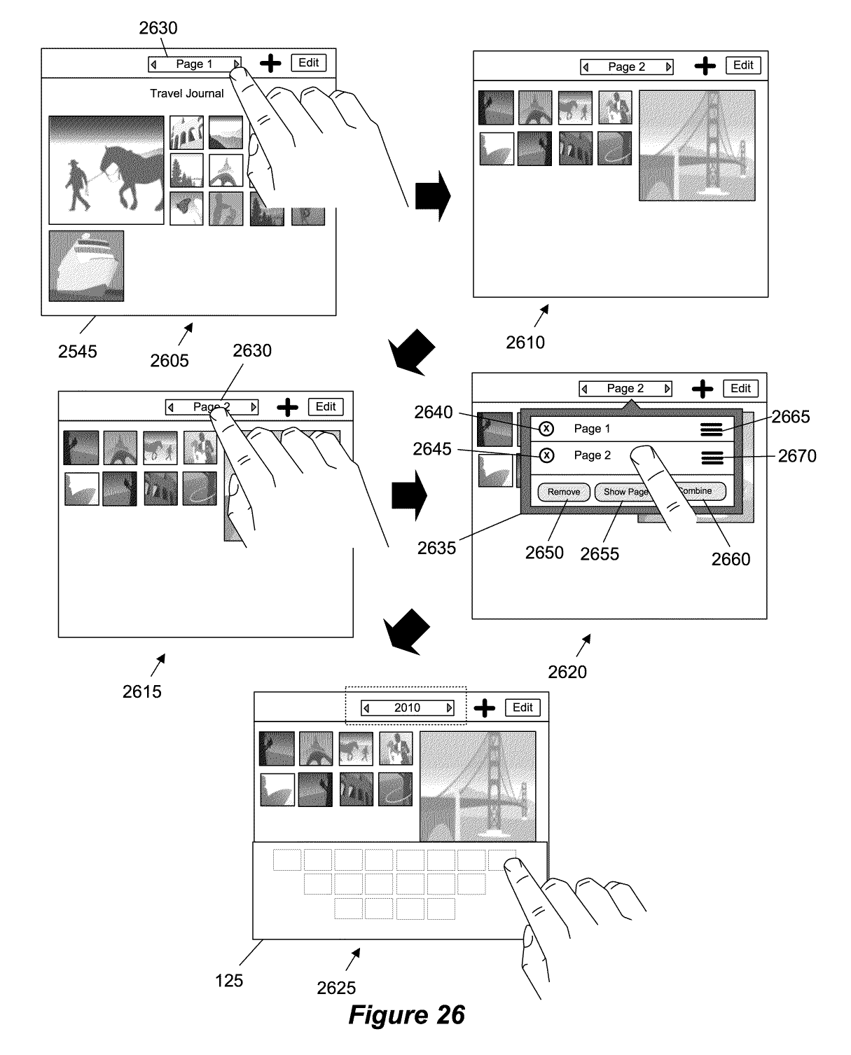

The previous example illustrated creating a new journal page. FIG. 26 provides an illustrative example of displaying and modifying the new page. Specifically, this figure illustrates in five operational stages 2605-2625 how the application allows the user to choose a page to display. This figure also illustrates several tools for specifying page attributes.

The first stage 2605 illustrates selecting an option to display the new page of the journal 2545. As shown, the application includes a page control 2630 for displaying different pages of the journal. The page control 2630 includes one or more directional arrow that the user can select to view a different page (e.g., next or previous page). The page control also displays the page number of the journal 2545. To display the new journal page, the user selects a directional arrow (e.g., right arrow) of the page control V30 for displaying the next page.

As shown in the second stage 2610, the selection of the directional arrow causes the application to display the next page (i.e., the new page). The new page of the journal includes all the images that were moved from the first page. In some embodiments, the application applies the layout algorithm to the images that were moved to the new page. The result is illustrated in the second stage 2610 as the images from the first page have been reflowed across the second page of the journal.

The application of some embodiments allows the user to modify page attributes. Examples of such attributes include page name. As shown in the second stage 2610, the application has specified a default name for the new page (i.e., page 2). In the third stage 2615, the user selects (e.g., by performing a gesture such as tapping the user's finger on) the page control 2630.

The fourth stage 2620 illustrates the application after the selection of the page control 2630. As shown, the selection causes a pop-up window 2635 to appear. This pop-up window includes a remove button 2650 for removing a selected page, a show page button 2655 for navigating to a selected page, and a combine page button 2660 for combining two or more selected pages. The pop-up window 2635 also displays the page names. Each of the page names are associated with a page selector 2640 or 2645 for selecting the corresponding page and a page order control 2665 or 2670 for changing the order of the corresponding page in the journal.

In the fourth stage 2620, the user selects (e.g., by performing a gesture such as double tapping the user's finger on) the page name (i.e., page 2) or name field displayed in the pop-up window 2635. The selection causes the on-screen or virtual keyboard 125 to appear, as illustrated in the fifth stage 2625. The user then inputs a name for the new page. The input causes the application to display the new name for the page on the page control 2630.

In the example described above, a multi-page journal is created with the application. When creating a multi-page journal, the application of some embodiments creates a separate ordered list for each page. Alternatively, the application may include an indicator (e.g., a new page item) in the same ordered list that a new grid should be defined for another page of the journal.

B. Adding Spaces

The previous example illustrated adding a new page to a journal. FIG. 27 provides an illustrative example of using a spacer to add blank spaces to the journal 2545. Four operational stages 2705-2720 of the application are shown in this figure. As shown in the first stage 2705, the application displays the pop-up window 2530 for selecting an editing tool. To add a blank space to the journal, the user selects the spacer 2725.

The second stage 2710 illustrates selecting a location on the journal to insert a blank space. Specifically, the user selects (e.g., taps and holds) the spacer 2725 from the pop-up window 2530, and drags and drops it at the first grid cell 2730 on the bottom row of the journal 2545. Here, the user drops the page tool on the grid cell 2730. In one embodiment, a user may select the location by tapping or placing a finger at a location on the journal. In other embodiments, other gestures may be performed to select a location.

As shown in the third stage 2715, the drag and drop operation caused the application to place a blank space 2735 on the grid cell. The images that appear after the blank space are reflowed across the journal layout.

In the third stage 2715, the user selects (e.g., by performing a gesture such as tapping the user's finger on) the space 2735. The selection causes a delete button 2740 to appear. The user can select this button 2740 to delete the space 2735 from the journal 2545. As shown, the selection also causes selectable items 1130-1140 for resizing the blank space to appear. Specifically, the user can select and move (1) the item 1140 to modify the width of the image, (2) the item 1130 to modify the height, or (3) the item 1135 to modify both the width and height. As shown in the fourth stage 2720, the user drags the selectable item 1140 horizontally across the journal. This cause the application to populate all grid cells at that row with the blank space. The remaining images are pushed down the journal's associated grid. In some embodiments, the space can be used to design a journal by moving one or more items (e.g., info items, images) down the sequential list of items along the flow of the grid.

C. Adding a Header

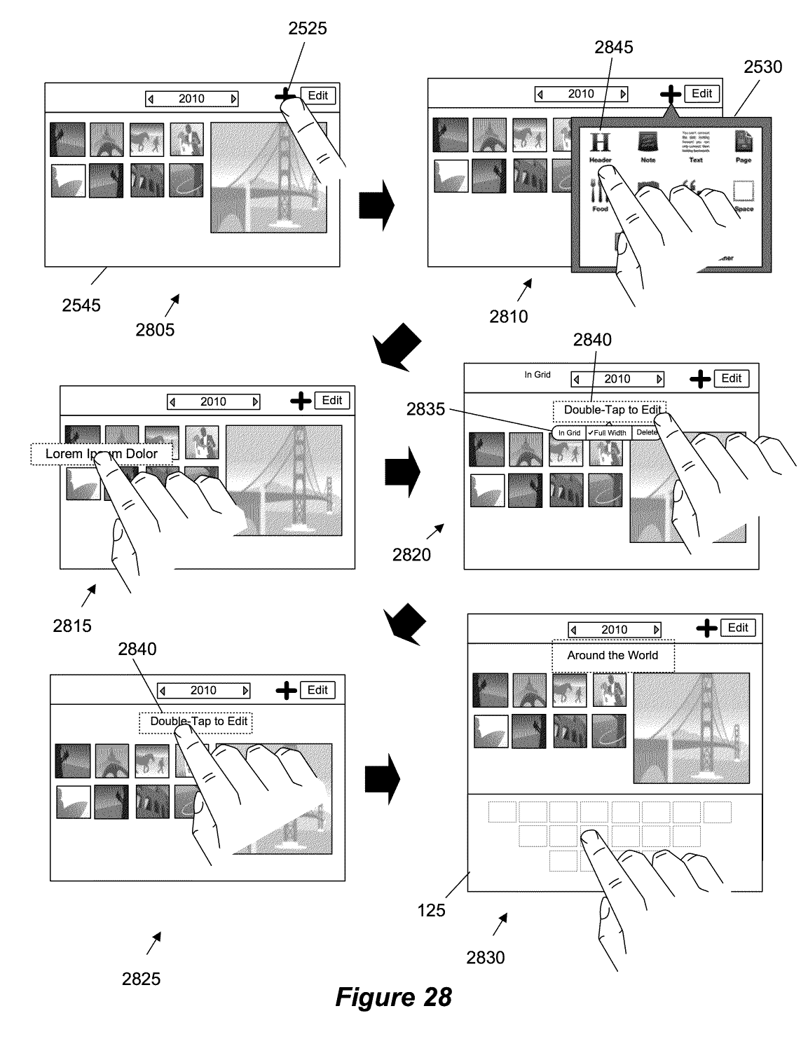

In some embodiments, the image organizing and editing application provides one or more tools to add text (e.g., alphanumeric characters, symbols) to a journal. FIG. 28 provides an illustrative example of adding a header. Specifically, this figure shows in six operational stages 2805-2830 how a header can be added to the new page of the journal 2545.

The first stage 2805 illustrates the application displaying the second page of the journal 2545. To select an editing tool, the user selects the tool button 2525. The selection causes the pop-up window 2530 to appear, as illustrated in the second stage 2810.

In the second stage 2810, the user selects the heading tool 2845 for creating a new header. The third stage 2515 illustrates selecting a location on the journal 2545 to add the header. Specifically, the user selects (e.g., taps and holds) the header tool 2830 from the pop-up window 2530, and drags and drops it at the upper-left corner of the journal. In one embodiment, a user may select the location by tapping or placing a finger at a location on the journal. In other embodiments, other gestures may be performed to select a location. Alternatively, the user can select (e.g., tap) the header tool 2830. The application may then add the header at the end of the journal page.

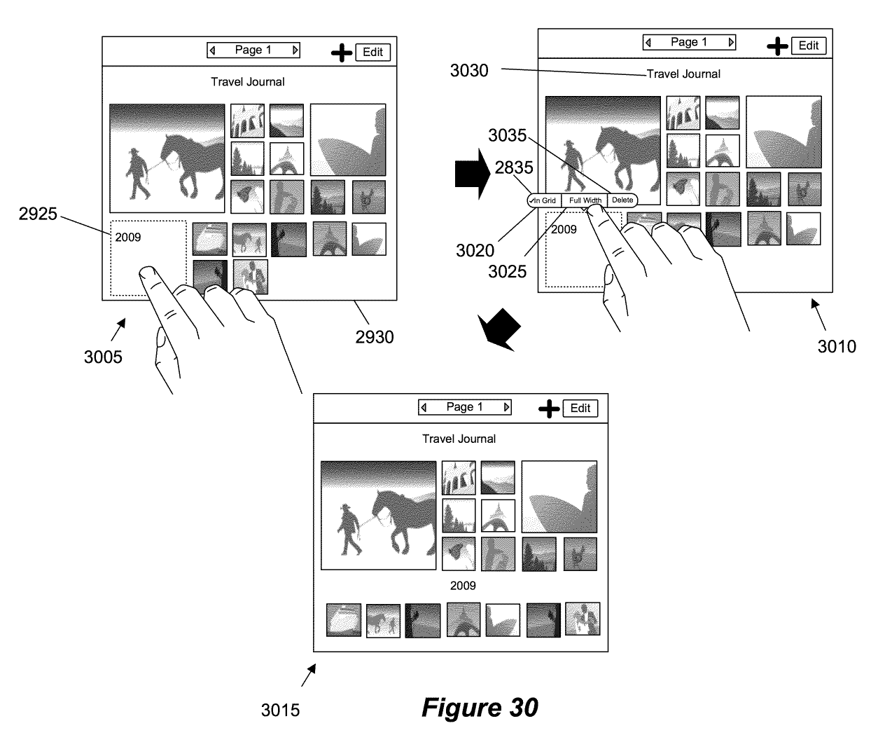

As shown in the fourth stage 2820, the drag and drop operation causes the application to create a header 2840 for the second page of the journal 2545. Specifically, the application has created the header with a default heading. The user then selects (e.g., by performing a gesture such as tapping the user's finger on) the header 2840 to display several header options. Specifically, the selection causes a context menu 2835 to appear. The context menu 2835 includes an option to delete the header. The context menu also includes options to specify whether the header is “Full Width” or “In Grid”. An in grid item is an item that is contained in one or more grid cells. Different from the in grid item, a full width item is not contained in any grill cells. That is, the full width item spans across the entire page of the journal. In some embodiments, the full width item can also expand vertically down the journal page (e.g., when the user inputs multi-line text). Several examples of specifying whether a text item is full width or in grid will be described below by reference to FIG. 30.

The fifth stage 2825 illustrates selecting the header to input text for the header 2840. To input text, the user selects (e.g., by performing a gesture such as double tapping the user's finger on) the header 2840. The sixth stage 2830 illustrates inputting a new heading. Specifically, the selection of the header 2840 causes the on-screen keyboard 125 to be displayed. The user then inputs text for the header 2840 using the keyboard 125.

D. Adding Text

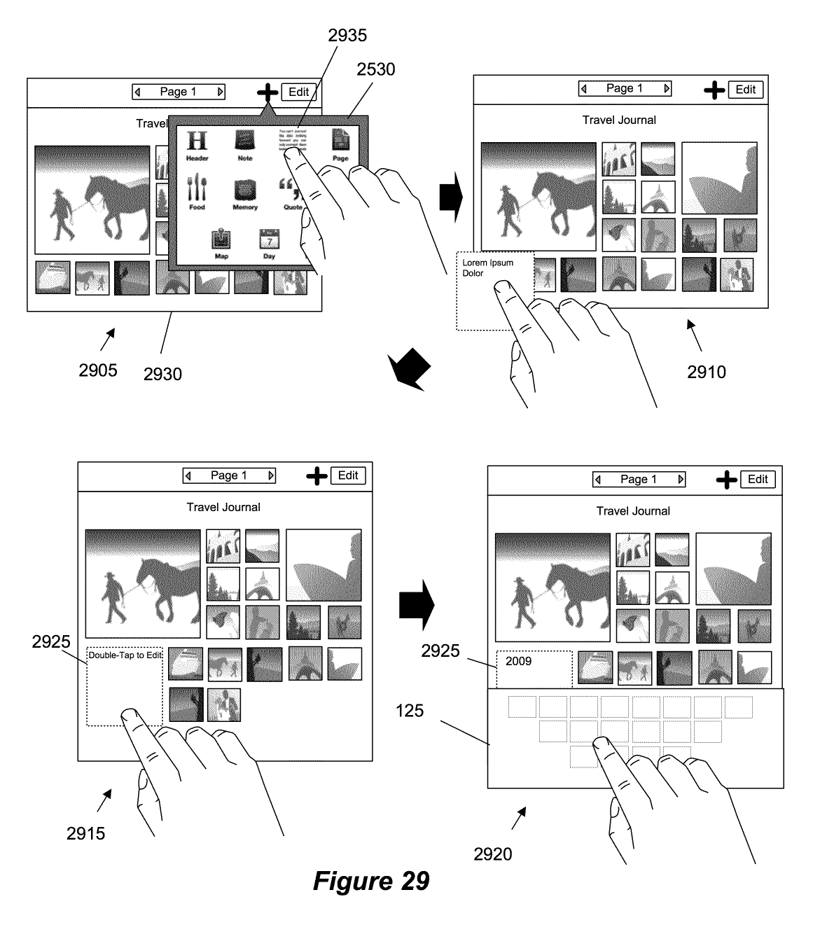

The previous examples illustrated adding different notes to the journal. FIG. 29 provides an illustrative example of adding text to a journal 2930. Four operational stages 2905-2920 of the application are illustrated in this figure. In the first stage 2905, the application is displaying the pop-up window 2530 for selecting an editing tool. To add text to the journal 2930, the user selects a text tool 2935.

The second stage 2910 illustrates selecting a location on the journal 2930 to insert text. In particular, the user drags and drops the text tool 2935 on a location that corresponds to a grid cell. As shown in the third stage 2915, the drag and drop operation causes the application to place a text field 2925. In the example illustrated in FIG. 29, the text field 2925 is by default a two by two item. That is, the text field 2925 occupies two grid cells in both the vertical and horizontal direction. In addition, the text field 2925 includes default text that provides instructions on how to edit the text.

In the third stage 2915, the user selects (e.g., by performing a gesture such as double tapping the user's finger on) the header 2840. The selection causes the on-screen keyboard 125 to appear as illustrated in the fourth stage 2920. The fourth stage 2920 illustrates inputting text for the text field 2925. Specifically, the user inputs the text using the on-screen keyboard 125. The user can also input one or more lines of text using the text field, in some embodiments.

In the example illustrated in FIG. 29, the text field 2925 is similar to a heading. For example, the text field 2925 is not associated with an icon or image. The text field is also transparent. That is, the background of the journal can be seen through the text field. However, the text field 2925 is placed on several grid cells, while the header spans across multiple grid cells. The application of some embodiments provides selectable items to specify whether a particular info item is in contained in one or more grid cells or is an in line item (i.e., a full width item). As mentioned above, a full width item is not contained in any grill cells. That is, the full width item spans across the entire page of the journal. In some embodiments, the full width item can also expand vertically down the journal page (e.g., when the user inputs multi-line text).

FIG. 30 provides an illustrative example of specifying the text inputted in the text field 2925 to be an in line item of the journal. Three operational stages 3005-3015 of the application are shown in this figure. The first stage 3005 illustrates selecting (e.g., by performing a gesture such as tapping the user's finger on) the text field 2925 on the journal 2930. As shown in the second stage 3010, the selection causes the content menu 2835 to appear. The content menu includes several menu items 3020, 3025, and 3035. Specifically, the menu item 3020 can be selected to specify whether the text in the text field is an in grid item that is contained in one or more grid cells. As shown, the menu item includes a check mark which indicates that the text is an in grid item. The menu item 3025 can be selected to specify whether the text is a full width item. The context menu also includes a menu item 3035 to delete the text field from the journal.

In the second stage 3010, the user selects the menu item 3025 to modify the text from being an in grid text to a full width text. The third stage 3015 illustrates the journal 2930 after selecting the menu item 3025. Similar to the heading 3030, the text is no longer overlaid on the grid but is centered along the width of the journal. The user can select the heading 3030 to modify the text (e.g., input one or more paragraphs of text). When the user inputs multiple lines of text, the text expands vertically. As such, the input text is not confined to one or more grid cells. In some embodiments, the application places a limit in the amount of text that can be displayed in a grid cell. Conversely, a seemingly endless amount of text can be inputted when the text is converted to a full width text.

The above example described converting an in grid item to a full width item. In some embodiments, the full width item is listed in the journal's ordered list with a flag, which indicates that that it should not be placed in a grid cell. Alternatively, the full width item can be a separate item on one or more other lists or collections that include full width items.

E. Adding Notes

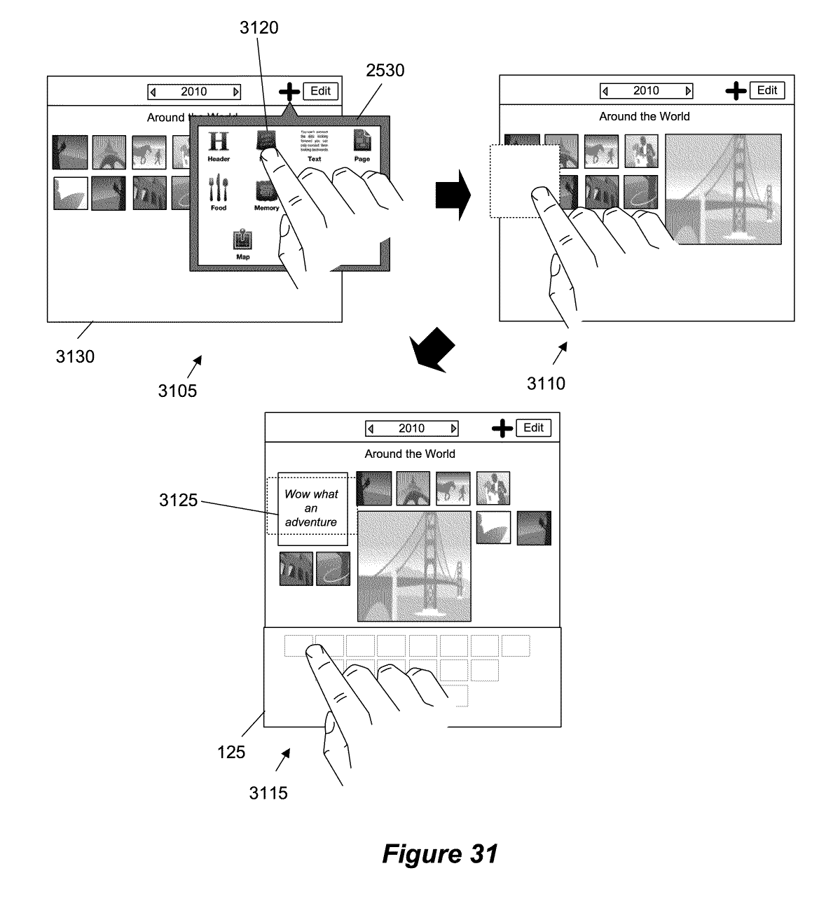

FIG. 31 provides an illustrative example of adding a note to the journal. Three operational stages 3105-3115 of the application are illustrated in this figure. As shown in the first stage 3105, the application is displaying the pop-up window 2530 for selecting an editing tool. To add a note to the journal 3130, the user selects a note tool 3120.

The second stage 3110 illustrates selecting a location on the journal 3130 to put the note. In particular, the user drags and drops the note tool on a location that corresponds to one or more grid cells. As shown in the third stage 3115, the drag and drop operation caused the application to place a note 3125 on the journal page at the location. In one embodiment, a user may select the location by tapping or placing a finger at a location on the journal. In other embodiments, other gestures may be performed to select a location. Alternatively, the user can select (e.g., by performing a gesture such as tapping the user's finger on) the note tool 2830. The application then adds the note to the end of the journal page.

The third stage 3115 illustrates inputting text for the note 3125. Specifically, the user inputs the text using the on-screen keyboard 125. The user can also input one or more lines of text for the note 3125. In some embodiments, the on-screen keyboard 125 is displayed when the user performs a first gesture (e.g., by double tapping) on the note 3125. The application of some embodiments displays a delete button to delete the note 3125 when the user performs a second different gesture (e.g., by single tapping) on the note.

In the example illustrated in FIG. 31, the note is a pre-designed info item. For example, the note can be a colored item, textured item, associated with an image or an icon, associated with a font style, etc. The note is placed over four grid cells. That is, the note takes up multiple columns and rows of the journal. As shown, the note is by default a two by two item. That is, the note occupies two grid cells in two directions. In some embodiments, the size of the note is static (i.e., fixed) in that the application's user cannot modify it.

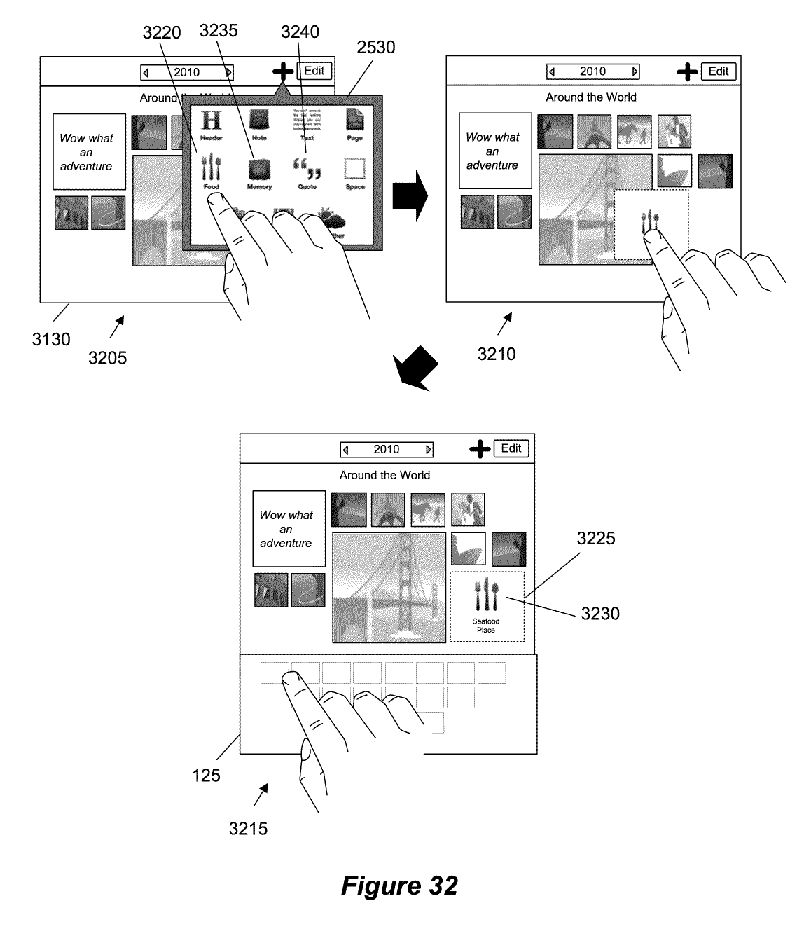

The previous example illustrates adding a note. FIG. 32 provides an illustrative example of adding another info item. Specifically, this figure illustrates in three operational stages 3205-3215 how another type of note related to food or restaurant can be added to the journal 3130.

As shown in the first stage 3205, the application displays the pop-up window 2530 for selecting an editing tool. To add a note to the journal 3130, the user selects a note tool 3220. The second stage 3210 illustrates selecting a location on the journal 3130 to add the note. In particular, the user drags and drops the note tool 3220 on a location that corresponds to one or more grid cells. As shown in the third stage 3215, the drag and drop operation causes the application to place a note 3225 at the location.

The third stage 3215 illustrates inputting text for the note 3225. Specifically, the user inputs the text using the on-screen keyboard 125. The user might have selected the note 3225 and a context menu item (e.g., an edit button) to display the keyboard. The user can also input one or more lines of text for the note 3225. In the example illustrated in FIG. 32, the note is a pre-designed info item. For example, the note is associated with an icon 3230 that provides a visual indication that the note relates to food (e.g., a restaurant, a dish, etc.).

In some embodiments, the info item (e.g., the note) may be associated with a hyperlink to a webpage. For example, the application may provide an input field to input a link to a webpage (e.g., of a restaurant). Once inputted, the selection of the info item may cause a browser window to appear and display the webpage. The user can also input a link to an image or some other item. As will be described in detail below, the application of some embodiments allows the user to publish a journal to one or more webpages or websites. In some such embodiments, the webpage is published with the hyperlink. That is, when the user selects the info item in a web browser, the selection causes the browser to navigate to the webpage associated with the hyperlink.

The previous examples illustrated adding several designed text items (e.g., associated with one or more images, or icons) to a journal. In some embodiments, the application allows the user to a designed text item relating to quotes and memories. For example, the user can use a memory tool 3235 to add a text relating to memory, or a quote tool 3240 to add quotes to the journal.

F. Adding a Date

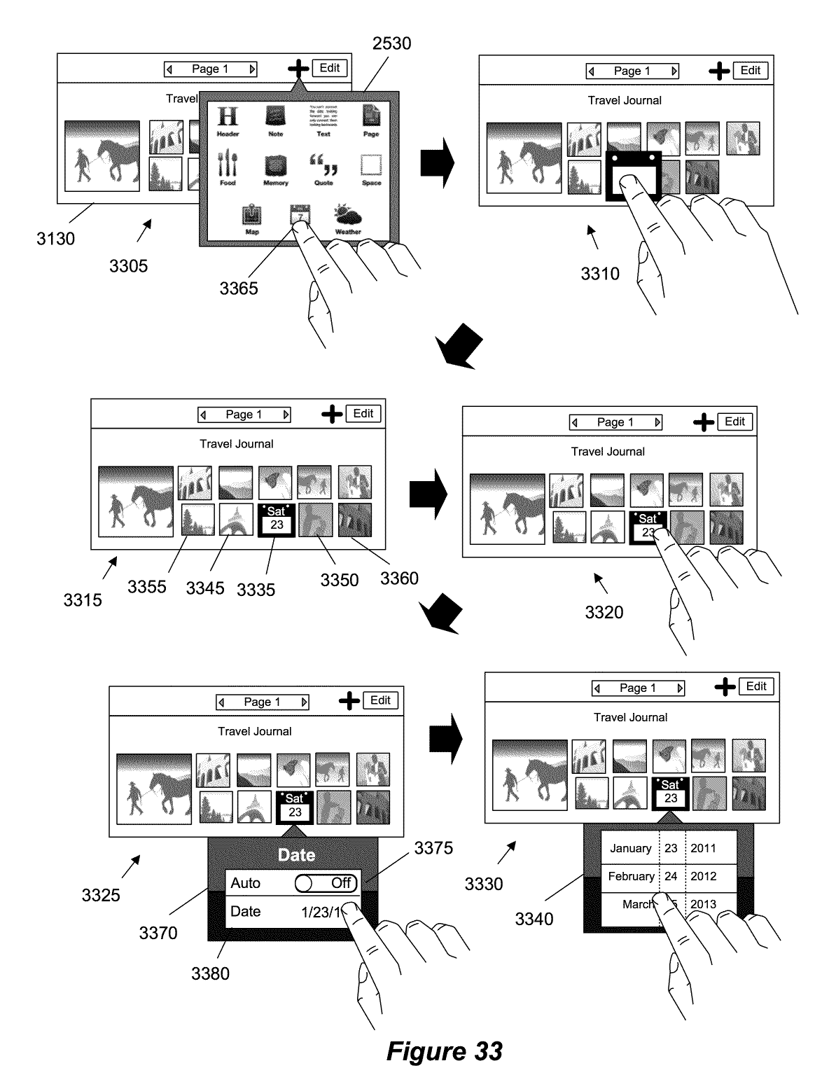

In some embodiments, the application allows the user to add info items that are populated with data based on one or more images in the journal. One example of such an info item is a date tool 3330 for adding a date to a journal. FIG. 33 provides an illustrative example of using a date tool 3330 to add a date item to a journal. Specifically, this figure illustrates in six operational stages 3305-3330 how a user can add and modify the date.

In the first stage 3305, the application displays the pop-up window 2530 for selecting an editing tool. To add a date, the user selects the date tool 3365. The second stage 3310 illustrates selecting a location on the journal to place the date. Specifically, the user drags and drops the date tool 3365 on a location that corresponds to a grid cell. Alternatively, the user can select (e.g., tap and release) the date tool 3365 to add the date to the end of the journal.

As shown in the third stage 3315, the drag and drop operation causes the application to place a date 3335 at the selected location (e.g., on a grid cell). In the example illustrated in FIG. 33, the date 3335 is by default a one by one item. That is, the date 3335 occupies only one grid cell. The images that appear after the date 3335 are reflowed across the journal layout. As shown, the application has also specified a particular date to display on the date info item.

In some embodiments, the application analyzes one or more images (e.g., nearby images) to determine this date. For example, the application might analyze a timestamp or creation date associated with a previous image 3345. If the data is not available for that image 3345, the application might analyze the data associated with the next image 3350. If the data is not available for the next image 3350, the application might analyze images that are several sequences (e.g., columns, or even rows) apart from the position of the date info item such as images 3355 and 3360.

In the example illustrated in FIG. 33, the date is also presented with a design. That is, the date is not displayed as a plain text item but is displayed with a particular design or look. Specifically, the date 3335 is presented as a desk calendar. Alternatively, the application may present the date differently, in some embodiments.

In the fourth stage 3320, the user selects (e.g., by performing a gesture such as double tapping the user's finger on) the date 3335. The selection causes a date option window 3370 to appear, as illustrated in the fifth stage 3325. The date option window 3370 includes an option 3375 (e.g., a toggle switch) to specify whether the date info item should be automatically populated with a date. The window 3370 also includes a date field 3380 to manually input a date. In some embodiments, the date field 3380 can only be edited when the auto-population feature has been disabled. That is, if the date is incorrect or the user wants to display a date for some other image, the user can turn off the auto-detection feature and manually set the date.

As shown in the fifth stage 3325, the user selects (e.g., taps on) the date field 3380. The selection causes the calendar 3340 to appear, as illustrated in the sixth stage 3330. The user then uses this calendar 3340 to modify the date 3335.

Similar to images, the application of some embodiments allows the date 3335 to be resized or moved to another location on the journal. In some embodiments, the application updates the date with another date when it is moved to another location on the journal. The application of some embodiments might analyze one or more images or their associated metadata to update the date.

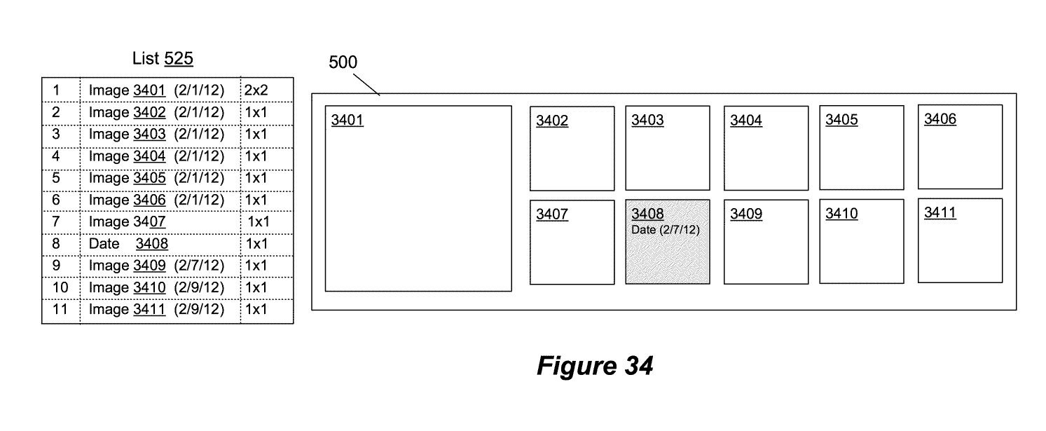

FIG. 34 provides an illustrative example of how some embodiments populate an info item with data. The figure includes the ordered list 525 and the grid 500. As mentioned above, the application of some embodiments creates the list 525 and uses it to populate the grid with items (e.g., images, info items). In some embodiments, the list defines the layout of the journal by specifying the position and size of each image on the grid.

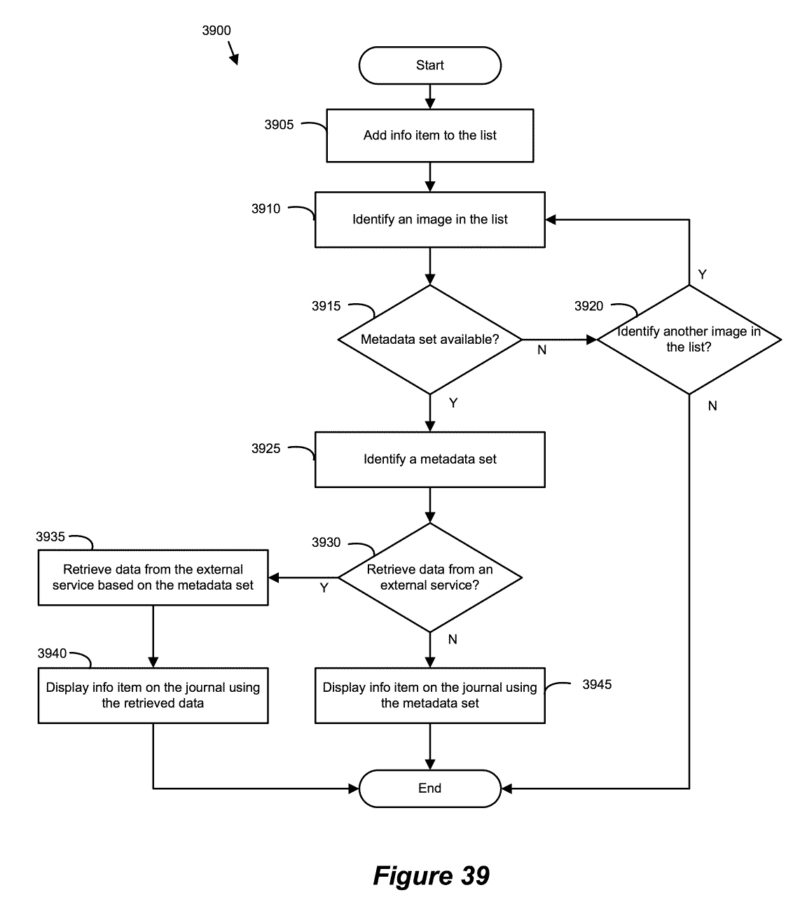

As shown, the grid is populated with a date 3408 and several images 3401-3407. In populating an info item, the application of some embodiments traverses the ordered list to analyze images (e.g., the images metadata). In the example illustrated in FIG. 34, the application has first analyzed the image 3407 to identity a timestamp or creation date. As the data is not available, the application then analyzed the image 3409. Based on the analysis, the application then specifies the date to be the one associated with the image 3409. Several more examples of analyzing images will be described below by reference to FIG. 39.

G. Adding a Map

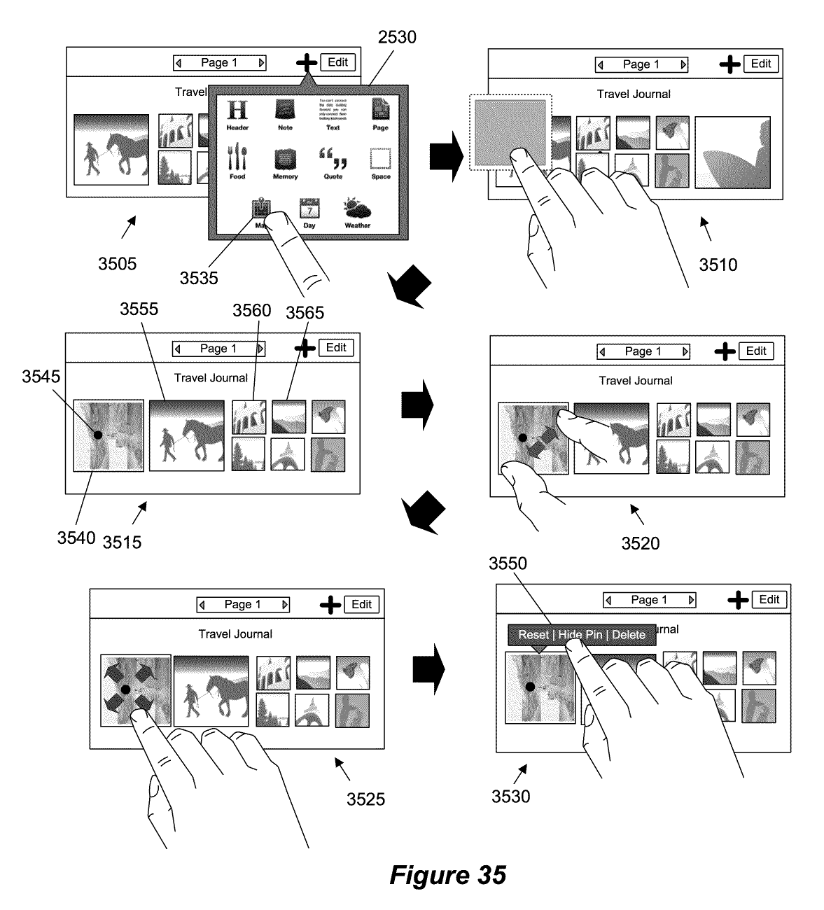

In the previous example, the date tool is used to add a date to a journal. FIG. 35 provides an illustrative example of adding a map to the journal. Specifically, this figure illustrates in six operational stages 3505-3530 how a user can add and modify the map.

In the first stage 3505, the application displays the pop-up window 2530 for selecting an editing tool. To add a map, the user selects the map tool 3535. The second stage 3510 illustrates selecting a location on the journal to place the map. Specifically, the user drags and drops the map tool 3535 onto a location on the journal. Alternatively, the user can select (e.g., tap and release) the map tool 3535 to add the map at the end of the journal page.

As shown in the third stage 3515, the drag and drop operation causes the application to place a map 3540 at the specified location. The images that appear after the map are reflowed across the journal layout. The map displays a visual representation of a particular area or location. In some embodiments, the application analyzes one or more images to determine this area or location. Similar to the date described above, the application might analyze the location information (e.g., GPS data) associated with a previous image or next image 3555. If the data is not available, the application might analyze images that are several sequences (e.g., columns, or even rows) apart from the position of the map such as images 3560 and 3565.

Once the location information is derived, the application of some embodiments retrieves map data using the information. For example, the application might send the GPS data to an external map service to retrieve the map tiles associated with the location. In the example illustrate in FIG. 35, the application makes this request upon adding the map 3540 to the journal.

In addition, the map 3540 includes a pin 3545 that corresponds to the location information (e.g., the GPS data). The map is also a designed map having tiles or texture that match the look of a journal. For example, the map tiles include several folds that make it appear as a physical map that is attached to the journal. Accordingly, the application of some embodiments accesses a custom map service to display the map 3540.

As shown in FIG. 35, the map 3540 is also customizable. For example, the user can select (e.g., double tap on) the map and customize it in any number of different ways. In the fourth stage 3520, the user inputs a command through a multi-touch operation (e.g., pinch gesture) to zoom in and out the map 3540. The fifth stages 3525 illustrates positioning the map by selecting and moving (e.g., sliding) it. In addition, the sixth stage 3530 illustrates toggling a control 3550 to hide or show the pin. The control also includes options to reset or delete the map. Resetting the map returns the map to its initial view (e.g., prior to user modifications.).

Similar to images, the map 3540 is an info item that can be resized or moved to another location on the journal. In some embodiments, when the map is moved, the area or location shown in the map is dynamically updated. That is, the application of some embodiments might analyze one or more images or their associated metadata to retrieve map data.

H. Adding Weather Info

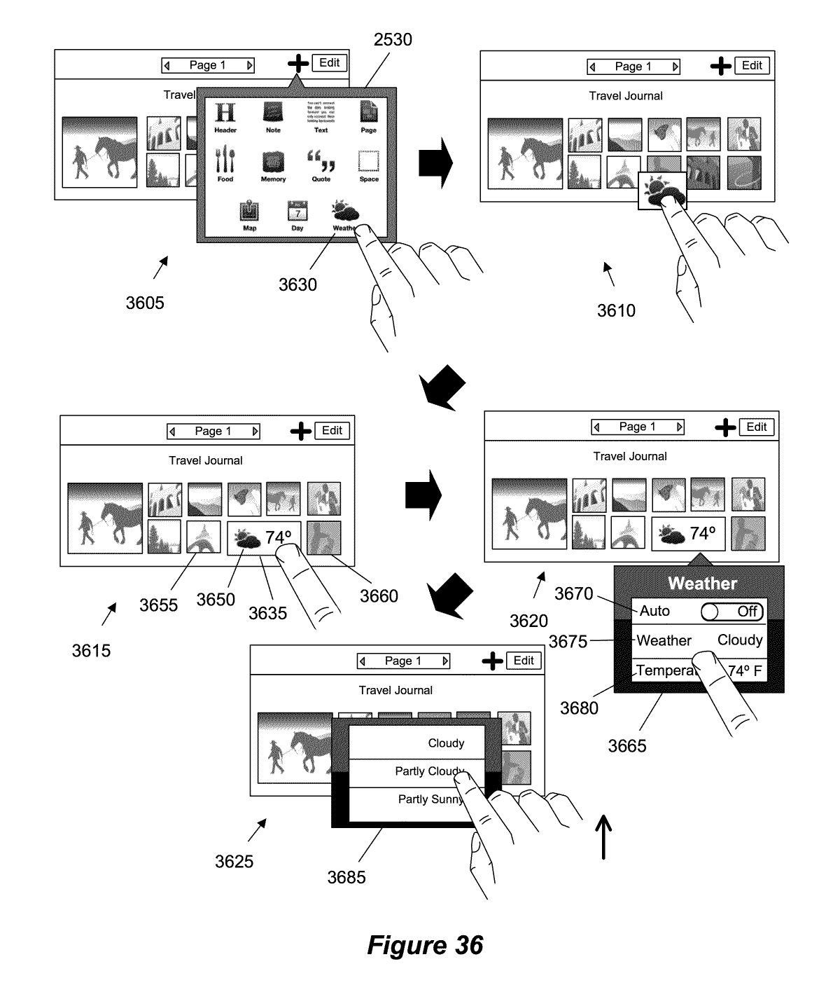

In the previous example, the map tool is used to add a map to a journal. FIG. 36 provides an illustrative example of adding weather information in the journal. Specifically, this figure illustrates in five operational stages 3605-3625 how a user can add and modify the weather information.

In the first stage 3605, the application displays the pop-up window 2530 for selecting an editing tool. To add weather information, the user selects the weather tool 3630. The second stage 3610 illustrates selecting a location on the journal to place the weather information. Specifically, the user drags and drops the weather tool onto a location on the journal. Alternatively, the user can select (e.g., tap and release) the weather tool 3630 to add the weather info at the end of the journal page.

As shown in the third stage 3615, the drag and drop operation causes the application to place weather information item 3635 at the specified location. The images that appear after the weather information item 3635 are reflowed across the journal layout.

The weather information item 3635 displays the temperature (e.g. in degrees Fahrenheit or Celsius). The weather information item also includes an icon 3650 that provides a visual indication of the weather. In the example illustrated in FIG. 36, the icon 3650 displays a sun that is at least partly covered by a cloud. This provides a visual indication to the user that the weather condition is partly cloudy or partly sunny. In some embodiments, the application analyzes one or more images to display the weather information. Similar to several examples described above, the application might analyze the date and location information (e.g., GPS data) associated with the previous image 3655 or the next image 3660. If the data is not available, the application might analyze images that are several sequences (e.g., columns) apart from the position of the weather information item.

Once the date and location information is derived, the application of some embodiments retrieves weather data using the information. For example, the application might send the date (e.g., timestamp) and the location information (e.g., GPS data) to an external weather service. The weather service then retrieves the weather data and sends the weather information back to the application. The weather service may provide a code or text string that specifies the weather report (e.g., weather condition). The application of some embodiments uses the specified code or text string to render a visual representation of the weather condition (e.g., the icon 3650). In some embodiments, the application accesses an external weather service that provides the weather report. That is, the weather information on the journal may not reflect the actual weather but reflect the weather report or forecast.

In the example illustrated in FIG. 36, the weather 3635 is fully customizable. For example, the weather 3635 is an interactive tool that can be used to specify the temperature and/or weather condition. For example, in the third stage 3615, the user selects the weather information item 3635. As shown in the fourth stage 3620, the selection causes a weather options window 3665 to appear. The weather option window 3665 includes an option 3670 (e.g., a toggle switch) to specify whether the weather info item should be automatically populated with weather information. The window 3665 also includes (1) a weather condition control 3675 to manually input the weather condition and (2) a temperature control 3680 to manually input the temperature. In some embodiments, these controls 3675 and 3680 are disabled or cannot be selected when the auto-population feature has been enabled.

In the fourth stage 3620, the user selects the weather condition control 3670. The selection causes a weather condition tool 3685 to appear, as illustrated in the fifth stage 3625. The user then uses this weather condition tool 3685 to change the weather condition. When the weather condition is modified, the application may display another icon that indicates the specified weather condition. Similar to images, the weather information item 3635 can be resized or moved to another location on the journal. In some embodiments, when the weather information item is moved, the weather information is dynamically updated. That is, the application of some embodiments might analyze one or more images or their associated metadata to retrieve weather data.

I. Other Dynamic Info Items

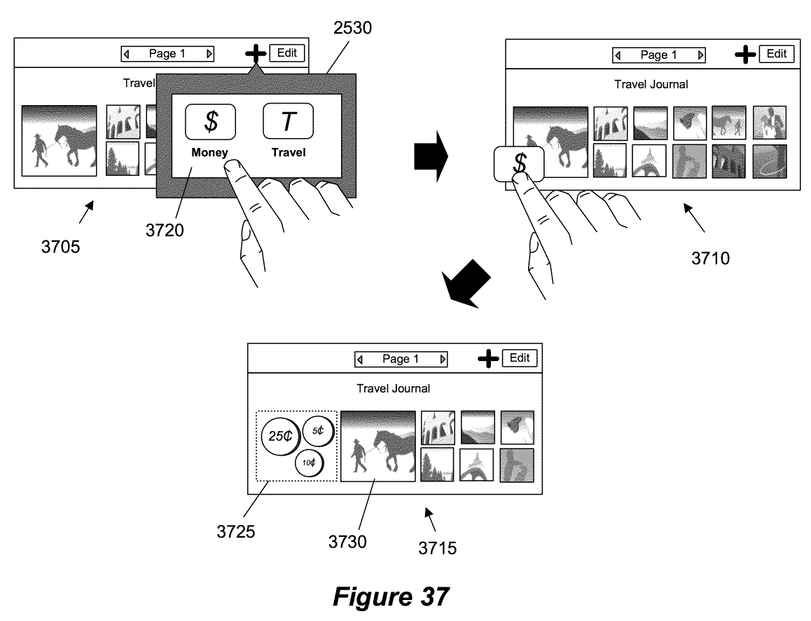

In the previous example, the weather tool is used to add weather information to a journal. FIG. 37 provides an illustrative example of using a money tool to add one or more images or icons that show money (e.g., coins, paper money, banknote, etc.). Three operational stages 3705-3715 of the application are shown in this figure.

In the first stage 3705, the application displays the pop-up window 2530 for selecting an editing tool. Here, the user selects the money tool 3720. As shown in the second stage 3710, the user then drags and drops the money tool onto a location on the journal. Alternatively, the user can select (e.g., tap and release) the money tool 3720 to add one or more images showing money.

As shown in the third stage 3715, the drag and drop operation causes the application to place several coins 3725 onto the journal. In some embodiments, the application analyzes one or more images to present images showing money. Similar to several examples described above, the application might analyze the location information (e.g., GPS data) associated with a previous image or next image 3730. If the data is not available, the application might analyze images that are several sequences (e.g., columns) apart from the position of the weather info.

Once the location information is derived, the application of some embodiments might retrieve at least one image showing currency (e.g., coins, banknotes) associated with the location. In some embodiments, the application might access an external source to retrieve one or more images. One reason for adding such info item is that some people place coins or banknotes into their physical journals. Accordingly, this money tool 3720 allows the application's user to create similar look of such physical journals.

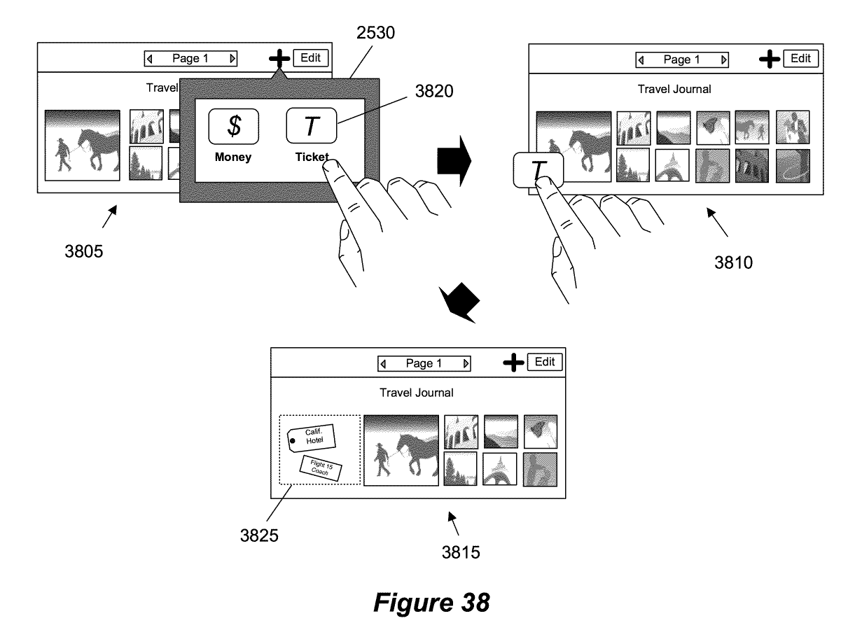

FIG. 38 provides an illustrative example of using a ticket tool 3820 to add travel information to the journal. Three operational stages 3805-3815 of the application are shown in this figure.

In the first stage 3805, the application displays the pop-up window 2530 for selecting an editing tool. Here, the user selects the ticket tool 3820. As shown in the second stage 3810, the user then drags and drops the ticket tool onto a location on the journal. Alternatively, the user can select (e.g., tap and release) the ticket tool 3820 to add travel information.

As shown in the third stage 3815, the drag and drop operation causes the application to place a travel information item 3825. In the example illustrated in FIG. 38, the travel information item 3825 is shown as a plane ticket and a luggage tag. In some embodiments, the application accesses an external service to display the travel information. For example, the application may retrieve data associated with a travel itinerary from a trip planner service. The application may then display a representation of the plane ticket (e.g., with seat number, flight number, airline, etc.). The application may also display a representation of the place (e.g., hotel) associated with the travel itinerary, a rental car, etc. One reason for adding such info item is that some people attach travel related items (e.g., plane tickets) to their physical journals. Accordingly, this ticket tool 3820 allows the application's user to create similar look of such physical journals. In many of the examples described above, the application retrieves data from an external source. In some embodiments, the application uses an application programming interface (API) of the external data source to access the data.

J. Example Process for Populating Info Items

In several of the examples describe above, the application dynamically populates info items with appropriate data by analyzing images in the journal. FIG. 39 conceptually illustrates a process 3900 that some embodiments use to populate such info items. In some embodiments, the process 3900 is performed by the image organizing and editing application.

As shown in FIG. 39, the process 3900 begins when it adds (at 3905) an info item to a list. As mentioned above, the application of some embodiments creates an ordered list that contains a sequence of items (e.g., images, info items). The application then uses this list to sequentially add each item in the list to a grid.

At 3910, the process 3900 identifies an image in the list. In some embodiments, the process identifies the next or previous image in the sequence. For example, when the info item is the first item in the list, the process 3900 might identify the next image in the list. Conversely, if the info item is the last item on the list, the process 3900 might identity the preceding image in the list. Furthermore, when the info item is between two images, the process 3900 might first identify the previous image before identifying the next image. In addition, when the info item is between an image and another info item, the process might identify that image first prior to any other images.

The process 3900 then determines whether a metadata set is available for the identified image. If so, the process identifies (at 3925) the metadata set. Examples of such a metadata set include creation date (e.g., timestamp) and location information (e.g., GPS data). Depending on the type, the process 3900 might identify a specific metadata set such as the date, the location information, etc.

At 3930, the process 3900 determines whether to retrieve data from an external service. If so, the process retrieves (at 3935) from the external service using the metadata set. Example of such service includes location or map service, weather service, travel service, etc. The process then displays (at 3940) the info item using the retrieved data. When data from an external source is not needed, the process 3900 displays (at 3945) the info item on the journal using the metadata set. For example, the process might present a date on the journal without accessing an external service to retrieve data.

When the metadata set is not available, the process 3900 determines (at 3920) whether to identify another image in the list. In some embodiments, the process identifies a subsequent image in the list that is adjacent to the next or previous image. For example, if the info item is the sixth item in the list, the process might first identify the fifth item on the list, followed by the seventh item, fourth item, eighth item, etc. In some embodiments, the process traverses the list up to five items on either side of the info item. One of ordinary skill in the art would understand that the process might go even further up and down the list. The process might only analyze previous images or subsequent images in the list. As shown in FIG. 39, when the determination is made to identify another image, the process 3900 returns to 3910, which is described above. Otherwise, the process ends.

### VI. Editing Images

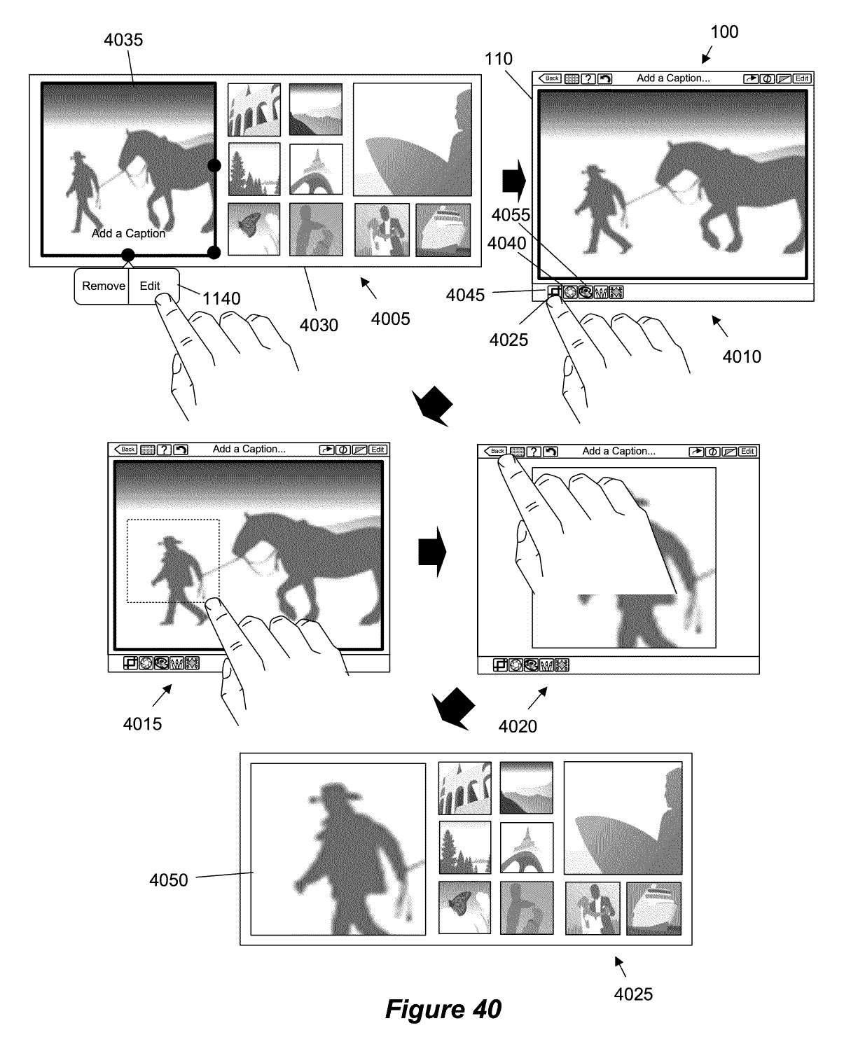

In some embodiments, the application allows the user to select an image from the journal and edit the image. When the image is edited, the application displays the edited image on the journal. FIG. 40 provides an illustrative example of editing an image on the journal 4030. Four operational stages 4005-4020 of the application are shown in this figure.

In the first stage 4005, the user has selected the image 4035 on the journal. The selection results in the application displaying the menu item 4040 for editing the image to appear. As shown, the user selects this item 4040 to edit the image.

As shown in the second stage 4010, the selection of the menu item 4040 causes the application to display the selected image on the image display area 110. In addition, the GUI 100 includes a tool bar 4045. In the example illustrated in FIG. 40, the tool bar includes several editing tools. The crop tool 4055 activates a cropping tool that allows the user to align cropped images and remove unwanted portions of an image. The exposure tool 4040 activates a set of exposure tools that allow the user to modify the black point, shadows, contrast, brightness, highlights, and white point of an image. The color tool 4055 activates a set of color tools that enable the user to modify the saturation and vibrancy, as well as color-specific saturations (e.g., blue pixels or green pixels) and white balance.

In the second stage 4010, the user selects the crop tool 4045. As shown in the third stage 4015, the user then selects a portion of the image to crop. The fourth stage 4020 illustrates the image display area displaying the cropped image 4050. The user selects a back button to return to the journal. As shown in the fifth stage 4025, the cropped version of the image 4035 is overlaid on the journal.

### VII. Adding Images to a Journal

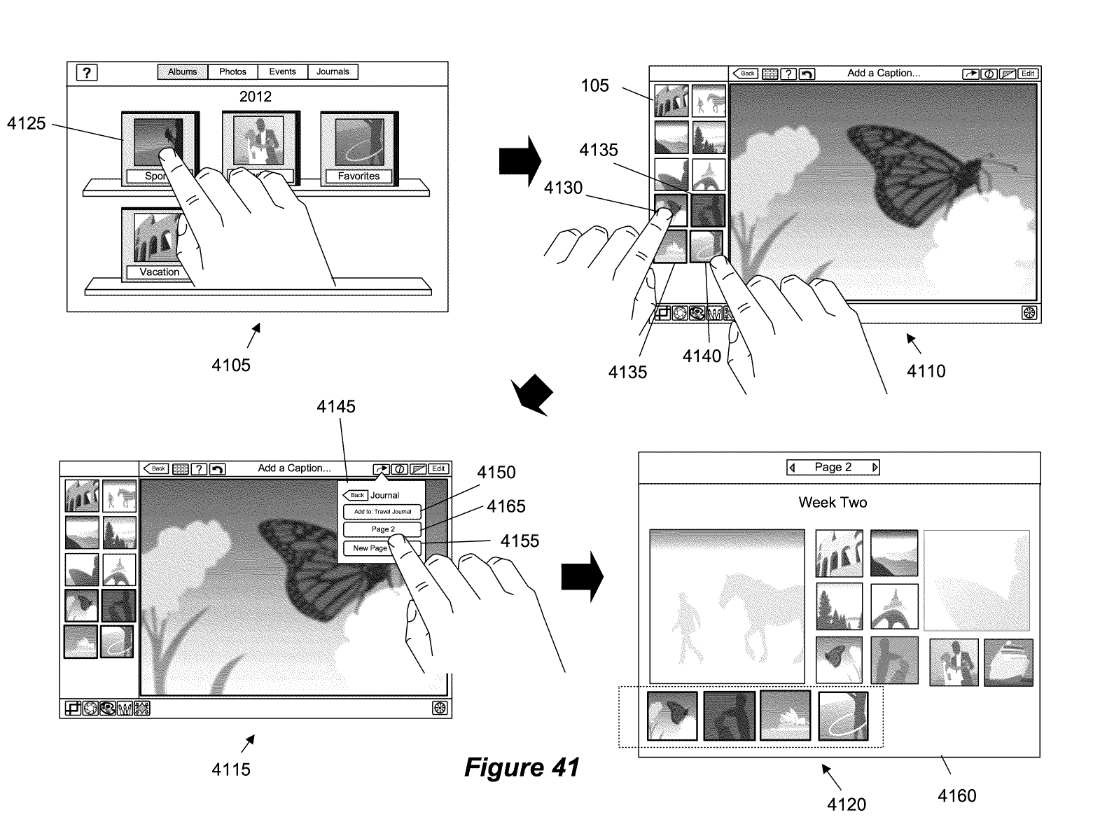

In some embodiments, the application provides a set of tools to add images to a journal. The application of some embodiments allows the user to specify whether to add one or more images to an existing journal page or add the images to a new page. FIG. 41 provides an illustrative example of adding images. Specifically, this figure illustrates in four operational stages 4105-4120 how the application adds several selected images to a selected page of the journal.

In the first stage 4105, the application displays several albums in the album view. The user selects an album 4125. As shown in the second stage 4110, the selection causes the application to display images in the album on the thumbnail display area 105.

In the second stage 4110, a range of images is selected for a journal. Specifically, the user taps and holds the first and last thumbnails 4130 and 4140. The multi-touch gesture causes the application to highlight the selected thumbnails in the thumbnail display area 105.

The third stage 4115 illustrates the application displaying a journal options window 4145. The journal options window includes a selectable item 4150 to add the images to a new or existing journal. Here, the user has selected the option to add the images to an existing journal page. The user then selects a journal page to add the images using a selectable item 4165. Specifically, the user has selected the second page of the journal. Alternatively, the user can select the selectable item 4155 to add the images to a new page. The fourth stage 4120 illustrates the journal 4160 after adding the range of images. As shown, the range of images is sequentially added at the end of the second page.

### VIII. Auto Layout/Reset Layout

In some embodiments, the application provides a reset tool to reset a journal layout. This reset tool can be used to reset each item (e.g., images, info items) on the journal to its default size. In addition to the reset tool, or instead of it, the application of some embodiments provides auto layout tool. The auto layout tool can be used to reflow items on the journal using a set of rules. Several examples of such a set of rules are described by reference to FIGS. 5-10.

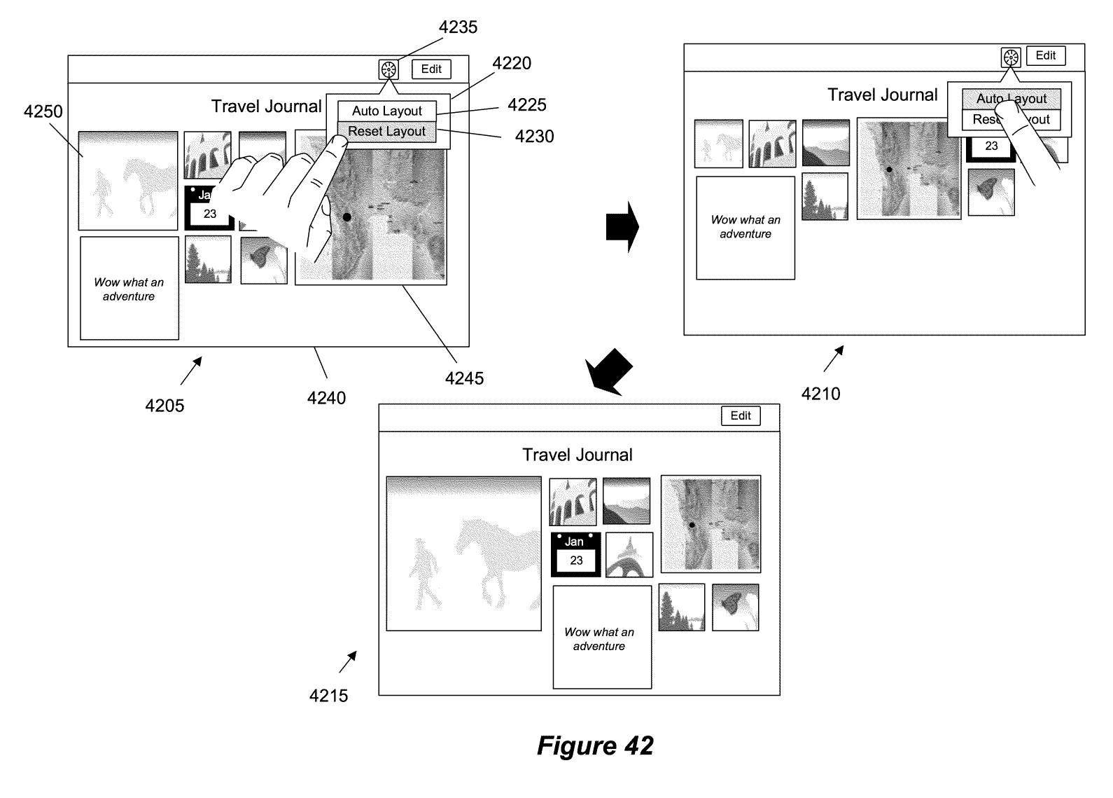

FIG. 42 provides an illustrative example of modifying the layout of a journal 4240. Specifically, this figure illustrates in three operational stages 4205-4215 an example of how the application of some embodiments performs the reset and auto layout operations.

In the first stage 4205, the application displays an edited journal 4240. Several of the items have been resized according to user input. Specifically, the map 4245 has been resized from an item that by default occupies two grid cells on two rows (i.e., a two by two item) to one that occupies three grid cells on three rows (i.e., a three by three item). The image 4250 has been resized to be a two by two item. In some embodiments, the default size of the image is one by one. The remaining items are overlaid on the journal at their default sizes.

As shown in the first stage 4205, the user has selected a journal setting control 4235. The selection caused a journal settings tool 4220 to appear. This setting tool includes a reset control 4230 and an auto layout control 4225. The selection of the reset control resets each item (e.g., images, info items) on the journal to its default size. The selection of the auto layout control 4225 causes the application to reflow items on the journal using the predetermined set of layout rules. In some embodiments, the setting tool 4220 includes a theme selector for changing the journal's theme. An example of such a theme selector is described above by reference to FIG. 4.

In the first stage, the user selects the reset control 4230. The second stage 4210 illustrates the journal after the selection of the reset control 4230. As shown, the selection causes the application to reset the sizes of the image 4250 and the map 4245. Specifically, the map 4245 is displayed as a two by two item, and the image 4250 is displayed as a one by one item. In some embodiments, the selection of the reset tool 4230 causes the application to traverse the ordered list associated with the journal to modify each item that is not listed with its default size.

In the second stage 4210, the user selects the auto layout control 4225. As shown in the third stage 4215, the selection causes the application to modify the journal layout. In some embodiments, the application uses a set of rules to modify the default sizes of one or more items. For instance, a first rule has specified the first image 4250 on the journal to be a three by three item. A second rule might specify that the fourth item on the journal is a two by two item.

### IX. Sharing Journals

The application of some embodiments provides a variety of different tools to share journals. Several examples of these tools will now be described by reference to FIGS. 43-52.

A. Web Publishing Tools

FIG. 43 provides an illustrative example of sharing a journal by publishing the journal to a website. Three operational stages 4305-4315 of the application are shown in this figure. As shown, this figure includes a pop-up window 4380 that has (1) a cloud publishing tool 4345, (2) a cloud message tool 4365, (3) a cloud viewing tool 4370, (4) a home page tool 4375, (5) a home page message tool 4302, and (6) a home page viewing tool 4304.

The cloud publishing tool 4345 allows the user to specify whether a journal should be published to a website. This website may be one provided to the user by the cloud service. For example, the cloud service provider may allow the user to publish the journal to a website that it hosts. In such case, the cloud service provider may provide a uniform resource locator (“URL”) that can be used to access the published version of the journal (e.g., or more or web pages). In some embodiments, the URL is a public URL. However, the URL may include many characters (e.g., random number and/or text) that make it difficult to locate.

In the example illustrated in FIG. 43, the cloud publishing tool 4345 includes a control 4355 (e.g., toggle switch). The user can select (e.g., toggle) the control 4355 to publish the journal (e.g., the displayed journal 4385) to the website. The user can also reselect the control to turn off the web-publishing feature for the journal. In this manner, the application allows the user to publish the journal by simply selecting or toggling a button.

The cloud message tool 4365 allows the user to send a message that contains a URL link to the published journal. For example, the user can select this button and add one or more entities (e.g., friends, families) to send the message. In some embodiments, the selection of this tool causes an email program to be opened with a new message that includes the URL link. The user can then input one or more email addresses and select (e.g., tap) a send button to send the message.

The cloud view tool 4370 can be selected to view the published version of the journal in a web browser. That is, the selection of this button causes a web browser to be displayed or opened. The web browser then loads a web page version of the journal. In some embodiments, this viewing feature is achieved by sending the browser the above-mentioned URL.

The homepage tool 4375 allows the journal to be added to a journal home page. Specifically, a representation (e.g., one or more thumbnail images) of the journal is added to the home page. The representation is associated with the URL of the journal's web page. That is, the representation is a link that can be selected to navigate to the web page. The journal home page may include links to several different published journals. Similar to the cloud message tool, the home page tool 4375 includes a control 4306 (e.g., toggle switch) to specify whether the journal is added to the home page.

In the first stage 4305, the application displays the journal 4385. To share the journal, the user has selected a share button 4390. The selection results in the display of a share tool 4325. This tool includes a cloud tool 4330 for publishing the journal to a website, a slide show tool 4335 for displaying a slide show of the images in the journal, an application tool 4340 for opening another application to save the journal.

As shown in the first stage 4305, the user selects the cloud tool 4330 to publish the journal to a website. The second stage 4310 illustrates the GUI after the selection of the cloud tool. The selection causes the application to display the pop-up window 4380.

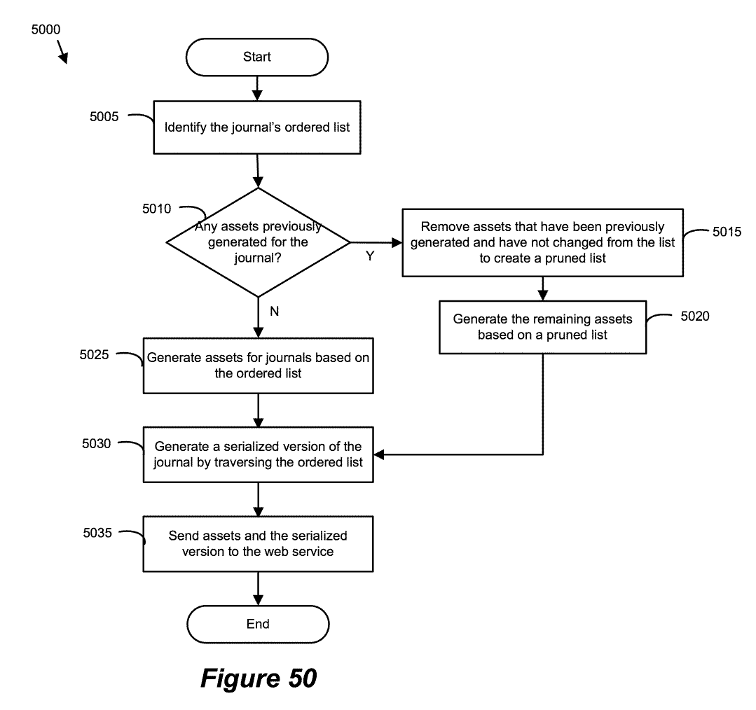

In the second stage 4310, the user has selected the control 4355 associated with the cloud publishing tool 4345. Specifically, the control 4355 has been toggled to the “On” position from the “Off” position. When the control is switched to the “On” position, the application of some embodiments enters a publishing mode. During this mode, the application may generate assets (e.g., images) and send those generated assets to a web publishing service. The application may also display a prompt or a notice, which indicates that images are being generated. Several examples of generating and sending assets will be described below by reference to FIG. 50. When the journal is in the process of being published, the application may also disable the cloud message tool 4365 and the cloud viewing tool 4370. Here, the journal 4385 has been published to the web site. To view the published journal, the user then selects the cloud viewing 4370.

As shown in the third stage 4315, the selection causes a web browser 4395 to be displayed or opened. The web browser 4395 receives data from the web server hosting the journal's web page. The web browser 4395 then loads and displays the web page it in a browser window.

In the example described above, the journal 4385 is published to the web site when the user toggles the control 4355 to the “On” position. When the user decides that he or she does not want to share the journal, the user can toggle the control 4355 to the “Off” position. In some embodiments, this selection causes the web server hosting the journal's web page to delete the web page and its associated images. In some embodiments, the application presents a prompt or warning that the published journal (i.e., the set of web pages) and its associated images will be deleted.

B. Published Journal

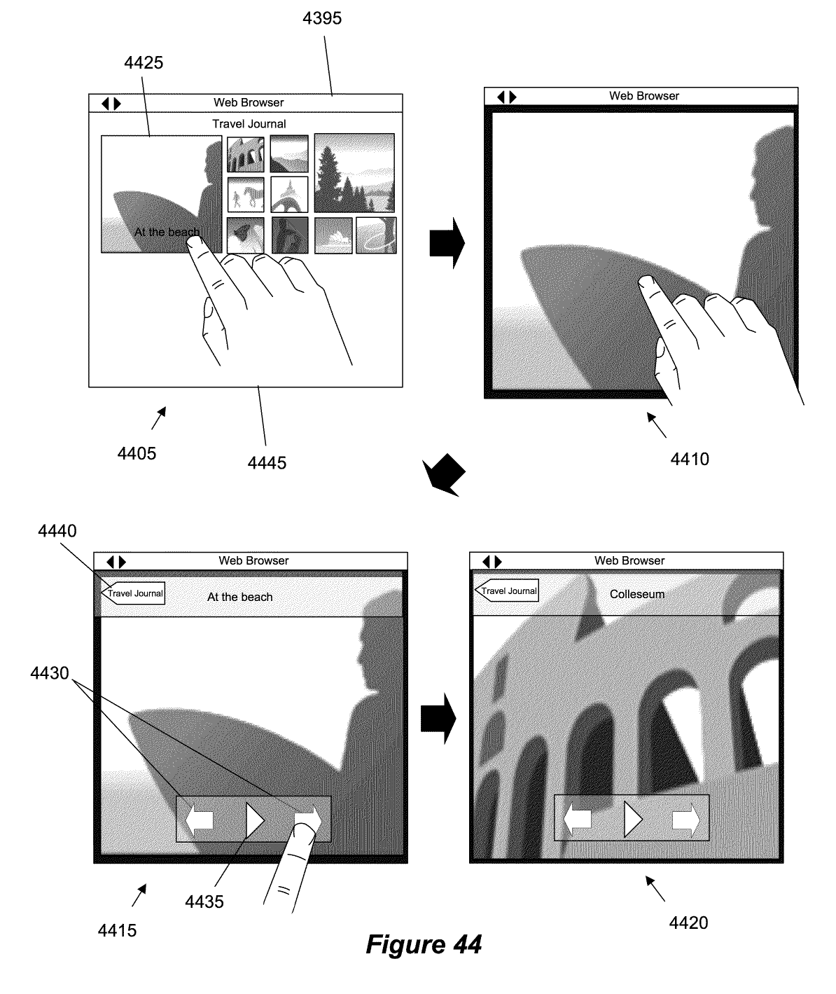

The previous example illustrated publishing a journal to a website. FIG. 44 provides an illustrative example of how some embodiments present the published journal on a web browser. Specifically, this figure illustrates in four operational stages 4405-4420 how a user can select an image and scroll through images in the published journal. These operations are continuations of the ones illustrated in FIG. 43.

In the first stage 4405, the web browser 4395 displays the published journal 4445 (i.e., the web page version). As shown, the web page is similar to the source version of the journal. Specifically, the journal heading is displayed at the top of the web page. The images are arranged in a grid-like format. Several of the images appear larger as they occupy more than one grid cells. In addition, the image 4425 is displayed with its associated caption. Similar to the source version, the caption is displayed over (e.g., the lower portion of) the image 4425.

In the first stage 4405, the user selects (e.g., by performing a gesture such as tapping the user's finger on) the first image 4425 on the web page. As shown in the second stage 4410, the selection causes the browser 4395 to load and display a higher resolution version of the first image 4425. Here, the higher resolution version is a full screen representation. The full screen representation is displayed without the caption.

As shown in the second stage 4410, the user selects (e.g., by performing a gesture such as tapping the user's finger on) the full screen representation. The selection causes the caption to appear over the full screen representation. Specifically, the caption is displayed at the top of the full screen representation. The selection also causes several controls 4430-4440 to appear over the full screen representation. These controls include a back button 4440 for returning to the previous view (i.e., the thumbnail grid view of the first stage 4405) and a slide show button 4435 for playing a slide show of the journal's images. The controls also include several directional arrows 4430 for navigating through the journal's images. These directional arrows provide a visual indication to the user that the user can scroll to the next or previous image. When the image is a first image in the journal, an input to display a previous image may cause the browser 4395 to load and display the last image in the journal. Similarly, when the image is the last image, an input to display the next image may cause the browser to load and display the first image in the journal.

In the third stage 4415, the user selects (e.g., by performing a gesture such as tapping the user's finger on) on a directional arrow to scroll to the next image. Alternatively, the user can perform a touch gesture (e.g., by swiping across at least a portion of the displayed image). As shown in the fourth stage 4420, the input causes the browser 4395 to load and display a full screen representation of the second image in the journal 4445. Specifically, the full screen representation is displayed with the controls 4430-4440. As the second image is not captioned, the full screen representation is displayed with the image's name (e.g., file name). In some embodiments, the controls and the caption disappear (e.g., fade away) when there is no user input for a predetermined period of time.

In the example described above, the browser presents several controls 4430-4440 upon selection of an image. However, the browser may present one or more other controls. For example, a selection of an image may cause the browser to display a save button for saving the image. When the image represents a video clip, the browser may display a play button for playing the video clip.

Also, in the example described above, the user uses a web browser to scroll through images in the published version of the journal. Similar to the published version, the application of some embodiments allows the user to scroll through images. For example, the user can select a journal using the application, then select an image, and scroll through images in the journal. In addition, if the image represents a video clip, the application of some embodiments plays the video clip upon a user selection of the video clip.

C. Adding to a Homepage

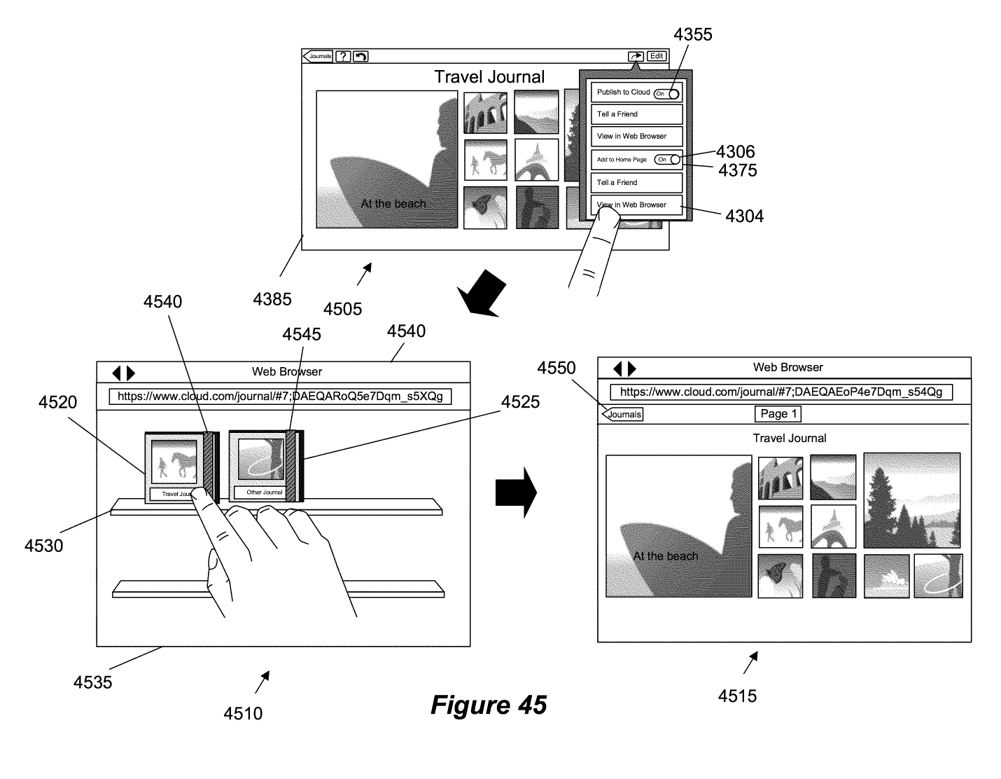

As mentioned above, the application of some embodiments allows a published journal to be added to a journal home page. FIG. 45 provides an illustrative example of adding a published journal to a journal home page. Three operational stages 4505-4515 are shown in this figure.

The first stage 4505 illustrates the application after publishing the journal 4385 to the web site. To publish the journal, the user has toggled the control 4355 from the “Off” position to the “On” position. The user has also selected the option to add the published journal to the journal home page. This is shown in the first stage 4505 as the control 4306 associated with the home page tool 4375 is in the “On” position. To view the journal home page, the user then selects the home page viewing tool 4304.

As shown in the second stage 4510, the selection of the home page viewing tool 4304 causes the web browser to display a journal home page 4535. The journal homepage is similar to the journal display area that is described above by reference to FIG. 4. The journal home page includes representations 4520 and 4525 of the published journal. Specifically, each representation is presented as a small travel journal with an elastic band (4540 or 4545) around it. In some embodiments, the color of the elastic band indicates that the journal is a remote journal. For instance, a red color may indicate that the journal is a remote journal that can be viewed but not edited while a gray color may indicate that the journal is a local journal that can be edited.

Each representation is also displayed with an image (e.g., a key image or key photo) and a title. The title corresponds to the one specified with the image organizing and editing application. The title may also be a default title specified by the application.

In the second stage 4510, the user selects (e.g., by performing a gesture such as tapping the user's finger on) the representation 4520. As shown in the third stage 4515, the selection causes the web browser 4540 page to load and display the web page version of the journal 4385. Here, the web page version includes a back button 4550 to return to the journal home page 4535.

In the example described above, two published journals are presented in the journal home page. The user can add additional journals to the homepage. For example, the user can select another journal and toggle its associated home page control to the “On” position. The user can also remove the journal from the journal home page by toggling the control to the “Off” position.

D. Sending a Message

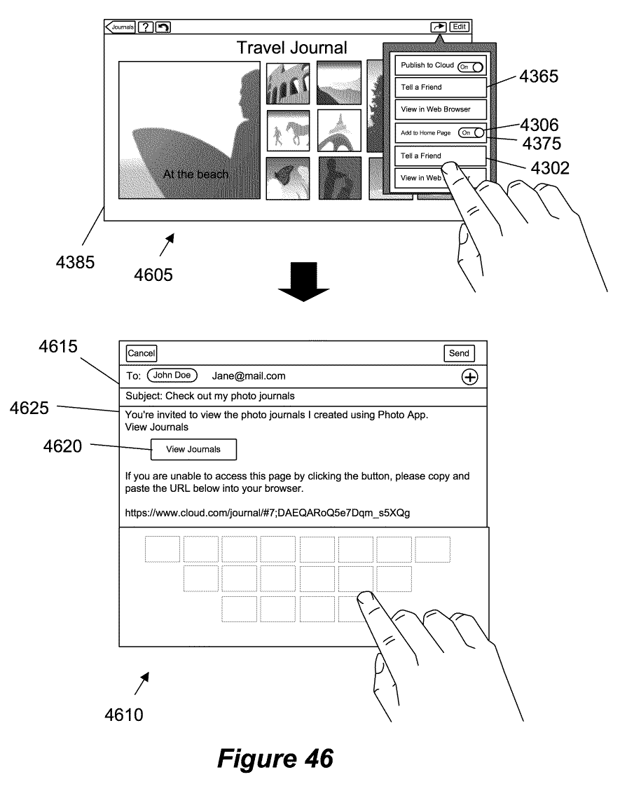

In some embodiments, the image organizing and editing application allows the user to send a message that contains a link to the published journal. FIG. 46 provides an illustrative example generating and sending such a message. Two operational stages 4605-4610 are illustrated in this figure.

The first stage 4605 illustrates the application after publishing the journal 4385 to the web site. The user has also selected the option to add the published journal to the journal home page. This is shown in the first stage 4605 as the control 4306 associated with the home page tool 4375 is in the “On” position. To generate an email message, the user then selects the home page message tool 4302. The application then generates a message relating to the home page of published journal. The application may also display a prompt, which indicates that the message is being generated.

As shown in the second stage 4610, the selection of the home message tool 4302 causes an email application 4615 to be opened. The email application 4615 displays an email 4625 with the message. Here, the email includes a button 4620 that is associated with the URL of the journal homepage. The recipient of the email can select this button 4620 to display the journal home page (e.g., in a web browser).

In the previous example, the home page message tool 4302 is selected to generate a message that contains a link to the journal home page. Alternatively, the user can select the cloud message tool 4365 to generate a message that contains a link to the published journal. In some embodiments, when the control 4306 associated with the home page tool 4375 is switched to the “On” posited, the published journal contains a link (e.g., the back button 4550 of FIG. 45) to the journal home page.

E. Synching Edits

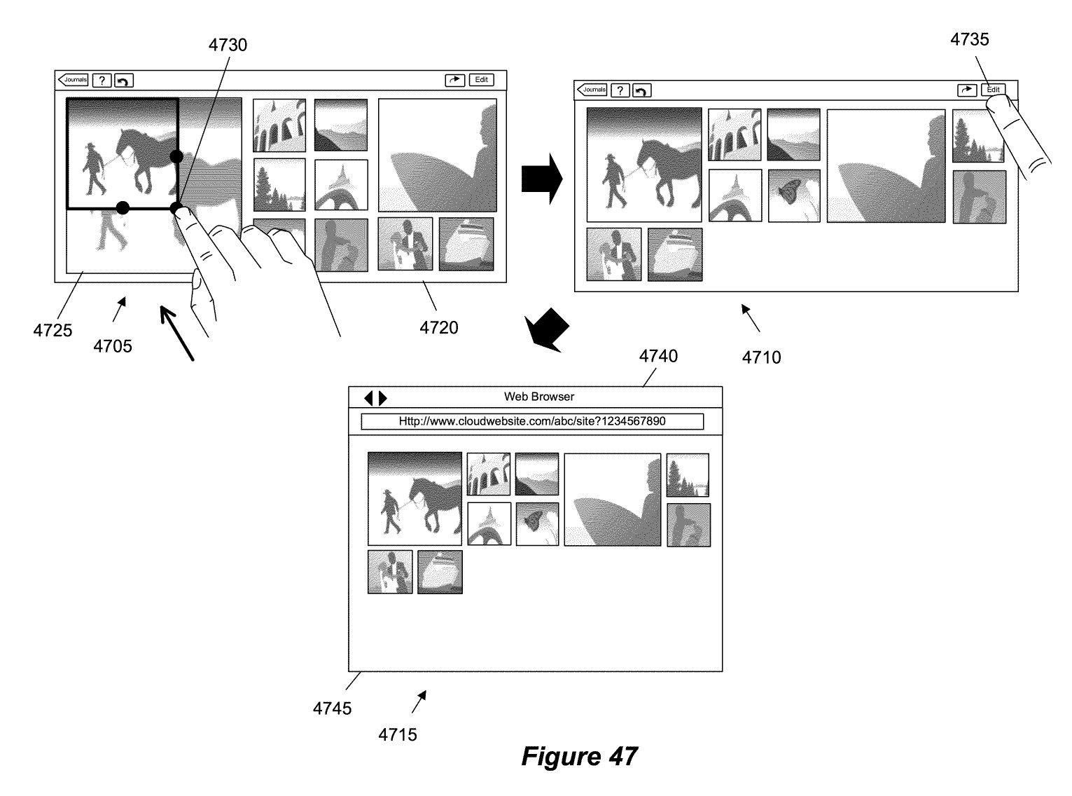

In the previous example, the published or remote version of a journal is displayed in a web browser. When a journal is edited, the application of some embodiments allows the user to synchronize (sync) or dynamically update the remote version of the journal with the edits. FIG. 47 provides an illustrative example of synchronizing edits to a local journal with a corresponding remote journal. Specifically, this figure illustrates in three stages 4705-4715 how edits to a local journal are instantly reflected remotely in the published journal.

The first stage 4705 illustrates editing the journal 4720. Specifically, the user has selected the first image 4725. The selection causes several selectable items (e.g., 4730) for resizing the first image to appear. The user then selects and moves the selectable item 4730 from one corner of the image 4725 towards the opposite corner to resize the first image 4725.

The second stage 4710 illustrates the journal 4720 after resizing the first image 4725. As shown, the first image 4725 has been resized from a three by three image to a two by two image. Here, the user then selects a control 4735 to synchronize the edits to the local journal with the remote journal. The selection causes the application to send the update to the cloud service (e.g., web service).

In the third stage 4715, a web browser 4740 has been opened. Specifically, the web browser shows the published version of the journal 4745 has been updated with the edits to the local journal 4720. The user can make additional edits to the local journal 4720 and select the control 4735 to synchronize the local journal with the remote journal 4745.

In the example illustrated in FIG. 47, the sync control 4735 is an edit button. In some embodiments, the selection of this edit button causes the application to display a prompt, which indicates that the application is generating images for the web page version. One of ordinary skill in the art would understand that the edit button is just one example control that the user can select to synchronize the local journal with the remote journal. For example, the application may provide another different control (e.g., a back button, a close application button, etc.) that can be selected to initiate the synchronization.

F. Synching Devices

In the examples described above, the journal that is created on one device is published using a cloud service (e.g., web service). In some embodiments, the cloud service provides tools to create an association between multiple devices. For example, the cloud service provider may allow the user to register several devices under one account. When a journal is published with one device, the cloud service of some embodiments allows the journal to be synchronized across all other devices.

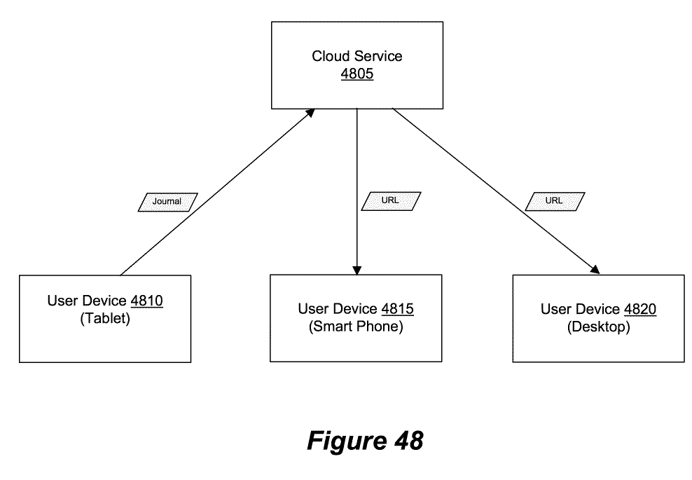

FIG. 48 conceptually illustrates a data flow diagram that provides an example of how a journal is synchronized across multiple associated devices. As shown, the figure includes three user devices 4810-4820. Here, the user device 4810 is a tablet computer, the user device 4815 is a smart phone, and the user device 4820 is a desktop computer. These devices are just a few examples of many different types of devices that can be associated through an account. For example, the user device 4820 could also be a laptop computer, a workstation, etc. In addition, one account can be associated with several similar devices (e.g., multiple smart phones, tablets, etc.).

The cloud service 4805 of some embodiments provides one or more services that the user can use. For example, the cloud service of some embodiments provides a storage service that allows the user to store or back-up data (e.g., contacts, documents) from the user devices. As mentioned above, the cloud service 4805 may also provide a web hosting service for hosting the web page version of a journal. In some embodiments, the cloud service 4805 may charge a fee when the amount of data (e.g., hosted images and/or video clips in the journal) stored with the service exceeds a particular threshold value (e.g., five gigabytes).

As shown in FIG. 48, the user device 4810 sends journal data through a network (e.g., the Internet). Specifically, the user device 4810 sends the journal data to publish the journal on a web page. The user might have selected an option in the application to publish the journal. In some embodiments, the application generates the journal data by traversing one or more ordered lists and outputting a serialized text. That is, the application of some embodiments analyzes one or more journal lists with the size and position information of each item to output one or more files. In some embodiments, the application performs the serialization to output the files in a JavaScript Object Notation (JSON) format. However, the journal list can be serialized in a different format (e.g., XML format). In some embodiments, when a local journal is updated, the application performs the serialization operation on the one or more ordered lists. Alternatively, the application may perform the serialization operation on only those portions that have been modified.

The cloud service 4805 receives the journal data and publishes the journal as one or more web pages. The cloud service also generates a URL that can be used to access the published or remote journal. The URL is then sent to each of the other devices 4815 and 4820 associated with the account. In some embodiments, the cloud service includes a module (e.g., HTML generator) to convert the serialized text to web page documents (e.g., HTML files). For example, the converter might read the serialized text (e.g., with the image information, the position information, and size information) and output one or more documents.

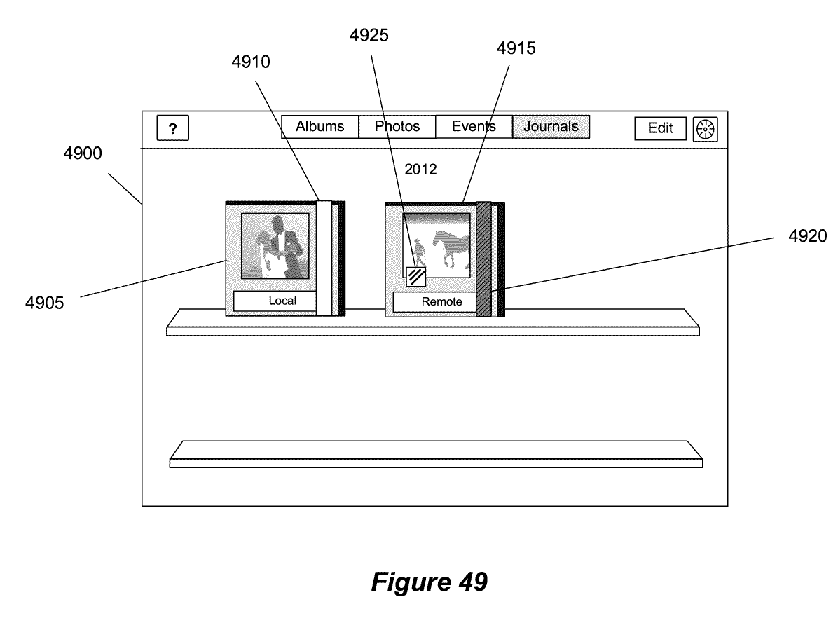

In the example described above, when a journal is published with one device, several other associated devices are automatically notified of the publication. That is, the cloud service sends URL of the published journal to each of the associated devices. FIG. 49 provides an illustrative example of how the application of some embodiments presents the local and remote journal differently.

As shown in FIG. 49, the application displays the journal display area 4900. The journal display area displays two journals 4905 and 4915. Each of the journals is displayed with a particular image (e.g., a key photo) and a particular title. For illustrative purposes, the title indicates that the journal 4905 is a local journal, while the journal 4915 is a remote or web version of the local journal.

In some embodiments, the local journal is one that can be edited on the device. This is because the media content (e.g., images, video clip) and/or the journal data (e.g., the journal layout list) are stored locally on that device.

In some embodiments, the application provides visual indications to indicate whether a journal is a local journal or a remote journal. In the example illustrated in FIG. 49, the local journal 4905 is displayed with a band 4910 having one color (e.g., white), while the remote journal 4915 is displayed with a band 4920 having another color (e.g., red). The remote journal 4915 is also displayed with an icon to indicate that it represents a remote journal. One of ordinary skill in the art would understand that the color of the band and the icon are just two of many possible visual indications. For example, the application of some embodiments might use different sizes pattern, and/or text, etc.

In the example illustrated in FIG. 49, the remote journal 4915 is displayed with a title and an image. In some embodiments, the title and the image are received along with the journal URL from the cloud service provider. Alternatively, the application downloads these items upon receiving the URL.

G. Example Processes

Several examples of sharing a journal by publishing it to a website have been described above. FIG. 50 conceptually illustrates a process that some embodiments use to generate different items (e.g., images) to publish a journal to a web site. In some embodiments, the process is performed by the image organizing and editing application. The process 5000 begins when it identifies (at 5005) the journal's ordered list. In some embodiments, the identification is initiated with the user selecting an option to publish the journal to a website. The identification may also be initiated after a published journal has been edited. An example of synchronizing edits is described above by reference to FIG. 47.

At 5010, the process 5000 determines whether any assets have been previously generated for the journal. Examples of assets include images, info items, text items, etc. In some embodiments, these assets are generated at different resolutions using source assets (e.g., depending on the number of grid cells each asset occupies on a journal page). The process might also generate multiple images at different sizes for one source image. For instance, the process might generate a thumbnail image (e.g., for the key image or the grid view), a full screen image, etc.

When assets have been previously generated, the process 5000 creates (at 5015) a pruned list by removing assets that have been previously generated and have not changed from the ordered list. For example, the process 5000 might have previously generated and sent images and/or info items that remain the same in the journal. As such, the web server may already store those assets. The process 5000 then generates (at 5020) the remaining assets based on a pruned list. The process 5000 then proceeds to 5030, which is described below.

When no assets have been generated for the journals, the process 5000 generates (at 5025) asset for the journal. The process 5000 then generates (at 5030) a serialized version of the journal. In some embodiments, the serialized version is generated by traversing the entire ordered list and not the pruned list. The process 5000 of some embodiments generates the serialized version each time, regardless of whether or not the journal has been previously published. The serialized version may include information about each asset along with the asset's position and size information. As mentioned above, the serialized version of the journal may be a JSON file. However, the journal list can be serialized in a different format (e.g., XML format).

The process then sends (at 5035) the generated assets and the serialized version to a cloud service for publication. The application may execute on a mobile device (e.g., a smart phone, tablet). In some embodiments, the process sends one or more of these items when the device is connected to the Internet using a particular type of connection. For example, the items may be sent when the source device is connected to the internet using a Wi-Fi network. That is, these items may not be sent when the mobile device is connected to the Internet using a mobile network (e.g., 3G network, 4G network). This allows the mobile device to stay in a low power state and save battery, instead of switching to a high power state to send data over the mobile network.

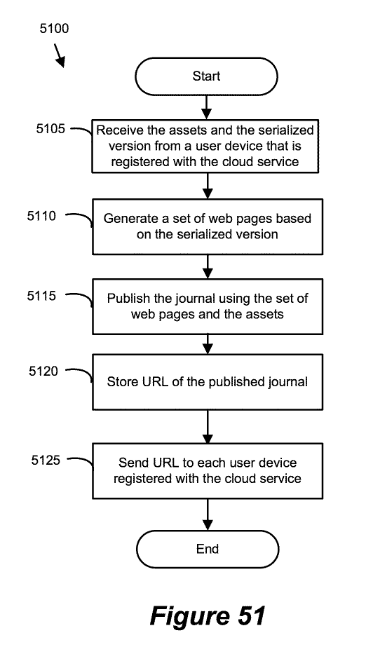

FIG. 51 conceptually illustrates a process 5100 that some embodiments use to publish a journal to a web site. In some embodiments, the process 5100 is performed by the cloud service. The cloud service may include one or more servers that perform different functions. For instance, the cloud service may include a web server that publishes the journal to the website. The cloud service may also include a control server that stores the URL associated with the journal and/or sends the URL to one or more computing devices (e.g., in order to share the journal).

As shown in FIG. 51, the process 5100 begins when it receives (at 5105) the assets and the serialized version from a source device that is registered with the cloud service. The process 5110 then generates (at 5110) a set of web pages based on the serialized version. For example, the process 5100 might analyze the information related to each asset (e.g., the name of the asset, the size and position information) and generate one or more HyperText Markup Language (HTML) documents.

At 5115, the process 5100 publishes (at 5115) the journal using the set of web pages and the assets. The process 5100 then stores (at 5120) the URL of the published journal. The process then sends (at 5125) the URL each user device registered with the cloud service. For example, the user may have several devices (e.g., smart phone, tablet) registered with the cloud service (e.g., cloud service account). The cloud service of some embodiments sends the URL to each register device.

The processes 5000 and 5100 are two example processes for publishing a journal to a web site. The specific operations of these processes may not be performed in the exact order shown and described. The specific operations may not be performed in one continuous series of operations, and different specific operations may be performed in different embodiments. Furthermore, each of these process could be implemented using several sub-processes, or as part of a larger macro process.

H. Exporting Journals

In the previous example, a journal that is created on one device is presented on multiple other devices. In some embodiments, the application of some embodiments allows the journal that is crated with one device to be saved on another device. In some embodiments, the journal is saved as a web-page version that includes images in the journal with one or more webpages linking to these images.

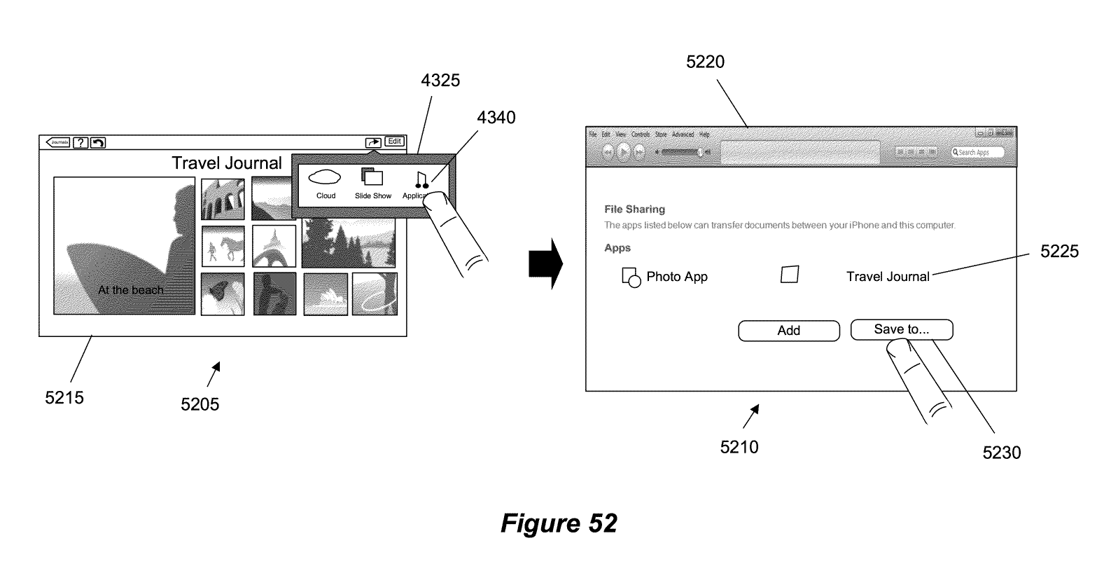

FIG. 52 illustrates saving a journal 5215 as a web document. Specifically, this figure illustrates in two operational stages 5205 and 5210 how a journal created with a first device (e.g., tablet, smart phone) can be saved to another device (e.g., laptop, desktop). As shown in the first stage 5205, the journal 5215 has been created with the application that executes on the first device.

To save the journal, the user selects the application tool 4340 from the share tool window 4325. As shown in the second stage 5210, the selection causes an application 5220 to be launched in a second device. Alternatively, the user can connect the first device to the second device to launch this application. In the example illustrated in FIG. 52, the application 5220 is a program for managing content on the first device. The application may also be a media program for downloading, saving, and organizing digital music and video files. Here, the application 5220 lists the image organizing application as a photo app.

The second stage 5210 illustrates saving a webpage version of the journal on the second device. Specifically, the user selects the name 5225 of the photo app listed on the application 5220. The user then selects a save button 5230. The application 5220 saves the journal 5215 as a webpage version (e.g., HTML documents with images) of the journal on the second device. As mentioned above, the application of some embodiments generates outputs serialized text by traversing the journal list. That is, the application of some embodiments analyzes the ordered list with the size and position information of each item to output one or more files. In some such embodiments, the application downloads a plugin to convert the serialized text to the webpage version. In some embodiments, the application saves the webpage version (e.g., images, web pages) to one or more folders.

### X. Alternate Embodiments

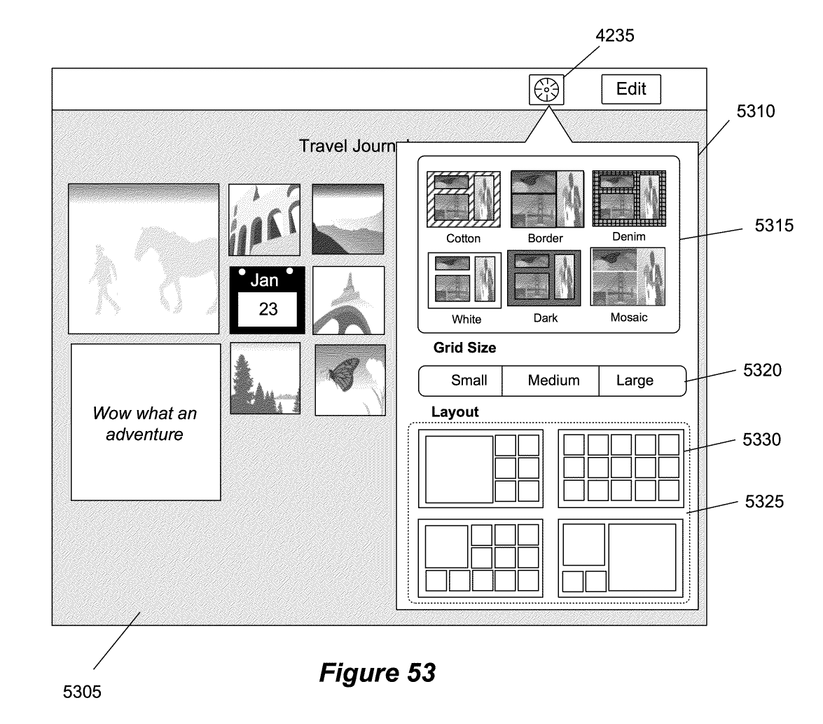

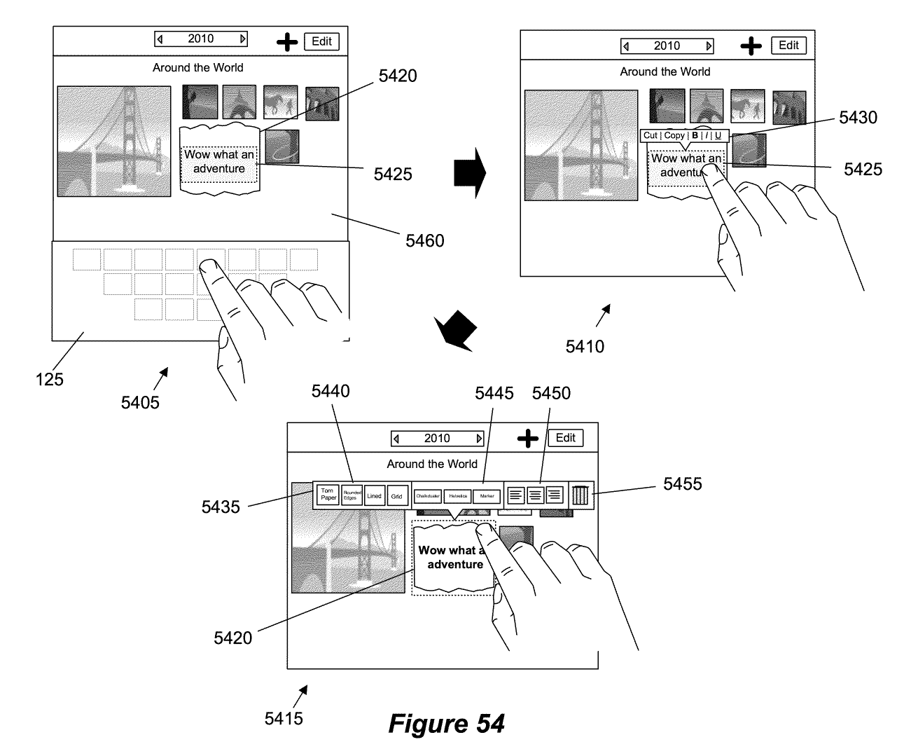

Many different examples of creating journals with an image editing application are described above. Several alternative embodiments of the image organizing and editing application will now be described by reference to FIGS. 53 and 54. FIG. 53 provides an illustrative example of a journal settings tool 5310 for modifying a journal 5305. Specifically, this figure illustrates how this settings tool 5310 can be used to modify the style or theme, the size of the grid, and the layout of the journal.

As shown FIG. 53, the application is displaying the journal 5305. To modify the journal, the user has selected a journal settings control 4235. The selection causes the application to display the journal settings tool 5310. The settings tool 5310 includes a theme selector 5315, a grid size selector 5320, and a layout selector 5325.

The theme selector 5315 allows the application's user to select a theme or style for the journal 5305. Different from the example described above by reference to FIG. 3, the theme selector 5315 simultaneously displays different themes. The user does not have to select (e.g., swipe the user's finger across) an area of the settings tool 5310 to display a next or previous theme. In this example, the theme includes cotton, border, denim, white, dark, and mosaic. Any one of these themes can be selected to change the background look (e.g., color, pattern) of the journal, and/or the edge or boundary between images in the journal. Each of these themes is also displayed with a preview (e.g., a thumbnail preview) of how the journal may appear when the corresponding theme is applied.

The grid size selector 5320 allows the user to change the size of the thumbnail grid. Specifically, the selector 5320 includes three buttons to make the thumbnail grid small, medium, or large. Accordingly, this selector 5320 allows the user to granularly adjust the sizes of the images and/or video clips that appear on the journal 5305.

The layout selector 5325 is a tool that can be used to change the layout of the journal. The layout selector concurrently displays several different layouts. Each layout specifies the size and/or arrangement of the images on a page of the journal. For example, the layout 5330 can be selected to make all images the same grid size on the page. As shown, each layout is displayed with a thumbnail preview of the layout. In some embodiments, the selection of a layout provides a more detailed example of how the journal may appear when the corresponding layout is applied. For instance, the detailed preview may present a page of the journal with a specified theme, a specified grid size, and/or the images in the journal.

The previous example illustrated a journal settings tool that can be used to modify the theme, grid size, and the image layout of the journal. The application of some embodiments provides other user interface items to edit info items, such as text or designed text item. FIG. 54 provides an illustrative example of modifying a designed text item. Three operational stages 5405-5415 of the application are shown in this figure. In the first stage 5405, the user has added a design text item 5420 (e.g., “memory” info item) to a page of a journal 5460. The user has also inputted text into the associated text field using the virtual keyboard 125.

The second stage 5410 illustrates the journal after the user has inputted text 5425 for the text item 5420. Here, the user has selected (e.g., tapped the user's finger on) the text 5425. The selection resulted in the display of a text tool 5430. In the example illustrated in second stage 5410, the text tool 5430 appears over the selected text as a pop-up window. The text tool includes different operations to modify the selected text. Specifically, the text tool includes selectable items to cut, copy, bold, italicize, and underline the text. In some embodiments, the text tool 5430 includes a selectable item for pasting text that has been previously copied.

In conjunction with text modification or instead of it, the application of some embodiments allows its user to modify the look of an info item. This is illustrated in the third stage 5415 as the application displays an info item tool 5435. The user might have first selected (e.g., tapped the user's finger on) the text item 5420 to display this tool.

The info item tool 5435 includes different groups of selectable items 5440-5450 to modify the look of the text item. In particular, the tool includes a first group of items 5440 to change the background design of the text item. For example, the user can select a torn paper, rounded edge, lined paper, or grid paper style. The second group 5445 can be used to select one of several different fonts (e.g., Chalkduster, Helvetica, Marker) for the designed text item 5420. In addition, the items in the third group 5450 can be selected to change the alignment of text (e.g., left alignment, center alignment, right alignment). The tool 5435 also includes a delete button 5455 to delete the text item. In some embodiments, the application provides different selectable item or different combinations of selectable items (e.g., based on the selected info item). For instance, when a different designed text item is selected, the application may provide options to change its color.

In the example described above, the application provides different tools to edit a text item. One of ordinary skill in the art would understand that other info items could be modified in a similar manner. For instance, the application might allow the user to modify the look of the calendar item, the map item, or the weather item by selecting a background color, background style, font, font type, alignment, etc.

### XI. Software Architecture

A. Example Software Architecture

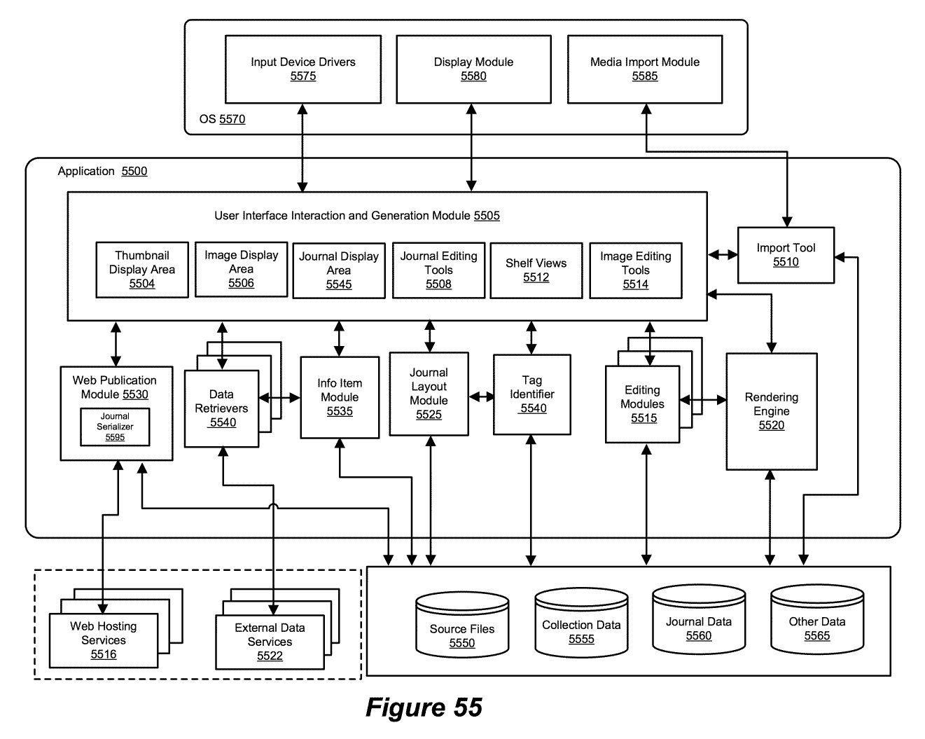

In some embodiments, the processes described above are implemented as software running on a particular machine, such as a computer or a handheld device, or stored in a machine readable medium. FIG. 55 conceptually illustrates the software architecture of an image organizing and editing application 5500 of some embodiments. In some embodiments, the application is a stand-alone application or is integrated into another application, while in other embodiments the application might be implemented within an operating system. Furthermore, in some embodiments, the application is provided as part of a server-based solution. In some such embodiments, the application is provided via a thin client. That is, the application runs on a server while a user interacts with the application via a separate machine remote from the server. In other such embodiments, the application is provided via a thick client. That is, the application is distributed from the server to the client machine and runs on the client machine.

The application 5500 includes a user interface (UI) interaction and generation module 5505, an import module 5510, editing modules 5515, a rendering engine 5520, a journal layout module 5525, a tag identifier 5540, an info item module 5535, a web publication module 5530, and data retrievers 5590. As shown, the user interface interaction and generation module 5505 generates a number of different UI elements, including an image display area 5506, a journal display area 5545, a thumbnail display area 5504, journal editing tools 5508, shelf views 5512, and image editing tools 5514.

The figure also illustrates stored data associated with the application: source files 5552, collection data 5555, journal data 5560, and other data 5565. In addition, the figure also includes 1 external data sources 5522 to retrieve data and web hosting services 5516 to publish journals. In some embodiments, the source files 5550 store media files (e.g., image files, video files, etc.) imported into the application. The collection data 5555 stores the collection information used by some embodiments to populate the thumbnails display area 5504. The collection data 5555 may be stored as one or more database (or other format) files in some embodiments. The journal data 5560 stores the journal information (e.g., the ordered list) used by some embodiments to specify journals. The journal data 5560 may also be collection data structures stored as one or more database (or other format) files in some embodiments. In some embodiments, the four sets of data 5550-5565 are stored in a single physical storage (e.g., an internal hard drive, external hard drive, etc.).

FIG. 55 also illustrates an operating system 5570 that includes input device driver(s) 5575, display module 5580, and media import module 5585. In some embodiments, as illustrated, the device drivers 5575, display module 5580, and media import module 5585 are part of the operating system 5570 even when the application 5500 is an application separate from the operating system 5570.

The input device drivers 5575 may include drivers for translating signals from a keyboard, mouse, touchpad, tablet, touchscreen, etc. A user interacts with one or more of these input devices, each of which send signals to its corresponding device driver. The device driver then translates the signals into user input data that is provided to the UI interaction and generation module 5505.

The present application describes a graphical user interface that provides users with numerous ways to perform different sets of operations and functionalities. In some embodiments, these operations and functionalities are performed based on different commands that are received from users through different input devices (e.g., keyboard, trackpad, touchpad, mouse, etc.). For example, the present application illustrates the use of touch controls in the graphical user interface to control (e.g., select, move) objects in the graphical user interface. However, in some embodiments, objects in the graphical user interface can also be controlled or manipulated through other controls, such as a cursor control. In some embodiments, the touch control is implemented through an input device that can detect the presence and location of touch on a display of the device. An example of such a device is a touch screen device. In some embodiments, with touch control, a user can directly manipulate objects by interacting with the graphical user interface that is displayed on the display of the touch screen device. For instance, a user can select a particular object in the graphical user interface by simply touching that particular object on the display of the touch screen device. As such, when touch control is utilized, a cursor may not even be provided for enabling selection of an object of a graphical user interface in some embodiments. However, when a cursor is provided in a graphical user interface, touch control can be used to control the cursor in some embodiments.

The display module 5580 translates the output of a user interface for a display device. That is, the display module 5580 receives signals (e.g., from the UI interaction and generation module 5505) describing what should be displayed and translates these signals into pixel information that is sent to the display device. The display device may be an LCD, plasma screen, CRT monitor, touchscreen, etc.

The media import module 5585 receives media files (e.g., image files, video files, etc.) from devices (e.g., external devices, external storage, etc.). The UI interaction and generation module 5505 of the application 5500 interprets the user input data received from the input device drivers 5575 and passes it to various UI components, including the image display area 5506, a journal display area 5545, the thumbnail display area 5504, the journal editing tools 5508, the shelf views 5512, and the image editing tools 5514. The UI interaction and generation module 5505 also manages the display of the UI, and outputs this display information to the display module 5580. In some embodiments, the UI interaction and generation module 5505 generates a basic GUI and populates the GUI with information from the other modules and stored data.

As shown, the UI interaction and generation module 5505, in some embodiments, generates a number of different UI elements. These elements, in some embodiments, include the image display area 5506, a journal display area 5545, the thumbnail display area 5504, the journal editing tools 5508, the shelf views 5512, and the image editing tools 5514. The UI interaction and generation module 5505 also manages the display of the UI, and outputs this display information to the display module 5580. In some embodiments, the UI interaction and generation module 5505 generates a basic GUI and populates the GUI with information from the other modules and stored data. All of these UI elements are described in many different examples above.

The import tools 5510 manages the import of source media into the application 5500. Some embodiments, as shown, receive source media from the media import module 5585 of the operating system 5570. The import tool 5510 receives instructions through the UI interaction and generation module 5505 as to which files (e.g., image files) should be imported, and then instructs the media import module 5585 to enable this import. The import tool 5510 stores these source files 5550 in specific file folders associated with the application. In some embodiments, the import tool 5510 also manages the creation of collection data structures.

The editing modules 5515 include a variety of modules for editing images. Example includes tools for removing red eye, cropping images, correcting color, etc. Many more examples will be described below by reference to FIG. 55. The rendering engine 5520 handles the rendering of images for the application.

The web publication module 5530 allows journals to be published to different websites. As shown, the web publication module includes a journal serializer 5595. This serializer generates the serialized journal data that is sent to a web hosting service of some embodiments. That is, the journal serializer of some embodiments analyzes the ordered list with the size and position information of each item to output one or more files. In some embodiments, the application performs the serialization to output the files in a JavaScript Object Notation (JSON) format. However, the journal list can be serialized in a different format (e.g., XML format).

In some embodiments, the web hosting service 5516 is a specialized service. That is, it receives the serialized journal data and converts it to web documents (e.g., HTML files). The web service in some such embodiments includes a web document generator (not shown) to convert the serialized text to web page documents (e.g., HTML files). For example, the converter might read the serialized text (e.g., with the image information, the position information, and size information) and output one or more documents. The web hosting service then publishes the journal as one or more web pages. The web service also generates a URL that can be used to access the published or remote journal. The URL is then sent to one or more devices associated with the user.

The info item module 5535 allows different info items to be added to a journal. Examples of such info item include header, text, notes, weather info, map, date, etc. To dynamically populate the info item module communicates with one or more data retrievers 5540. The data retrievers access the external data services 5522 to retrieve data. One or more of these retrievers may implement an API of an external data services to retrieve data. Many examples of such external data services are described above. These examples include a weather report service, a map service, a travel service, etc.

The journal layout module 5525 creates a journal layout. In some embodiments, the journal is defined by a two-dimensional grid that contains a fixed number of cells along one dimension and varying number of cells along the other dimension. In order to layout items across the grid, the layout module of some embodiments creates an ordered list. The ordered list defines the layout by specifying the position and size of each item (e.g., images, video clips, etc.) in the journal. Several of the items in the list are specified to be different sizes.

To emphasize certain tagged images, the layout module of some embodiments performs multiple passes on the ordered list. The layout module may perform a first pass to list each item with a particular size. The layout module may then perform at least a second pass to identify any images that are tagged with a marking (e.g., a caption, a favorite tag). In identifying marked images, the layout module 5540 of some embodiments interfaces with a tag identifier 5540. In some embodiments, this tag identifier 5540 identifies one or more images in the ordered list that are tagged or marked with one or more types of markings.

While many of the features of the application 5500 have been described as being performed by one module (e.g., the UI interaction and generation module 5505, the import tool 5510, etc.), one of ordinary skill in the art will recognize that the functions described herein might be split up into multiple modules. Similarly, functions described as being performed by multiple different modules might be performed by a single module in some embodiments.

B. Example Data Structures

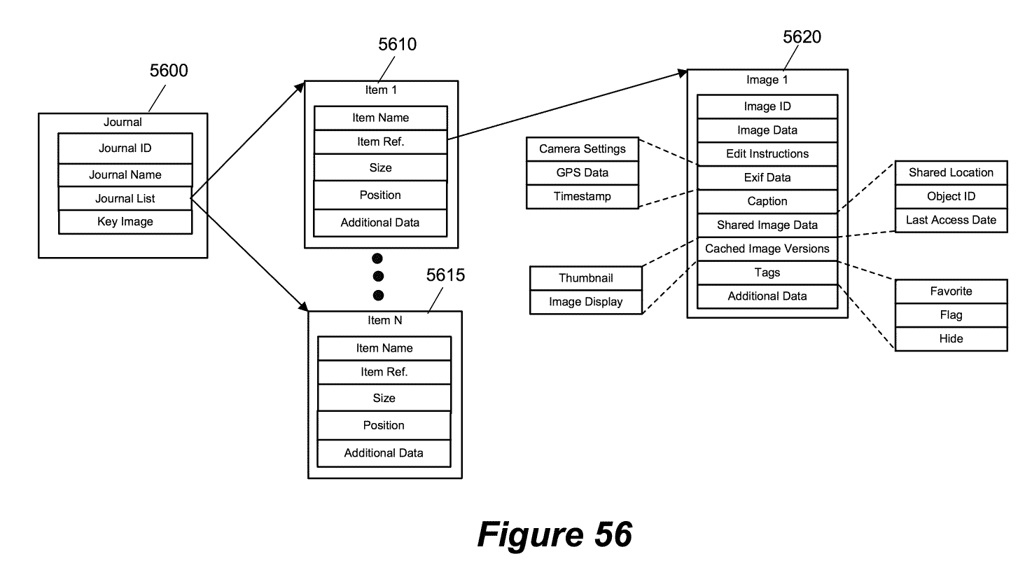

FIG. 56 conceptually illustrates several example data structures associated with the image organizing and editing application of some embodiments. As shown, the figure includes a journal data structure 5600 that is associated with several item data structures 5610-5615. The figure also includes a data structure 5620 that is associated with an image.

The journal data structure 5600 of some embodiments is a collection data structure that contains an ordered list of items. When creating a new journal, the application automatically creates a new collection data structure for the journal. The journal data structure 5600 includes a journal ID, a journal name, a key image, and references to an ordered series of items (e.g., the item data structures 5610-5615. The journal ID is a unique identifier for the collection that the application uses when referencing the journal. The key image is an image set by the user to represent the journal. In some embodiments, the application displays the key image as the selectable icon for the journal on the glass shelf in the journal organization GUI (as shown in FIG. 4).

In addition, the journal data structure 5600 includes an ordered set of references to each item (e.g., images, video clips, info items) in the journal. The order of the images determines the order in which items are displayed within a grid in some embodiments. As will be described below, some embodiments store data structures for each image imported into the application, and the journal references these data structures. These references may be pointers, references to database entries, etc.

The item data structures 5600 of some embodiments represent items in the journal. (e.g., images, video clips, info items). As shown, each item includes a name for describing the item, a pointer to an image or some other data structure, size, and position. In some embodiments, the application uses the data associated with these items to populate a grid. Several examples of populating a grid are described above by reference to FIGS. 5-10.

The data structure 5615 includes an image ID, image data, edit instructions, Exchangeable image file format (Exif) data, a caption, shared image data, cached versions of the image, any tags on the image, and any additional data for the image. The image ID is a unique identifier for the image, which in some embodiments is used by the collection data structures to refer to the images stored in the collection.

The image data is the actual full-size pixel data for displaying the image (e.g., a series of color-space channel values for each pixel in the image or an encoded version thereof). In some embodiments, this data may be stored in a database of the image viewing, editing, and organization application, or may be stored with the data of another application on the same device. Thus, the data structure may store a pointer to the local file associated with the application or an ID that can be used to query the database of another application. In some embodiments, once the application uses the image in a journal or makes an edit to the image, the application automatically makes a local copy of the image file that contains the image data.

The edit instructions include information regarding any edits the user has applied to the image. In this manner, the application stores the image in a non-destructive format, such that the application can easily revert from an edited version of the image to the original at any time. For instance, the user can apply a saturation effect to the image, leave the application, and then reopen the application and remove the effect at another time. The edits stored in these instructions may be crops and rotations, full-image exposure and color adjustments, localized adjustments, and special effects, as well as other edits that affect the pixels of the image. Some embodiments store these editing instructions in a particular order, so that users can view different versions of the image with only certain sets of edits applied.

The Exif data includes various information stored by the camera that captured the image, when that information is available. While Exif is one particular file format that is commonly used by digital cameras, one of ordinary skill in the art will recognize that comparable information may be available in other formats as well, or may even be directly input by a user. The Exif data includes camera settings data, GPS data, and a timestamp.

The camera settings data includes information about the camera settings for an image, if that information is available from the camera that captured the image. This information, for example, might include the aperture, focal length, shutter speed, exposure compensation, and ISO. The GPS data indicates the location at which an image was captured, while the timestamp indicates the time (according to the camera's clock) at which the image was captured. In some embodiments, the application identifies the GPS data and/or the timestamp to auto-fill info items added to journal. Many example of such dynamic info items are described above by reference to FIGS. 33-38.

The caption is a user-entered description of the image. In some embodiments, this information is displayed with the photo in the image viewing area, but may also be used to display over the photo in a created journal, and may be used if the image is posted to a social media or photo-sharing website. As mentioned above, the application of some identifies captioned images in order to make them appear larger than other images in the journal.

When the user posts the image to such a website, the application generates shared image data for the image. This information stores the location (e.g., Facebook, Flickr®, etc.), as well as an object ID for accessing the image in the website's database. The last access date is a date and time at which the application last used the object ID to access any user comments on the photo from the social media or photo sharing website.

The cached image versions store versions of the image that are commonly accessed and displayed, so that the application does not need to repeatedly generate these images from the full-size image data. For instance, the application will often store a thumbnail for the image as well as a display resolution version (e.g., a version tailored for the image display area). The application of some embodiments generates a new thumbnail for an image each time an edit is applied, replacing the previous thumbnail. Some embodiments store multiple display resolution versions including the original image and one or more edited versions of the image.

The tags are information that the application enables the user to associate with an image. For instance, in some embodiments, users can mark the image as a favorite, flag the image (e.g., for further review), and hide the image so that the image will not be displayed within the standard thumbnail grid for a collection and will not be displayed in the image display area when the user cycles through a collection that includes the image. Other embodiments may include additional tags. As mentioned above, the application of some embodiments one or more of different types of tags to emphasize images in the journal. Alternatively, the application can identify one or more different types of tags to de-emphasize images. For example, an image with a low rating tag can be made to appear smaller than other images or moved towards the end of the journal. Finally, the image data structure 5600 includes additional data 5650 that the application might store with an image (e.g., locations and sizes of faces, etc.).

One of ordinary skill in the art will recognize that the image data structure 5600 is only one possible data structure that the application might use to store the required information for an image. For example, different embodiments might store additional or less information, store the information in a different order, etc. In addition, the application of some embodiments stores other types of collection data structure that is similar to the journal data structure 5600. These collections include album, event, overall collection, etc. For example, the application of some embodiments includes the “photos” collection, which references each image imported into the application irrespective of which other collections also include the image. Similar to the journal collection, these other types of collection (e.g., the album collection) may each have an ordered list of images. In some such embodiments, the application uses one or more of these ordered lists of images to populate the journal's list of items.

B. Example Graphical User Interface

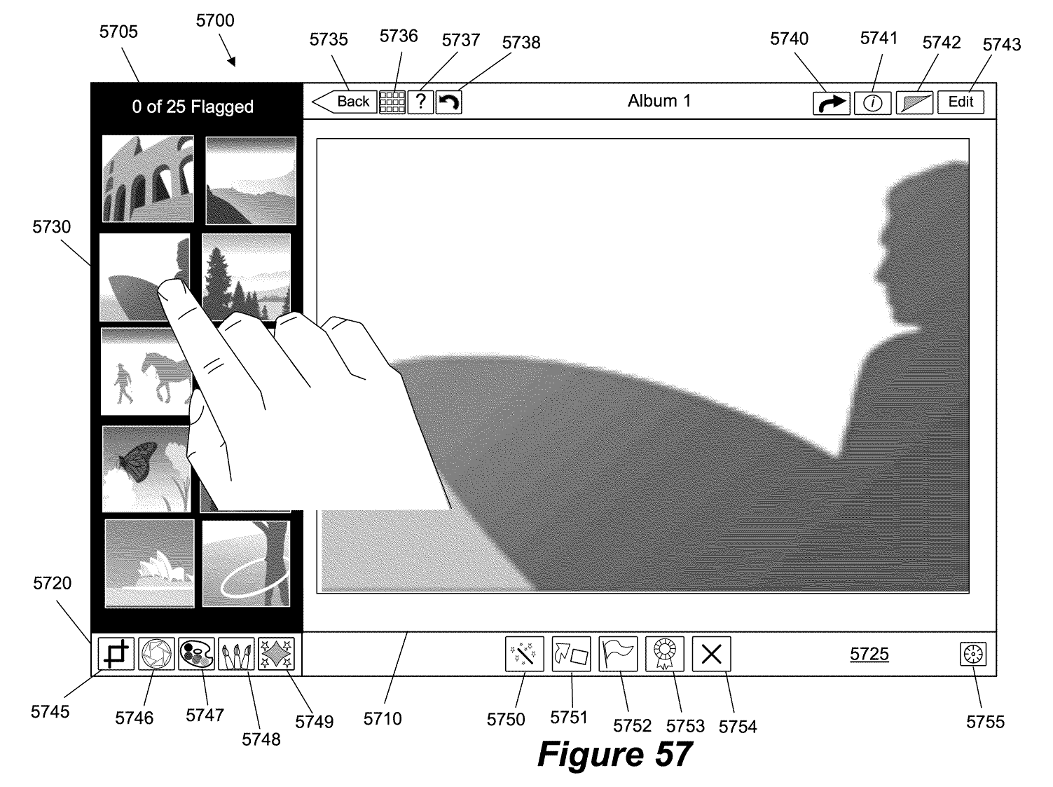

The above-described figures illustrated various examples of the GUI of an image viewing, editing, and organization application of some embodiments. FIG. 57 illustrates a detailed view of a GUI 5700 of some embodiments for viewing, editing, and organizing images. As shown, the GUI 5700 includes a thumbnail display area 5705, an image display area 5710, a first toolbar 5715, a second toolbar 5720, and a third toolbar 5725. The thumbnail display area 5705 displays thumbnails of the images in a selected collection. Thumbnails are small representations of a full-size image, and represent only a portion of an image in some embodiments. For example, the thumbnails in thumbnail display area 5705 are all squares, irrespective of the aspect ratio of the full-size images. In order to determine the portion of a rectangular image to use for a thumbnail, the application identifies the smaller dimension of the image and uses the center portion of the image in the longer direction. For instance, with a 1600×1200-pixel image, the application would use a 1200×1200 square. To further refine the selected portion for a thumbnail, some embodiments identify a center of all the faces in the image (using a face detection algorithm), then use this location to center the thumbnail portion in the clipped direction. Thus, if the faces in the theoretical 1600×1200 image were all located on the left side of the image, the application would use the leftmost 1200 columns of pixels rather than cut off 200 columns on either side.

After determining the portion of the image to use for the thumbnail, the image-viewing application generates a low-resolution version (e.g., using pixel blending and other techniques) of the image. The application of some embodiments stores the thumbnail for an image as a cached version of the image. Thus, when a user selects a collection, the application identifies all of the images in the collection (through the collection data structure), and accesses the cached thumbnails in each image data structure for display in the thumbnail display area.

The user may select one or more images in the thumbnail display area (e.g., through various touch interactions described above, or through other user input interactions). The selected thumbnails are displayed with a highlight or other indicator of selection. In thumbnail display area 5705, the thumbnail 5730 is selected. In addition, as shown, the thumbnail display area 5705 of some embodiments indicates a number of images in the collection that have been flagged (i.e., that have a tag for the flag set to yes). In some embodiments, this text is selectable in order to display only the thumbnails of the flagged images.

The application displays selected images in the image display area 5710 at a larger resolution than the corresponding thumbnails. The images are not typically displayed at the full size of the image, as images often have a higher resolution than the display device. As such, the application of some embodiments stores a cached version of the image designed to fit into the image display area. Images in the image display area 5710 are displayed in the aspect ratio of the full-size image. When one image is selected, the application displays the image as large as possible within the image display area without cutting off any part of the image. When multiple images are selected, the application displays the images in such a way as to maintain their visual weighting by using approximately the same number of pixels for each image, even when the images have different aspect ratios.

The first toolbar 5715 displays title information (e.g., the name of the collection shown in the GUI, a caption that a user has added to the currently selected image, etc.). In addition, the toolbar 5715 includes a first set of GUI items 5735-5738 and a second set of GUI items 5740-5743.

The first set of GUI items includes a back button 5735, a grid button 5736, a help button 5737, and an undo button 5738. The back button 5735 enables the user to navigate back to a collection organization GUI, from which users can select between different collections of images (e.g., albums, events, journals, etc.). Selection of the grid button 5736 causes the application to move the thumbnail display area on or off of the GUI (e.g., via a slide animation). In some embodiments, users can also slide the thumbnail display area on or off of the GUI via a swipe gesture. The help button 5737 activates a context-sensitive help feature that identifies a current set of tools active for the user and provides help indicators for those tools that succinctly describe the tools to the user. In some embodiments, the help indicators are selectable to access additional information about the tools. Selection of the undo button 5738 causes the application to remove the most recent edit to the image, whether this edit is a crop, color adjustment, etc. In order to perform this undo, some embodiments remove the most recent instruction from the set of edit instructions stored with the image.

The second set of GUI items includes a sharing button 5740, an information button 5741, a show original button 5742, and an edit button 5743. The sharing button 5740 enables a user to share an image in a variety of different ways. In some embodiments, the user can send a selected image to another compatible device on the same network (e.g., Wi-Fi or Bluetooth network), upload an image to an image hosting or social media website, and create a journal (i.e., a presentation of arranged images to which additional content can be added) from a set of selected images, among others.

The information button 5741 activates a display area that displays additional information about one or more selected images. The information displayed in the activated display area may include some or all of the Exif data stored for an image (e.g., camera settings, timestamp, etc.). When multiple images are selected, some embodiments only display Exif data that is common to all of the selected images. Some embodiments include additional tabs within the information display area for (i) displaying a map showing where the image or images were captured according to the GPS data, if this information is available and (ii) displaying comment streams for the image on any photo sharing websites. To download this information from the websites, the application uses the object ID stored for the image with the shared image data and sends this information to the website. The comment stream and, in some cases, additional information, are received from the website and displayed to the user.

The show original button 5742 enables the user to toggle between the original version of an image and the current edited version of the image. When a user selects the button, the application displays the original version of the image without any of the editing instructions applied. In some embodiments, the appropriate size image is stored as one of the cached versions of the image, making it quickly accessible. When the user selects the button again 5742 again, the application displays the edited version of the image, with the editing instructions applied.

The edit button 5743 allows the user to enter or exit edit mode. When a user has selected one of the sets of editing tools in the toolbar 5720, the edit button 5743 returns the user to the viewing and organization mode, as shown in FIG. 57. When the user selects the edit button 5743 while in the viewing mode, the application returns to the last used set of editing tools in the order shown in toolbar 5720. That is, the items in the toolbar 5720 are arranged in a particular order, and the edit button 5743 activates the rightmost of those items for which edits have been made to the selected image.

The toolbar 5720, as mentioned, includes five items 5745-5749, arranged in a particular order from left to right. The crop item 5745 activates a cropping and rotation tool that allows the user to align crooked images and remove unwanted portions of an image. The exposure item 5746 activates a set of exposure tools that allow the user to modify the black point, shadows, contrast, brightness, highlights, and white point of an image. In some embodiments, the set of exposure tools is a set of sliders that work together in different combinations to modify the tonal attributes of an image. The color item 5747 activates a set of color tools that enable the user to modify the saturation and vibrancy, as well as color-specific saturations (e.g., blue pixels or green pixels) and white balance. In some embodiments, some of these tools are presented as a set of sliders. The brushes item 5748 activates a set of enhancement tools that enable a user to localize modifications to the image. With the brushes, the user can remove red eye and blemishes, and apply or remove saturation and other features to localized portions of an image by performing a rubbing action over the image. Finally, the effects item 5749 activates a set of special effects that the user can apply to the image. These effects include gradients, tilt shifts, non-photorealistic desaturation effects, grayscale effects, various filters, etc. In some embodiments, the application presents these effects as a set of items that fan out from the toolbar 5725.

As stated, the UI items 5745-5749 are arranged in a particular order. This order follows the order in which users most commonly apply the five different types of edits. Accordingly, the editing instructions are stored in this same order, in some embodiments. When a user selects one of the items 5745-5749, some embodiments apply only the edits from the tools to the left of the selected tool to the displayed image (though other edits remain stored within the instruction set).

The toolbar 5725 includes a set of GUI items 5750-5754 as well as a settings item 5755. The auto-enhance item 5750 automatically performs enhancement edits to an image (e.g., removing apparent red eye, balancing color, etc.). The rotation button 5751 rotates any selected images. In some embodiments, each time the rotation button is pressed, the image rotates 90 degrees in a particular direction. The auto-enhancement, in some embodiments, comprises a predetermined set of edit instructions that are placed in the instruction set. Some embodiments perform an analysis of the image and then define a set of instructions based on the analysis. For instance, the auto-enhance tool will attempt to detect red eye in the image, but if no red eye is detected then no instructions will be generated to correct it. Similarly, automatic color balancing will be based on an analysis of the image. The rotations generated by the rotation button are also stored as edit instructions.

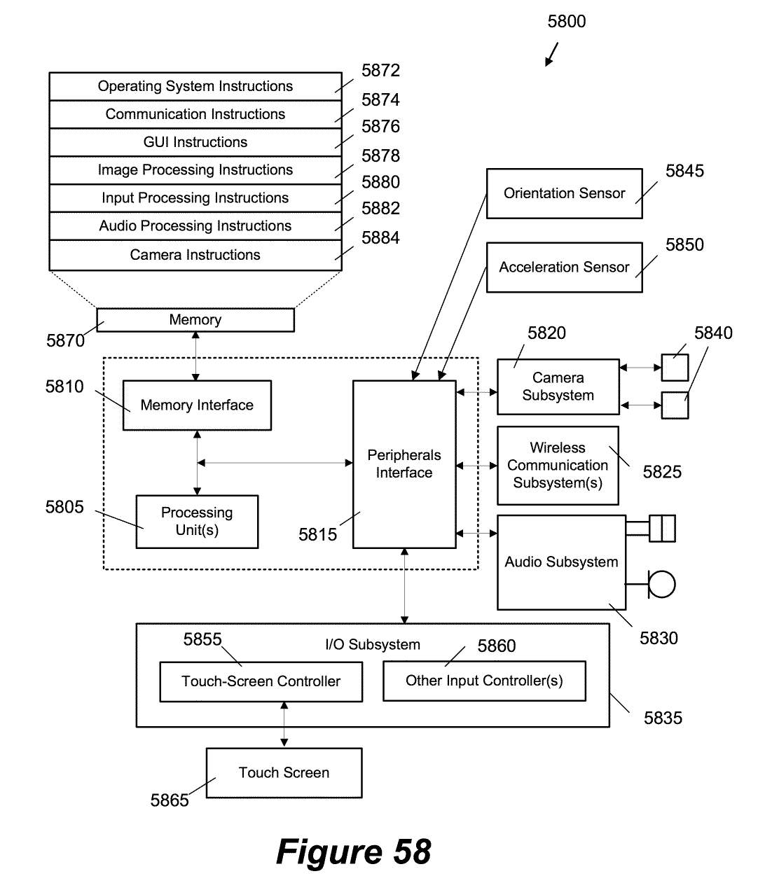

The flag button 5752 tags any selected image as flagged. In some embodiments, the flagged images of a collection can be displayed without any of the unflagged images. The favorites button 5753 allows a user to mark any selected images as favorites. In some embodiments, this tags the image as a favorite and also adds the image to a collection of favorite images. The hide button 5754 enables a user to tag an image as hidden. In some embodiments, a hidden image will not be displayed in the thumbnail display area and/or will not be displayed when a user cycles through the images of a collection in the image display area. As shown in FIG. 58, many of these features are stored as tags in the image data structure.

Finally, the settings button 5755 activates a context-sensitive menu that provides different menu options depending on the currently active toolset. For instance, in viewing mode the menu of some embodiments provides options for creating a new album, setting a key photo for an album, copying settings from one photo to another, and other options. When different sets of editing tools are active, the menu provides options related to the particular active toolset.

One of ordinary skill in the art will recognize that the image viewing and editing GUI 5700 is only one example of many possible graphical user interfaces for an image viewing, editing, and organizing application. For instance, the various items could be located in different areas or in a different order, and some embodiments might include items with additional or different functionalities. The thumbnail display area of some embodiments might display thumbnails that match the aspect ratio of their corresponding full-size images, etc.

### XII. Electronic Systems

Many of the above-described features and applications are implemented as software processes that are specified as a set of instructions recorded on a computer readable storage medium (also referred to as computer readable medium). When these instructions are executed by one or more computational or processing unit(s) (e.g., one or more processors, cores of processors, or other processing units), they cause the processing unit(s) to perform the actions indicated in the instructions. Examples of computer readable media include, but are not limited to, CD-ROMs, flash drives, random access memory (RAM) chips, hard drives, erasable programmable read-only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

A. Mobile Device

The image editing and viewing applications of some embodiments operate on mobile devices. FIG. 58 is an example of an architecture 5800 of such a mobile computing device. Examples of mobile computing devices include smartphones, tablets, laptops, etc. As shown, the mobile computing device 5800 includes one or more processing units 5805, a memory interface 5810 and a peripherals interface 5815.

The peripherals interface 5815 is coupled to various sensors and subsystems, including a camera subsystem 5820, a wireless communication subsystem(s) 5825, an audio subsystem 5830, an I/O subsystem 5835, etc. The peripherals interface 5815 enables communication between the processing units 5805 and various peripherals. For example, an orientation sensor 5845 (e.g., a gyroscope) and an acceleration sensor 5850 (e.g., an accelerometer) is coupled to the peripherals interface 5815 to facilitate orientation and acceleration functions.

The camera subsystem 5820 is coupled to one or more optical sensors 5840 (e.g., a charged coupled device (CCD) optical sensor, a complementary metal-oxide-semiconductor (CMOS) optical sensor, etc.). The camera subsystem 5820 coupled with the optical sensors 5840 facilitates camera functions, such as image and/or video data capturing. The wireless communication subsystem 5825 serves to facilitate communication functions. In some embodiments, the wireless communication subsystem 5825 includes radio frequency receivers and transmitters, and optical receivers and transmitters (not shown in FIG. 58). These receivers and transmitters of some embodiments are implemented to operate over one or more communication networks such as a GSM network, a Wi-Fi network, a Bluetooth network, etc. The audio subsystem 5830 is coupled to a speaker to output audio (e.g., to output different sound effects associated with different image operations). Additionally, the audio subsystem 5830 is coupled to a microphone to facilitate voice-enabled functions, such as voice recognition, digital recording, etc.

The I/O subsystem 5835 involves the transfer between input/output peripheral devices, such as a display, a touch screen, etc., and the data bus of the processing units 5805 through the peripherals interface 5815. The I/O subsystem 5835 includes a touch-screen controller 5855 and other input controllers 5860 to facilitate the transfer between input/output peripheral devices and the data bus of the processing units 5805. As shown, the touch-screen controller 5855 is coupled to a touch screen 5865. The touch-screen controller 5855 detects contact and movement on the touch screen 5865 using any of multiple touch sensitivity technologies. The other input controllers 5860 are coupled to other input/control devices, such as one or more buttons. Some embodiments include a near-touch sensitive screen and a corresponding controller that can detect near-touch interactions instead of or in addition to touch interactions.

The memory interface 5810 is coupled to memory 5870. In some embodiments, the memory 5870 includes volatile memory (e.g., high-speed random access memory), non-volatile memory (e.g., flash memory), a combination of volatile and non-volatile memory, and/or any other type of memory. As illustrated in FIG. 58, the memory 5870 stores an operating system (OS) 5872. The OS 5872 includes instructions for handling basic system services and for performing hardware dependent tasks.

The memory 5870 also includes communication instructions 5874 to facilitate communicating with one or more additional devices; graphical user interface instructions 5876 to facilitate graphic user interface processing; image processing instructions 5878 to facilitate image-related processing and functions; input processing instructions 5880 to facilitate input-related (e.g., touch input) processes and functions; audio processing instructions 5882 to facilitate audio-related processes and functions; and camera instructions 5884 to facilitate camera-related processes and functions. The instructions described above are merely exemplary and the memory 5870 includes additional and/or other instructions in some embodiments. For instance, the memory for a smartphone may include phone instructions to facilitate phone-related processes and functions. The above-identified instructions need not be implemented as separate software programs or modules. Various functions of the mobile computing device can be implemented in hardware and/or in software, including in one or more signal processing and/or application specific integrated circuits.

While the components illustrated in FIG. 58 are shown as separate components, one of ordinary skill in the art will recognize that two or more components may be integrated into one or more integrated circuits. In addition, two or more components may be coupled together by one or more communication buses or signal lines. Also, while many of the functions have been described as being performed by one component, one of ordinary skill in the art will realize that the functions described with respect to FIG. 58 may be split into two or more integrated circuits.

B. Computer System

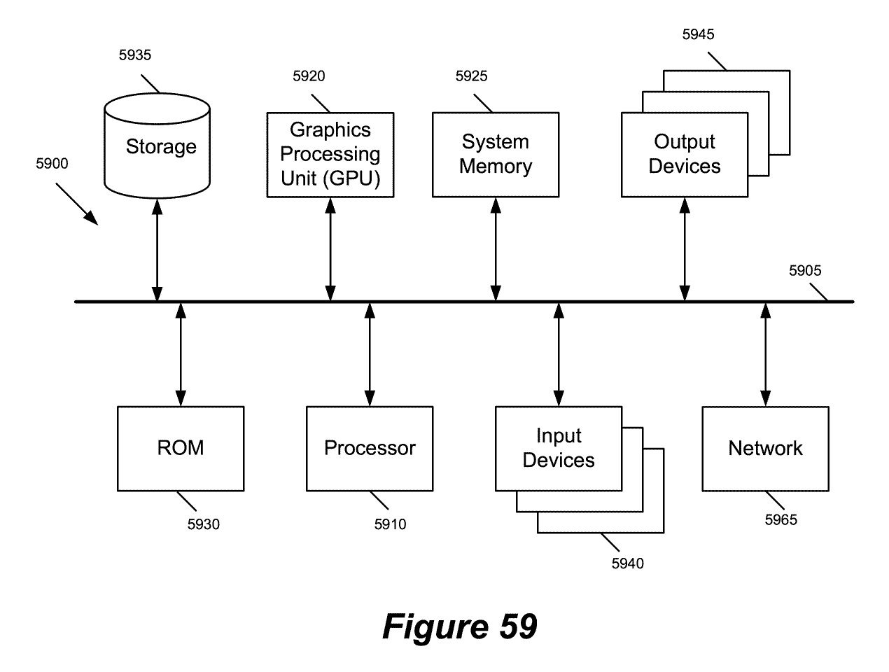

FIG. 59 conceptually illustrates another example of an electronic system 5900 with which some embodiments of the invention are implemented. The electronic system 5900 may be a computer (e.g., a desktop computer, personal computer, tablet computer, etc.), phone, PDA, or any other sort of electronic or computing device. Such an electronic system includes various types of computer readable media and interfaces for various other types of computer readable media. Electronic system 5900 includes a bus 5905, processing unit(s) 5910, a graphics processing unit (GPU) 5915, a system memory 5920, a network 5925, a read-only memory 5930, a permanent storage device 5935, input devices 5940, and output devices 5945.

The bus 5905 collectively represents all system, peripheral, and chipset buses that communicatively connect the numerous internal devices of the electronic system 5900. For instance, the bus 5905 communicatively connects the processing unit(s) 5910 with the read-only memory 5930, the GPU 5915, the system memory 5920, and the permanent storage device 5935.

From these various memory units, the processing unit(s) 5910 retrieves instructions to execute and data to process in order to execute the processes of the invention. The processing unit(s) may be a single processor or a multi-core processor in different embodiments. Some instructions are passed to and executed by the GPU 5915. The GPU 5915 can offload various computations or complement the image processing provided by the processing unit(s) 5910.

The read-only-memory (ROM) 5930 stores static data and instructions that are needed by the processing unit(s) 5910 and other modules of the electronic system. The permanent storage device 5935, on the other hand, is a read-and-write memory device. This device is a non-volatile memory unit that stores instructions and data even when the electronic system 5900 is off. Some embodiments of the invention use a mass-storage device (such as a magnetic or optical disk and its corresponding disk drive) as the permanent storage device 5935.

Other embodiments use a removable storage device (such as a floppy disk, flash memory device, etc., and its corresponding drive) as the permanent storage device. Like the permanent storage device 5935, the system memory 5920 is a read-and-write memory device. However, unlike storage device 5935, the system memory 5920 is a volatile read-and-write memory, such a random access memory. The system memory 5920 stores some of the instructions and data that the processor needs at runtime. In some embodiments, the invention's processes are stored in the system memory 5920, the permanent storage device 5935, and/or the read-only memory 5930. For example, the various memory units include instructions for processing multimedia clips in accordance with some embodiments. From these various memory units, the processing unit(s) 5910 retrieves instructions to execute and data to process in order to execute the processes of some embodiments.

The bus 5905 also connects to the input and output devices 5940 and 5945. The input devices 5940 enable the user to communicate information and select commands to the electronic system. The input devices 5940 include alphanumeric keyboards and pointing devices (also called “cursor control devices”), cameras (e.g., webcams), microphones or similar devices for receiving voice commands, etc. The output devices 5945 display images generated by the electronic system or otherwise output data. The output devices 5945 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 59, bus 5905 also couples electronic system 5900 to a network 5925 through a network adapter (not shown). In this manner, the computer can be a part of a network of computers (such as a local area network (“LAN”), a wide area network (“WAN”), or an Intranet, or a network of networks, such as the Internet. Any or all components of electronic system 5900 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

While the invention has been described with reference to numerous specific details, one of ordinary skill in the art will recognize that the invention can be embodied in other specific forms without departing from the spirit of the invention. For instance, many of the figures illustrate various touch gestures (e.g., taps, double taps, swipe gestures, press and hold gestures, etc.). However, many of the illustrated operations could be performed via different touch gestures (e.g., a swipe instead of a tap, etc.) or by non-touch input (e.g., using a cursor controller, a keyboard, a touchpad/trackpad, a near-touch sensitive screen, etc.). In addition, a number of the figures (including FIGS. 6, 9, 10, 39, 50, and 51) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the invention is not to be limited by the foregoing illustrative details, but rather is to be defined by the appended claims.

While the invention has been described with reference to numerous specific details, one of ordinary skill in the art will recognize that the invention can be embodied in other specific forms without departing from the spirit of the invention. For example, one of ordinary skill in the art will understand that many of the UI items of FIGS. 1-4, 11, 13, 14, 16, 18, 21-33, 35-38, 40-47, 49, 52-54, and 57 can also be activated and/or set by a cursor control device (e.g., a mouse or trackball), a stylus, keyboard, a finger gesture (e.g., placing, pointing, tapping one or more fingers) near a near-touch sensitive screen, or any other control system in some embodiments. Thus, one of ordinary skill in the art would understand that the invention is not to be limited by the foregoing illustrative details, but rather is to be defined by the appended claims.

What is claimed is:

1. A non-transitory machine readable medium storing a program that when executed by at least one processing unit provides a user interface (UI), the UI comprising:
a display area for displaying a journal comprising a plurality of images; and
a plurality of items for creating a story around the images in the journal, wherein the plurality of items comprises at least one dynamic item that when added to the journal causes (i) an analysis of one or more of the images and (ii) a display of information on the journal based on the analysis.

2. The non-transitory machine readable medium of claim 1, wherein the analysis comprises identifying a date associated with an image in the journal to display the date on the journal.

3. The non-transitory machine readable medium of claim 1, wherein the analysis comprises identifying Global Positioning System (GPS) data associated with an image in the journal to display a map of a location associated with the GPS data.

4. The non-transitory machine readable medium of claim 3, wherein adding the dynamic item to the journal further causes the GPS data to be sent over a network to an external map service in order to retrieve the map showing the location.

5. The non-transitory machine readable medium of claim 1, wherein the analysis comprises identifying date and GPS data associated with an image in the journal to display weather information relating to the date and location associated with the GPS data.

6. The non-transitory machine readable medium of claim 5, wherein adding the dynamic item to the journal further causes the date and GPS data to be sent over a network to an external weather service in order to retrieve a weather report that is used to display the weather information.

7. The non-transitory machine readable medium of claim 1, wherein the information is presented graphically with one or more images on the journal.

8. The non-transitory machine readable medium of claim 1, wherein the journal is defined by two-dimensional grid having a fixed number of cells along one dimension and a varying number of cells along the other dimension, wherein each of the images and the items is placed on one or more grid cells.

9. The non-transitory machine readable medium of claim 8, wherein the plurality of item comprises a text item to add plain text to a set of one or more grid cells.

10. The non-transitory machine readable medium of claim 9, wherein the UI further comprises a set of options for specifying whether the text is contained in the set of grid cells, or is not contained in any grid cells but spans the width of the journal.

11. The non-transitory machine readable medium of claim 1, wherein the plurality of items comprises a new page item that when added to the journal causes a new page to be added to the journal.

12. The non-transitory machine readable medium of claim 1, wherein a movement of the dynamic item from one location to another location on the journal causes an analysis of one or more other images and a modification of the displayed information based on the analysis of the one or more other images.

13. A non-transitory machine readable medium storing a program for execution by at least one processing unit, the program comprising sets of instructions for:
displaying a journal comprising a plurality of images;
adding an item for displaying information on the journal;
analyzing, in response to the addition, one or more of the images in the journal; and
displaying, based on the analysis, the information on the item.

14. The non-transitory machine readable medium of claim 13, wherein the program further comprises a set of instructions for creating the journal by defining an ordered list that lists each image with the image's size, wherein the set of instructions for adding the item comprises adding the item to the ordered list with the item's size.

15. The non-transitory machine readable medium of claim 13, wherein the set of instructions adding the item comprises a set of instructions for adding the item to journal between two images.

16. The non-transitory machine readable medium of claim 15, wherein the set of instructions for analyzing the one or more images comprises a set of instructions for identifying a set of metadata associated with a first image that is next to the item on one side.

17. The non-transitory machine readable medium of claim 16, wherein the set of instructions for analyzing the one or more images comprises a set of instructions for identifying a set of metadata associated with a second image that is next to the item on the other side upon determining that the set of metadata is not associated with the first image.

18. The non-transitory machine readable medium of claim 17, wherein the set of instructions for analyzing the one or more images comprises a set of instructions for identifying a set of metadata associated with a third image that is next two the second image but not next to the item upon determining that the set of metadata is not associated with the first image.

19. The non-transitory machine readable medium of claim 13, wherein the program further comprises a set of instructions for sending the set of metadata over a network to an external data source in order to retrieve data that is used to display the information.

20. The non-transitory machine readable medium of claim 19, wherein the external data source is one of a map service that provides map data, a weather service that provides weather data, and a travel service that provides travel data.

21. A method of defining a user interface (UI) for creating journals, the method comprising:
defining a display area for displaying a journal comprising a plurality of images; and
defining a plurality of items for creating a story around the images in the journal, wherein the plurality of items comprises at least one dynamic item that when added to the journal causes (i) an analysis of one or more of the images and (ii) a display of information on the journal based on the analysis.

22. The method of claim 21, wherein the analysis comprises identifying a date associated with an image in the journal to display the date on the journal.

23. The method of claim 21, wherein the analysis comprises identifying GPS data associated with an image in the journal to display a map of a location associated with the GPS data.

24. The method of claim 21, wherein the analysis comprises identifying date and GPS data associated with an image in the journal to display weather information relating to the date and location associated with the GPS data.
